(19) United States
(12) Patent Application Publication
(10) Pub. No.: US 2026/0273618 A1
(43) Pub. Date: Sep. 17, 2026

(54) PROCESS OF PRODUCING SPHERICAL POWDERS OF METAL, AND ALLOYS AND COMPOSITES THEREOF

(71) Applicants: Alex IASNIKOV, St. Albert (CA); Christopher V. DEVONE, Phoenixville, PA (US)

(72) Inventors: Alex IASNIKOV, St. Albert (CA); Christopher V. DEVONE, Phoenixville, PA (US)

(21) Appl. No.: 19/565,953

(22) Filed: Mar. 13, 2026

Related U.S. Application Data
(60) Provisional application No. 63/772,130, filed on Mar. 14, 2025.

(51) Int. Cl. B22F 1/065; B22F 9/02; B22F 9/14; B22F 10/14; B22F 10/64; B33Y 10/00; B33Y 70/00; B33Y 80/00

(52) U.S. Cl. CPC B22F 1/065; B22F 9/026; B22F 9/14; B22F 10/14; B22F 10/64; B22F 2301/20; B22F 2304/10; B33Y 10/00; B33Y 70/00; B33Y 80/00

(57) ABSTRACT

Processes for producing spherical metal powder particles are disclosed. A slurry containing primary metal powder (D50 about 0.01-10 μm), an organic binder, and a solvent is spray dried to form spherical agglomerates (D50 about 5-150 μm), debound, and sintered below the alloy solidus, optionally by microwave sintering, to produce sintered spherical particles. The particles may be densified and spheroidized in a DC plasma torch to densities of about 99-100% of theoretical. Alternatively, metal oxide powder is spray dried, debound, sintered, reduced to metal, and DC plasma processed to restore sphericity after reduction-induced volume change. Oxide-containing powders include oxide dispersion strengthened (ODS) powders formed by mechanical alloying nanoscale oxides prior to spray drying, oxide-modified powders, and oxide-dispersed powders formed without mechanical alloying. Additional embodiments provide porous powders for sinter-based additive manufacturing and granule-level liquid-phase densification without plasma.

### CROSS-REFERENCE TO RELATED APPLICATION

This application claims priority to U.S. Provisional Application No. 63/772,130, filed Mar. 14, 2025, the disclosure of which is herein incorporated by reference in its entirety.

### BACKGROUND OF THE INVENTION

Embodiments described herein relate generally to a process for producing spherical powders of metals, and alloys and composites thereof, and to a process for producing articles with improved tensile strength and oxidation resistance properties.

The process of building a three-dimensional (3D) object from a computer-aided design (CAD) model or digital 3D model is known as 3D printing or additive manufacturing (AM). 3D printing can be performed via various procedures in which materials are combined, connected, or hardened under the control of a computer, usually layer by layer (such as by fusing plastics, liquids, or powder grains). One of the main advantages of 3D printing is its ability to produce extremely complex structures or geometrical figures, including hollow parts or portions with interior truss structures to reduce weight.

Currently, a common method for 3D printing of metals and alloys is laser powder bed fusion (L-PBF). Other utilized methods include binder jetting and material extrusion. These methods all require spherical metal powders. While both binder jetting and material extrusion can use non-spherical powders, print quality is better with spherical particles.

Spherical metal powders are used in numerous powder metallurgy applications to produce higher quality metal parts than their irregularly shaped counterparts. Two major benefits of spherical powders compared to irregularly shaped powders include better flowability and higher packing density. Spherical metal powders are useful for powder metal injection molding (MIM), 3D metal printing and other powder metallurgical applications.

Spherical metal and alloy powders for additive manufacturing are commonly produced by gas atomization, with plasma atomization (including radio frequency (RF) plasma), plasma rotating electrode process (PREP), and electrode induction gas atomization (EIGA) used for certain reactive or high-purity systems. These processes involve high capital equipment costs and significant energy consumption. High material costs combined with high cost of metal printers significantly limit application and development of 3D printed metal parts.

Plasma atomization processes can have limited yield of a target particle size fraction depending on the size cut and process parameters, and atomization costs increase significantly with increasing melting point of the feedstock. As a result, these processes become very expensive for producing high temperature metals and alloys, and are prohibitively expensive for refractory metals such as W, Re, Mo, Nb, Ta, Hf and their alloys, and very expensive for high temperature alloys such as MoRe, WRe, MoTa, etc. These metals and alloys are extensively used for 3D printing of parts used in aerospace applications as well as in biomedical and some industrial applications.

Walter et al. (Powders 2, 216-231 (2023)) describes the successful manufacturing of spherical iron powders via spray drying and sintering/reduction of iron oxide. While atomized iron powders are widely used in aerospace, defense, automotive, construction, and healthcare applications, cost reduction through alternatives to atomization remains desirable. However, the Walter et al. process is limited to iron and does not address refractory metals, alloy systems, ODS or oxide-modified pathways, microwave sintering, or plasma spheroidization.

Stawovy et al. (U.S. Pat. No. 12,359,290, “Tungsten Heavy Metal Alloy Powders and Methods of Forming Them,” Elmet Technologies) describes the production of substantially spherical tungsten heavy alloy (WHA) powders via spray drying with optional plasma densification, achieving Hall flow rates as low as 7 seconds per 50 g and plasma-densified particles reaching up to 65% of theoretical density. However, the Elmet process is limited to tungsten heavy alloys (approximately 90% W with Ni, Fe, Cu, Co, or Mn binder additions) and does not achieve densities above 65% of theoretical, does not employ microwave sintering, does not address the oxide starting material route with reduction, and does not encompass ODS or oxide-modified alloy pathways. Yang et al. (U.S. Pat. No. 9,421,612, University of Utah) describes the production of substantially spherical metal powders via spray drying of metal hydride (TiH₂) powders followed by sintering. The process is directed primarily to titanium alloys (Ti-6A1-4V) and does not address refractory metals, microwave sintering, activator-enabled lower-temperature processing, or oxide-dispersion pathways. Stawovy et al. (U.S. Pat. No. 11,389,872, “Tungsten Heavy Metal Alloy Powders and Methods”) similarly discloses spray drying to form agglomerates and plasma densification to form composite tungsten heavy alloy particles, with limitations comparable to those of U.S. Pat. No. 12,359,290 described above. Fan et al. (U.S. Pat. No. 5,686,676, “Process for Making Improved Copper/Tungsten Composites”) describes hydrogen reduction of spray-dried oxide mixtures under controlled dew point conditions to produce copper/tungsten composite powders; however, the process is specific to Cu/W composites and does not address spheroidization, microwave sintering, activators, or the ODS/oxide-modified pathways of the present disclosure.

Agrawal et al. (U.S. Pat. No. 9,259,785, 6K Inc.) describes the use of microwave plasma processing to spheroidize and densify spray-dried or agglomerated metal and ceramic powders. However, the 6K process relies on RF or microwave plasma as the primary densification mechanism and does not disclose the combination of microwave sintering with activator-enabled lower-temperature processing, the metal oxide starting material route with subsequent reduction, or the distinct ODS and oxide-modified alloy pathways of the present disclosure.

The ability to produce a variety of high density spherical metal powders by a straightforward, economical process is desirable.

### SUMMARY OF THE INVENTION

In one embodiment, aspects of the disclosure relate to a method for producing spherical metal powder particles from a metal or metal alloy starting material, the method comprising:
(a) preparing a slurry comprising a metal or metal alloy powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) sintering the debound agglomerates at a temperature below a solidus temperature of the metal or metal alloy to produce spherical metal powder particles having a density of about 70% to about 95% of theoretical density.

In another embodiment, aspects of the disclosure are directed to a method for producing spherical metal powder particles from a metal or metal alloy starting material, the method comprising:
(a) preparing a slurry comprising a pre-alloyed metal powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) heating the debound agglomerates to a temperature between a solidus temperature and a liquidus temperature of the metal or metal alloy starting material to cause partial melting and formation of a liquid phase within each debound agglomerate, whereby the debound agglomerates are densified to a density of about 95% to about 100% of theoretical density by liquid phase sintering at a granule level without a subsequent plasma spheroidization step,
and wherein the heating is performed in a fluidized bed furnace, a rotating tube furnace, or on a non-wetting substrate selected from the group consisting of boron nitride-coated alumina and yttria-stabilized zirconia.

Further aspects of the disclosure relate to a method for producing spherical metal powder particles from a metal or metal alloy starting material, the method comprising:
(a) preparing a slurry comprising a metal or metal alloy powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) feeding the debound agglomerates directly into a DC plasma torch without a prior sintering step, wherein the DC plasma simultaneously densifies and spheroidizes the debound agglomerates to a density of about 99% to about 100% of theoretical density.

Additional aspects of the disclosure are directed to a method for producing spherical metal powder particles from metal oxide starting materials, the method comprising:
(a) preparing a slurry comprising a metal oxide powder having an average particle size D50 of about 0.01 microns to about 10 microns, an organic binder, and a solvent;
(b) spray drying the slurry to produce spherical oxide agglomerates;
(c) debinding the spherical oxide agglomerates;
(d) sintering the debound spherical oxide agglomerates under an inert or hydrogen-containing atmosphere,
(e) reducing the debound oxide agglomerates to metallic form via hydrogen reduction or metallothermic reduction, wherein
   step (e) is performed simultaneously with step (d) under a hydrogen, hydrogen-containing, or a forming gas atmosphere such that sintering consolidation and oxide reduction occur concurrently in a single combined thermal step to form a reduced metal powder; or
   step (e) is performed as a separate step after step (d) to form the reduced metal powder; and
(f) subjecting the reduced metal powder to DC plasma spheroidization to restore sphericity and produce spherical metal powder particles having a density of about 99% to about 100% of theoretical density.

In a further embodiment, aspects of the disclosure relate to a spherical metal powder comprising metal powder particles having an average particle size D50 of about 5 to about 100 microns, a density of about 70% to about 100% of theoretical density, a sphericity of at least about 0.85 as measured by automated image analysis, and a sintered polycrystalline microstructure comprising multiple grains derived from individual primary powder particles bonded by solid-state sintering necks, with residual closed porosity distributed within a particle interior.

Advantageous refinements of the invention, which can be implemented alone or in combination, are specified in the dependent claims.

In summary, the following embodiments are proposed as particularly preferred in the scope of the present invention:

Embodiment 1: A method for producing spherical metal powder particles from a metal or metal alloy starting material, the method comprising:
(a) preparing a slurry comprising a metal or metal alloy powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) sintering the debound agglomerates at a temperature below a solidus temperature of the metal or metal alloy to produce spherical metal powder particles having a density of about 70% to about 95% of theoretical density.

Embodiment 2: The method of Embodiment 1, wherein step (d) is performed in a microwave sintering furnace operating at a frequency of about 2.45 GHz or about 890-950 MHz.

Embodiment 3. The method of Embodiment 1 or 2, further comprising:
(e) subjecting the spherical metal powder particles to DC plasma spheroidization using a DC non-transferred arc plasma torch operating at a power of about 20 kW to about 500 kW by passing the spherical metal powder particles through a plasma plume to at least partially melt the spherical metal powder particles and spheroidize by surface tension, wherein the spherical metal powder particles subjected to DC plasma spheroidization have a density of about 99% to about 100% of theoretical density.

Embodiment 4: The method of any of Embodiments 1 to 3, wherein the metal or metal alloy powder is selected from the group consisting of transition metals of Groups 4-12, rare earth metals and alloys thereof, and refractory metals and alloys thereof selected from W, Mo, Re, Ta, Nb, Hf, Mo—Re alloys, W—Re alloys, Mo—W alloys, Mo—Ta alloys, Mo—Hf alloys, Ta—W alloys, and Ta—Nb alloys.

Embodiment 5: The method of any of Embodiments 1 to 4, wherein the slurry further comprises a sintering activator selected from the group consisting of Ni, Fe, Pt, and Ru in an amount of about 0.1 to about 1% by weight based on a total weight of solids.

Embodiment 6: The method of any of Embodiments 1 to 5, further comprising, prior to step (a), mechanically alloying nanoscale oxide particles having a particle size D50 of less than about 50 nm into the metal or metal alloy powder via high-energy planetary ball milling, attritor milling, or acoustic milling to establish an intragranular nanoscale dispersoid distribution,
wherein step (d) is performed in a solid state at a temperature below a solidus temperature of the metal alloy powder to produce oxide dispersion strengthened (ODS) metal powder particles having a density of about 85% to about 95% of theoretical density with an ODS microstructure comprising intragranular nanoscale dispersoids providing Orowan dislocation pinning; and
wherein the method optionally further comprises (e) subjecting the ODS metal powder particles to DC plasma spheroidization followed by rapid quenching at a cooling rate of at least about 10³ K/s to produce an ODS metal powder having a density of about 99% to about 100% of theoretical density while preserving the intragranular nanoscale dispersoid distribution.

Embodiment 7: The method of any of Embodiments 1 to 5, wherein the slurry further comprises oxide particles having an average particle size D50 of about 100 nm to about 5 m selected from the group consisting of Y₂O₃, La₂O₃, CeO₂, Ce₂O₃, and Y—Ti—O complex oxides, in an amount of about 0.5% to about 3.0% by weight based on a total weight of solids, and wherein the method further comprises (e) subjecting the spherical metal powder particles to DC plasma spheroidization, whereby the oxide particles redistribute to grain boundaries upon resolidification to provide grain boundary strengthening via Zener pinning, Hall-Petch grain refinement, and improved oxidation resistance through a reactive element effect.

Embodiment 8: The method of any of Embodiments 1 to 5, wherein an oxide phase comprising oxide particles is introduced within each spray-dried agglomerate without mechanical alloying by either:
(i) deagglomerating nanoscale or sub-micron oxide particles having a particle size D50 of about 10 nm to about 500 nm in a liquid carrier with a dispersant and depositing the oxide particles onto metal powder surfaces by hetero-agglomeration prior to slurry preparation, or
(ii) distributing nanoscale oxide particles or an oxide-forming precursor throughout the slurry prior to spray drying; and
wherein the method further comprises (e) subjecting the debound agglomerates to DC plasma spheroidization with rapid solidification to produce spherical metal powder particles having a density of about 99% to about 100% of theoretical density and containing an oxide phase distributed within a particle interior.

Embodiment 9: A method for producing spherical metal powder particles from a metal or metal alloy starting material, the method comprising:
(a) preparing a slurry comprising a pre-alloyed metal powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) heating the debound agglomerates to a temperature between a solidus temperature and a liquidus temperature of the metal or metal alloy starting material to cause partial melting and formation of a liquid phase within each debound agglomerate, whereby the debound agglomerates are densified to a density of about 95% to about 100% of theoretical density by liquid phase sintering at a granule level without a subsequent plasma spheroidization step,
and wherein the heating is performed in a fluidized bed furnace, a rotating tube furnace, or on a non-wetting substrate selected from the group consisting of boron nitride-coated alumina and yttria-stabilized zirconia.

Embodiment 10: The method of any of Embodiments 1 to 5 or 7 to 9, wherein the slurry further comprises a transient liquid-forming additive selected from the group consisting of boron in an amount of about 0.1 to about 1.0 wt. %, copper in an amount of about 1 to about 5 wt. %, silicon in an amount of about 0.5 to about 3 wt. %, phosphorus in an amount of about 0.1 to about 0.8 wt. %, and tin in an amount of about 1 to about 5 wt. %, each based on a total weight of solids, wherein during step (d) the transient liquid-forming additive forms a transient liquid phase that densifies the debound agglomerates to a density of about 95% to about 100% of theoretical density and subsequently solidifies by isothermal diffusion into a solid matrix.

Embodiment 11: The method of any of Embodiments 1 to 5 or 7 to 10, wherein the metal alloy powder is a high entropy alloy selected from the group consisting of refractory high-entropy alloys (RHEAs), 3d transition high-entropy alloys (THEAs), and high-entropy superalloys (HESAs).

Embodiment 12: A method for producing spherical metal powder particles from a metal or metal alloy starting material, the method comprising:
(a) preparing a slurry comprising a metal or metal alloy powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) feeding the debound agglomerates directly into a DC plasma torch without a prior sintering step, wherein the DC plasma simultaneously densifies and spheroidizes the debound agglomerates to a density of about 99% to about 100% of theoretical density.

Embodiment 13: A method for producing spherical metal powder particles from metal oxide starting materials, the method comprising:
(a) preparing a slurry comprising a metal oxide powder having an average particle size D50 of about 0.01 microns to about 10 microns, an organic binder, and a solvent;
(b) spray drying the slurry to produce spherical oxide agglomerates;
(c) debinding the spherical oxide agglomerates;
(d) sintering the debound spherical oxide agglomerates under an inert or hydrogen-containing atmosphere,
(e) reducing the debound oxide agglomerates to metallic form via hydrogen reduction or metallothermic reduction, wherein
step (e) is performed simultaneously with step (d) under a hydrogen, hydrogen-containing, or a forming gas atmosphere such that sintering consolidation and oxide reduction occur concurrently in a single combined thermal step to form a reduced metal powder; or
step (e) is performed as a separate step after step (d) to form the reduced metal powder; and
(f) subjecting the reduced metal powder to DC plasma spheroidization to restore sphericity and produce spherical metal powder particles having a density of about 99% to about 100% of theoretical density.

Embodiment 14: The method of Embodiment 13, wherein the metal oxide powder is selected from the group consisting of oxides of W, Mo, Re, Ta, Nb, Hf, Fe, Ti, Ni, and Co.

Embodiment 15: The method of Embodiment 13 or 14, wherein step (e) is a metallothermic reduction using a reducing agent selected from the group consisting of calcium, magnesium, aluminum, and sodium; and wherein steps (d) and (e) are performed simultaneously in a single furnace or are performed sequentially in a single furnace or in different furnaces.

Embodiment 16: A spherical metal powder comprising metal powder particles having an average particle size D50 of about 5 to about 100 microns, a density of about 70% to about 100% of theoretical density, a sphericity of at least about 0.85 as measured by automated image analysis, and a sintered polycrystalline microstructure comprising multiple grains derived from individual primary powder particles bonded by solid-state sintering necks, with residual closed porosity distributed within a particle interior.

Embodiment 17: The spherical metal powder of Embodiment 16, wherein the metal powder particles comprise a refractory metal or refractory metal alloy selected from the group consisting of W, Mo, Re, Ta, Nb, Hf, W—Re, Mo—Re, Mo—Ta, Mo—Hf, and Ta—Nb.

Embodiment 18: The spherical metal powder of Embodiment 16 or 17, wherein the spherical metal powder is an oxide dispersion strengthened (ODS) powder comprising intragranular nanoscale oxide dispersoids having an average particle size D50 of about 5 to about 50 nm providing Orowan dislocation pinning, and has a density of about 85% to about 100% of theoretical density; or wherein the spherical metal powder is an oxide-modified alloy powder comprising oxide particles at grain boundaries providing Zener pinning, and has a density of about 99% to about 100% of theoretical density.

Embodiment 19: The spherical metal powder of any of Embodiments 16 to 18, wherein the spherical metal powder has a sphericity of at least 0.90 as measured by automated image analysis and a Hall flow rate of about 30 seconds per 50 grams or less as measured according to ASTM B213.

Embodiment 20: A method of sinter-based additive manufacturing comprising:
providing the spherical metal powder of any of Embodiments 16 to 19 having a density of about 70% to about 95% of theoretical density with residual interconnected porosity;
   forming a green part by binder jetting, fused filament fabrication, MIM-type feedstock extrusion, or bound metal deposition; and
sintering the green part to at least about 97% of theoretical density without supplemental hot isostatic pressing.

### BRIEF DESCRIPTION OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a schematic of an exemplary spray dryer process according to an embodiment of the disclosure;

FIG. 2 is a schematic of a conventional heating process;

FIG. 3 is a schematic of a microwave sintering process; and

FIG. 4 is a schematic of a DC plasma powder spheroidization system.

### DETAILED DESCRIPTION

Aspects of the disclosure relate to a low-cost process for producing high density spherical metal powders from metal or metal alloy starting materials, such as transition metals of Groups 4-12, rare earth metals, and alloys and composites thereof, including nickel-based superalloys, cobalt-based alloys, iron-based alloys and steels, titanium alloys, copper alloys, aluminum alloys, high entropy alloys, and metal matrix composites.

Certain terminology is used in the following description for convenience only and is not limiting. The words “a” and “an,” as used herein, mean “at least one.” The terms “powders” and “powder,” as used herein, mean a material containing small particles. It should also be understood that the term “about,” as used herein, means, for example, the value of a given quantity that varies within 10% of the value (e.g., ±1%, ±5%, or ±10% of the value).

Unless otherwise stated, any numerical value is to be understood as being modified in all instances by the term “about.” Thus, a numerical value typically includes±10% of the recited value. For example, the recitation of a temperature such as “10° C.” or “about 10° C.” includes 9° C. and 11° C. and all temperatures therebetween.

All numerical ranges expressed in this disclosure expressly encompass all possible subranges, all individual numerical values within that range, including integers within such ranges and fractions and decimal amounts of the values unless the context clearly indicates otherwise.

As used herein, the term “high density powder” means a powder having at least 70% of theoretical density, preferably at least 80%, even more preferably at least 85%, even more preferably 90%, even more preferably 95%, even more preferably 98%, and even more preferably ≥99% of theoretical density, and up to about 100% of theoretical density Thus, the term “high density” encompasses densities of about 70% to about 100% of theoretical, about 80% to about 100%, about 85% to about 100%, about 90% to about 100%, about 95% to about 100%, about 98% to about 100%, and about 99% to about 100%, as well as all intermediate ranges such as about 70% to about 95%, about 85% to about 95%, and about 85% to about 98%.

As described in further detail below, aspects of the disclosure relate to methods which employ spray drying, optional reduction, and sintering of individual metals, oxides thereof, and most known alloys to produce spherical metal powder particles of refractory metals and different alloys. By employing microwave sintering furnaces, the methods described herein reduce sintering cost and time. Further, by employing these methods, powder sphericity and density can be improved from about 70-90% to about 99% of theoretical when a DC plasma spheroidization step is employed. In the case of metals and alloys, the sintering step may also be replaced by the DC plasma spheroidization step. {49-53} An advantage of the process described herein is that it provides for the use of very fine primary powders which allows for the production of powders with finer grain size than conventional powders, which sinter better when binder jetting or material extrusion processes are used to print parts that need sintering.

Further, the use of slurry mixing provides for the ability to mix different elements and additives (such as oxides and sintering aids) with high homogeneity. For example, by adding 0.5-2% oxide (such as a REO (rare earth oxide)) to a 5 micron alloy powder and spray drying, the oxide particles are distributed more evenly than in conventional processes which employ 30-40 micron atomized powders and weld oxide particles to their surfaces in an acoustic sound mill, thereby improving the performance of the alloys.

Additionally, the addition of activators provides for the ability to sinter refractory metals and their binary compounds at lower temperature, and therefore lower cost.

More specifically, the methods according to the disclosure for the production of highly spherical powder particles involve spray drying a primary fine powder, debinding, and sintering, optionally followed by an additional reduction step if an oxide powder is used as the starting materials.

Accordingly, depending on the oxidation state of the starting material, an exemplary process according to aspects of the disclosure may include or consist of several simple and inexpensive steps:

(1) Spray drying a fine (primary) metal, metal alloy, or metal oxide powder starting material to produce spherical agglomerates.

(2) Debinding of the spray dried powders (spherical agglomerates) followed by high temperature sintering.

(3) Reduction of the sintered oxide agglomerates obtained in step (2) to metallic form. This step is only necessary when the starting materials are in an oxide form; when metal powders are used as the starting materials, the reduction step is not needed. Reduction may be performed as a separate step following sintering (sequential approach), or simultaneously with the sintering of step (2) in a single combined thermal step by conducting step (2) under a hydrogen or a forming gas atmosphere (simultaneous approach), in which oxide reduction and sintering consolidation occur concurrently in the same furnace and thermal cycle, reducing process steps and total thermal exposure. The temperature sufficient to achieve sintering consolidation and oxide reduction concurrently in a single combined thermal step may be determined by routine experimentation.

(4) Direct current (DC) plasma densification/spheroidization of the sintered powders. For the metal oxide route, this step is required to restore particle sphericity lost during the volume change accompanying reduction. For the metal and alloy route, this step is optional but preferred to achieve near-theoretical density. When metal powders are used as the starting materials, the high temperature sintering in step (2) may be replaced with a DC plasma treatment step in which the powder particles are simultaneously sintered and densified.

Thus, when the starting material is a metal oxide, the process involves spray drying, debinding, and either: (A) sequential sintering followed by a separate reduction step, then DC plasma densification; or (B) simultaneous sintering-reduction in a single thermal step under a hydrogen, hydrogen-containing, or forming gas atmosphere, then DC plasma densification. In the simultaneous approach (B), sintering consolidation and oxide-to-metal reduction occur concurrently in the same furnace cycle, after which DC plasma spheroidization is required to restore the sphericity and density lost during the volume change accompanying reduction. When the starting material is a metal, alloy, or a mixture of individual metals which comprise an alloy, the process involves spray drying, debinding, and high temperature sintering or DC plasma densification. For both types of raw materials, spray drying does not yield 100% spherical particles and the shape of the particles can get distorted during the sintering process, especially after reactive sintering of metals and reductions of oxides. Accordingly, for the metal oxide route, the DC plasma spheroidization step (4) is required; for the metal and alloy route, it is preferably employed.

Following spray drying and before debinding, the spray dried particles are screened to remove agglomerates and oversized particles. Optionally, after step (1) and prior to step (2), an additional screening step is performed to screen out and remove hard agglomerates and break soft agglomerates.

For the purposes of this disclosure, the term “primary” powder may be understood to refer to a particle having an average particle size D50 of about 0.01 microns to about 10 microns. For reactive metals (Ti, Ta, Zr, Hf) at particle sizes below about 0.1 microns, the powders may be pyrophoric and all handling, slurry preparation, and spray drying steps should be performed under inert atmosphere (e.g., argon or nitrogen). Non-reactive metals such as W, Mo, Re, Ni, Co, Fe, Cu, and their alloys are generally less pyrophoric than Ti, Ta, Zr, and Hf at these sizes, but fine powders of these metals are still combustible dust hazards and may be susceptible to surface oxidation; appropriate dust controls, grounding, and inert atmosphere or ventilation measures should be employed in accordance with applicable safety standards (e.g., NFPA 652). These particles may also be referred to as “fine particles” and these terms are used interchangeably herein. The term “agglomerated particle” or “agglomerates” may be understood to refer to particles having an average particle size D50 of about 5 to about 100 microns.

### Spray Drying Process

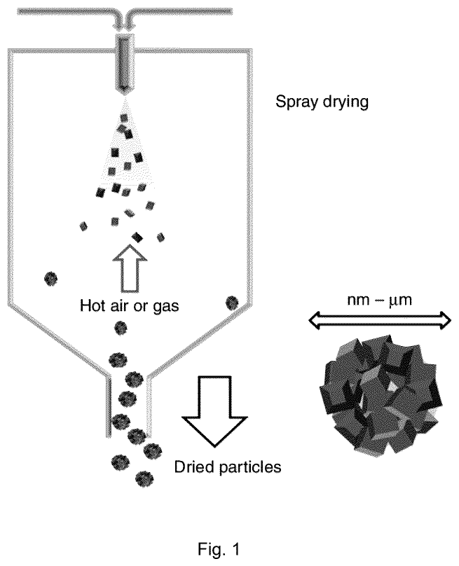

Spray drying is a well-known powder processing technique that is widely used for the production of granules of organic and inorganic matters. As shown in FIG. 1, in the spray drying process, a feed slurry transforms into fine droplets by passing through a nozzle. The fine droplets are atomized after passing through the nozzle. The atomized droplets then pass into a drying chamber where they are dried by a hot atmosphere.

The granulation of the primary powders used as starting materials in the methods described herein by spray drying, preferably using a centrifugal spray dryer to produce spherical particles, permits manipulation of the desired properties of the resulting powders, which include improved flowability, solubility, density, compatibility, dispersibility, and sinterability. The characteristics of the suspension (i.e., feed slurry) determine the morphology of the granules and, subsequently, the properties of the final metal or ceramic product. Other parameters affecting the properties of the obtained granules (such as morphology, size, and shape) include the device processing conditions and the characteristics of the starting powders.

The spray drying process may be performed in a commercially available spray dryer. For laboratory-scale development and process optimization, a two-fluid nozzle spray dryer such as the Mini Spray Dryer B-290 (BUCHI Corporation) may be used, but is not limited thereto. For industrial-scale production, a rotary atomizer spray dryer is preferred, such as the LPG-10 or similar centrifugal spray dryers, as rotary atomization provides higher throughput, more consistent spherical particle morphology, and better scalability than two-fluid nozzle systems.

An exemplary spray drying process includes two steps: (a) preparation of a slurry or mixture containing primary metal or metal oxide powders, and (b) spray drying of the slurry. As described in further detail below, the preparation of a slurry for spray-drying typically includes preparing a binder solution and mixing the primary powders with the binder solution and solvent. That is, the slurry contains the fine powder comprising the metal, metal alloy, or metal oxide, a solvent, and a binder. Appropriate solvents and binders are not particularly limited and are well known in the art; the particular solvent and binder solution may be determined by routine experimentation and are described in further detail below.

### Starting Materials

Different classes of materials may be used to make the spherical powders of metals and alloys according to the disclosure: those in metal oxide form and those in metallic form. The materials in metallic form may include alloys or mixtures of individual metals which constitute the alloys; these alloys are then formed during the sintering step. The fine powder starting materials are either obtained commercially or synthesized by known methods.

### Metals

The metal starting materials may be selected from metals, alloys, and mixtures of elemental metals, and specifically may be selected from transition metals, rare earth metals, binary alloys of refractory metals, multielement alloys including titanium alloys, iron alloys, aluminum alloys, copper alloys, cobalt alloys, nickel alloys, tungsten alloys, niobium alloys, and high entropy alloys, and metal matrix composite materials, as well as the mixtures of elemental metals which form these alloys. For the purposes of this disclosure, the term “metal starting material” may be understood to include all of these classes of metal-containing materials.

Exemplary transition metals and rare earth metals include, without limitation, scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), terbium (Tb), thulium (Tm), and ytterbium (Yb).

Exemplary binary alloys of refractory metals include Mo—Re alloys, W—Re alloys, Mo—W alloys, Mo—Ta alloys, Mo—Hf alloys, Ta—W alloys, and Ta—Nb alloys.

Exemplary multielement alloys include titanium alloys, iron alloys, aluminum alloys, copper alloys, cobalt alloys, nickel alloys, tungsten alloys, niobium alloys, and high entropy alloys.

Exemplary titanium alloys include Ti-6A1-4V, Ti-5A1-2.5Sn, and Ti-6A1-7Nb.

Exemplary iron alloys include low alloy steels, tool steels, stainless steels, soft magnetic steels, silicon steel, chromoly, Damascus steel, HSLA steel, high-speed steel, maraging steel, Elinvar, Invar, Kovar, and Spiegeleisen.

Exemplary copper or copper-based alloys include bronze (copper-tin alloy), brass, BeCu, CuNi and gun metal.

Exemplary cobalt or cobalt-based alloys include Alacrite, cobalt-chrome, Havar (alloy), HAYNES® NS-163, HAYNES® 188, Megallium, Nivaflex, Permendur, samarium-Co, Vicalloy, Vitallium, Stellite alloys, cobalt-nickel, and Co superalloys.

Exemplary nickel alloys include Ni 200, 201, 270, 400, 600, 601, DuraNi 301, Monel, Inconel®, Incoloy®, NIMONIC®, Hastelloy, NILO, FERRY alloy, NI-SPAN-C, Waspaloy, UDIMET®, INCOTHERM®, Invar, B-2, 70-30, C-Grade, X-750, 825, G-3, 800, C-276, C-22, 59, C-2000, 686, 617, HR-160, Nitinol, 2205, 2507, 254, SMO, Alloy 20, 3105, 800H, 625, nickel-aluminum alloys, nickel-chromium alloys, nickel-titanium alloys, and Ni superalloys.

Exemplary tungsten-based alloys include heavy tungsten alloys and tungsten carbide alloys.

Exemplary niobium alloys include NbZr, C103, C129Y, and NbTaTiV.

Exemplary high entropy alloys include 3d transition high-entropy alloys (THEAs), refractory high-entropy alloys (RHEAs), lightweight high-entropy alloys (LHEAs), lanthanide high-entropy alloys, noble metal high-entropy alloys, eutectic high-entropy alloys (EHEAs), high-entropy superalloys (HESAs), and high-entropy metallic glasses.

When alloys are formed in situ from mixtures of individual elemental metal powders rather than from pre-alloyed primary powders, the sintering step must provide sufficient time and temperature for complete interdiffusion of the constituent elements. For refractory metal alloys (e.g., W—Re, Mo—Re, Mo—Ta) and high entropy alloys, solid-state interdiffusion rates are intrinsically low, and incomplete homogenization may result in compositional gradients and inhomogeneous mechanical properties within individual powder particles. Accordingly, for complex alloy systems, particularly those containing refractory metals, the use of pre-alloyed primary powders is preferred. When elemental powder mixtures are employed, extended sintering times, higher sintering temperatures, or the use of finer primary powders (to reduce diffusion distances) may be necessary to achieve acceptable compositional homogeneity. Alternatively, the DC plasma spheroidization step may assist homogenization through complete melting and rapid resolidification of the powder particles.

Metal matrix composites (MMCs) are made by continuously dispersing a reinforcing material into a monolithic metallic material matrix. In structural applications, the matrix is usually a lighter metal such as aluminum, magnesium, or titanium, and provides a compliant support for the reinforcement. In high-temperature applications, cobalt and cobalt-nickel alloy matrices are common. Matrices based on Ag, Al, Be, Co, Cu, Fe, Mg, Ni and Ti are all commercially produced and used. Most common reinforcements used in commercial applications are Al₂O₃, B₄C, BeO, C, graphite, Mo, NbC, SiC, TaC, TiB, TiB₂, TiC, W, WC, and other ceramic materials. It is within the scope of the disclosure to include a broad spectrum of additives, including both metals and non-metals, dispersed in the metal matrix at varying contents.

The improvement of alloy tensile strength via reinforcement of alloys with oxides has been described. Oxide dispersion strengthened (ODS) alloys are alloys that consist of a metal matrix with small oxide particles dispersed within it. ODS variants improve high-temperature resistance properties and are designed to add strength (e.g., creep rupture, tensile, and fatigue strength) while retaining other good properties. Nickel alloys are the most common ODS base materials but the technology also extends to iron and aluminum alloys, titanium alloys, and refractory materials including niobium and tantalum alloys. Particularly, rare earth oxide (REO) additions can improve tensile strength and oxidation resistance of metals and alloys; such ODS materials often contain Y₂O₃, La₂O₃, Ce₂O₃, or more recently Y—Ti—O, where the titanium enables much smaller dispersoids to form. The use of all of the above materials is within the scope of this disclosure. See, for example, Wilms et al., Progress in Materials Science, Volume 133, 101049 (2023).

ODS materials are fundamentally distinct from MMCs. ODS alloys employ 0.2-0.5 wt. % nanoscale (typically 5-30 nm) oxide dispersoids that strengthen the alloy via Orowan dislocation pinning, requiring intragranular dispersoid placement to be effective. MMCs employ 5-30 vol. % micron-scale reinforcement for load transfer and do not require intragranular placement. These are separate material classes with distinct processing requirements and strengthening mechanisms.

The disclosure encompasses four distinct product pathways produced from the same spray drying platform, all of which may be used in the methods described herein:

(1) ODS powders, in which nanoscale oxide particles (less than about 50 nm) are first mechanically alloyed with the primary metal powder prior to slurry preparation. Mechanical alloying may be performed, for example and without limitation, by high-energy planetary ball milling, attritor milling, or acoustic milling (e.g., Resodyn acoustic mixer). During mechanical alloying, the severe plastic deformation repeatedly fractures and cold-welds the powder particles, breaking down the oxide nanoparticles and producing a non-equilibrium distribution of oxide constituents within the metal matrix as (i) supersaturated solute species, (ii) sub-nanometer to nanometer-scale amorphous clusters or complexes (e.g., Y-0, Y—Ti—O), and/or (iii) ultra-fine oxide fragments (typically <5 nm) intimately embedded within the metal lattice.

This approach is related to, but distinct from, the process employed for NASA's GRX-810 alloy, in which nano-Y₂O₃ was distributed onto NiCoCr powder surfaces via high-intensity acoustic mixing (Resodyn) prior to L-PBF consolidation. NASA's acoustic mixing process is characterized as a surface coating and distribution technique that achieves oxide attachment to metal particle surfaces without the severe plastic deformation and cold-welding characteristic of true mechanical alloying; accordingly, the GRX-810 process relies on the subsequent L-PBF melting and rapid solidification step to achieve intragranular dispersoid placement.

In contrast, Route (1) of the present disclosure encompasses both true mechanical alloying (planetary ball milling, attritor milling) and high-intensity acoustic milling at energy inputs sufficient to embed oxide species into the metal lattice, such that the intragranular dispersoid distribution is established prior to spray drying and sintering, and does not require a subsequent melting step for dispersoid placement. The mechanically alloyed powder is then used to prepare the slurry, spray dried into spherical agglomerates, and sintered in the solid state at a temperature below the solidus of the alloy. During sintering, the non-equilibrium oxide species nucleate and/or coalesce into nanoscale oxide dispersoids (typically 5-30 nm) at intragranular sites: dislocations, stacking faults, and nanocrystalline grain boundaries, created during milling, producing an ODS microstructure with intragranular nanoscale oxide dispersoids providing Orowan dislocation pinning. The resulting sintered ODS powder has a density of about 85 to about 95% of theoretical.

In certain embodiments, the sintered ODS powder may optionally be subjected to DC plasma spheroidization, as described in more detail below, with rapid quenching to increase the density to about 99 to about 100% of theoretical while preserving the intragranular dispersoid distribution. During plasma spheroidization, each particle is briefly melted and formed into a sphere by surface tension. Upon exiting the plasma zone, the molten droplets are rapidly quenched at a cooling rate of at least about 10³ K/s, and in certain embodiments at least about 10⁴, 10⁵, or 10⁶ K/s. Rapid quenching may be achieved by high-velocity inert gas quench (e.g., He, Ar, N₂), impingement of the droplets into a water-cooled collection chamber, collection into a liquid quench medium (water, brine, or oil with appropriate post-collection drying and passivation), or cryogenic gas cooling. At sufficiently high solidification velocities, the advancing solid-liquid interface engulfs nanoscale oxide features rather than pushing them to grain boundaries (consistent with established pushing/engulfment theory for nano-scale particles), thereby preserving the intragranular dispersoid distribution. Additionally, supersaturated oxide species and sub-nm clusters may partially dissolve during the brief melt residence time and reprecipitate intragranularly during rapid solidification. Without DC plasma spheroidization, the ODS powders at 85-95% density are suitable for consolidation by L-PBF, binder jetting, material extrusion (paste-based printing), and other additive manufacturing and powder metallurgy processes. With DC plasma spheroidization and rapid quenching, the ODS powders at 99-100% density are suitable for all of the foregoing processes with improved flowability and packing density. Simple mixing of nano-oxides with metal powders during spray drying without a prior mechanical alloying step does not produce ODS powders, because the insoluble oxide particles remain at prior particle boundaries during solid-state sintering and cannot migrate intragranularly in the absence of the non-equilibrium distribution established by mechanical alloying.

(2) Oxide-modified alloys, in which oxide particles (about 100 nm to about 5 μm) are incorporated during spray drying and the powders are subsequently plasma-spheroidized to full density (99-100% of theoretical), during which the oxide particles redistribute to grain boundaries and solidification cell boundaries upon resolidification, providing grain boundary strengthening via Zener pinning and Hall-Petch grain refinement, as well as improved oxidation resistance through the reactive element effect. Oxide-modified alloys are distinct from ODS materials; their strengthening mechanism operates through grain boundary pinning rather than intragranular dislocation pinning, and is realized in the powder itself rather than requiring a subsequent melting step. The oxide-modified alloy powders are fully dense and highly spherical, suitable for any additive manufacturing process, MIM, or conventional powder metallurgy. The DC plasma spheroidization step is included in the oxide-modified alloy pathway (2). For Route (1) (ODS), DC plasma spheroidization is optional and, when employed, requires rapid quenching as described herein to preserve the intragranular dispersoid distribution.

(3) Oxide-dispersed powders produced by colloidal processing without mechanical alloying. In this pathway, nanoscale or sub-micron oxide particles (e.g., Y₂O₃, La₂O₃, CeO₂, Al₂O₃, TiO₂, or complex oxides thereof, preferably having a particle size of about 10 nm to about 500 nm) are first deagglomerated and stabilized in a liquid carrier (water or organic solvent) using a dispersant (e.g., polyacrylic acid, ammonium polyacrylate, polyethyleneimine, or citrate, at about 0.1 to about 1 wt % relative to oxide) and ultrasonication and/or high-shear mixing to produce a stable oxide dispersion substantially free of agglomerates (D50 in liquid below about 500 nm). The primary metal powder is then combined with the stabilized oxide dispersion under agitation so that the oxide particles preferentially deposit onto metal particle surfaces by hetero-agglomeration, optionally aided by a polymer bridge binder (e.g., PVA, PVP, PVB, or PEG at about 0.2 to about 2 wt % relative to metal) and/or by electrostatic hetero-coagulation in which the pH is adjusted so that the oxide and metal surfaces have opposite zeta potentials, promoting controlled attachment of the oxide onto the metal. The resulting oxide-decorated metal powder is then used to prepare a slurry with a temporary organic binder and spray dried to produce spherical agglomerates. During spray drying, the multi-particle granule assembly converts the surface-distributed oxide into oxide distributed throughout the granule interior. Following debinding and solid-state sintering below the alloy solidus to a density of about 85% to about 98% of theoretical, the oxide particles become physically captured as an internal inclusion population within the densified granule. The sintered granules are then subjected to DC plasma spheroidization (DC or RF/ICP plasma) as described below.

During the brief melt residence time, the oxide inclusions are retained within the molten droplet and, upon solidification, are engulfed by the advancing solid-liquid interface rather than being expelled to grain boundaries, consistent with established pushing/engulfment criteria for particles in this size range. The resulting powder is fully dense (about 99 to about 100% of theoretical), highly spherical, and contains fine oxide inclusions distributed throughout the particle interior. This pathway is distinct from Route (1) (ODS via mechanical alloying) in that the oxides are not dissolved into the metal lattice and do not form intragranular nanoscale dispersoids by a dissolution-reprecipitation mechanism; rather, the oxide exists as discrete fine inclusions (typically 10-500 nm) that provide dispersion strengthening by a combination of Orowan pinning (for the finest inclusions) and load transfer to the oxide phase. This pathway is distinct from Route (2) (oxide-modified alloys) in that the oxide is distributed throughout the particle interior rather than concentrated at grain boundaries. The oxide-dispersed powders produced by this pathway are suitable for all additive manufacturing processes including L-PBF, directed energy deposition, binder jetting, and material extrusion.

In alternative embodiments of Route (3), the oxide phase may be introduced by an in-situ precursor method rather than by direct addition of oxide nanoparticles. In this variant, a soluble metal-organic or inorganic precursor containing the desired oxide-forming element (e.g., yttrium nitrate, yttrium acetate, cerium nitrate, or lanthanum acetylacetonate) is deposited onto the metal powder surfaces from solution, and subsequently converted to the oxide phase during debinding or sintering under controlled atmosphere. This approach can produce finer and more uniformly distributed oxide particles than direct nanoparticle addition. In a further variant, the spray drying parameters may be controlled to produce core-shell granules in which the outer shell is enriched in metal (for improved flowability and rapid melting during plasma spheroidization) and the inner region is enriched in the oxide phase (for strengthening), by staged feeding during spray drying or by sequential coating of the spray-dried granules.

When the ODS powders produced by Route (1) are consolidated by laser powder bed fusion (L-PBF), the powder particles undergo rapid melting and resolidification within the laser melt pool. L-PBF solidification rates are typically in the range of about 10⁵ to about 10⁷ K/s, which exceed the minimum cooling rates required for engulfment of nanoscale oxide features by the advancing solid-liquid interface. During the brief melt pool residence time (on the order of microseconds to low milliseconds), some fraction of the nanoscale oxide dispersoids may partially dissolve into the melt and subsequently reprecipitate as nanoscale complex oxides (e.g., Y—Al—O, Y—Ti—O, or Y—Si—O phases depending on alloy chemistry) during rapid solidification. Such reprecipitated oxides remain within the strengthening architecture and may be finer than the original dispersoids due to the high nucleation density associated with rapid cooling. In alloy systems containing aluminum (e.g., Ni-base superalloys with >3 wt. % Al), oxide loading should be controlled to avoid excessive slagging or cavity formation in the melt pool; oxide loadings of about 0.1 to about 1.0 wt. % are generally suitable for L-PBF consolidation.

The ODS powders of the present disclosure are suitable for L-PBF consolidation across multiple alloy families including nickel-base alloys (e.g., Inconel® 718, Inconel® 625, Hastelloy X, NiCoCr medium-entropy alloys), iron-base alloys (e.g., 316L, 304L, 17-4PH, ferritic/martensitic 9-12Cr steels), cobalt-base alloys (e.g., CoCrMo, Stellite-type, CoNiCrAlY), refractory metals and alloys (e.g., W, Mo, W—Re, Mo—Re, Nb, Ta), high-entropy alloys (e.g., refractory HEAs, 3d transition HEAs), and titanium alloys (e.g., Ti-6A1-4V), with the oxide species selected from Y₂O₃, La₂O₃, CeO₂, HfO₂, ZrO₂, Al₂O₃, TiO₂, and complex oxides thereof.

Verification of dispersoid retention in L-PBF consolidated ODS articles is performed by a combination of density measurement (Archimedes method and/or micro-computed tomography (micro-CT) to confirm density and quantify residual porosity and/or micro-cracking; preferably ≥99.5% of theoretical density for nickel-, iron-, and cobalt-base systems, and in certain refractory embodiments (e.g., tungsten)≥97% of theoretical density prior to optional HIP), scanning electron microscopy (SEM) to characterize melt pool and cellular solidification structure, and transmission electron microscopy (TEM) of specimens prepared by focused ion beam (FIB) lift-out from as-built regions. TEM analysis includes bright-field and high-angle annular dark-field scanning TEM (HAADF-STEM) imaging to determine dispersoid size distribution (target: about 5 to about 50 nm mean diameter) and location (intragranular vs. cell wall/grain boundary), energy-dispersive X-ray spectroscopy (STEM-EDS) to confirm oxide chemistry (Y, O, and where applicable Ti, Al, or Hf enrichment), and selected area electron diffraction (SAED) or nanobeam diffraction to identify the oxide phase. This verification protocol is applicable to all alloy systems consolidated by L-PBF from Route (1) ODS powders produced according to the methods of this disclosure.

(4) Melt-mediated nano-oxide dispersion strengthening without mechanical alloying. In this pathway, nanoscale oxide particles and/or oxide-forming precursors are combined with primary metal powder (D50 about 0.01 to about 10 microns) in a slurry prior to spray drying, such that the oxide-bearing primary particles are distributed throughout the volume of each spray-dried secondary agglomerate (D50 about 5 to about 150 microns). The agglomerates are debound and may optionally be pre-sintered below the solidus temperature to impart handling strength. The debound (and optionally pre-sintered) agglomerates are then subjected to plasma spheroidization and/or laser spheroidization to at least partially melt the agglomerates and form spherical droplets by surface tension. Similar melt-mediated routes have been shown to incorporate and disperse nanoscale oxides without mechanical alloying when coated powders are consolidated by laser powder bed fusion.

During the brief molten interval in Route (4), oxide feedstock and/or oxide-forming constituents may undergo dissolution, reaction, and reprecipitation during rapid solidification, and the resulting oxide structure can depend on melt time/temperature history and alloy chemistry (for example, reactions between Y₂O₃ and Al and the formation of larger slag inclusions under certain conditions have been reported in melt-pool studies of dispersion-strengthened alloys).

The spheroidized droplets are rapidly solidified (e.g., by high-velocity inert gas quenching, impingement on water-cooled inert surfaces, or liquid quenching in an inert or low-reactivity quench medium followed by drying/passivation) to limit coarsening and to “freeze in” the oxide distribution within each particle. The inventors note that plasma spheroidization includes a melting stage in which oxides can coagulate and migrate toward the particle surface in certain systems; therefore, Route (4) preferably uses (i) oxide distributed throughout the granule interior prior to melting, (ii) minimized molten residence time, (iii) alloy/oxide chemistries that improve wetting and stability of complex oxides, and/or (iv) quench conditions sufficient to limit segregation and coarsening.

In certain embodiments, Route (4) produces spherical powders having a density of at least about 95% (and in some embodiments at least about 99%) of theoretical density and containing an oxide phase distributed within the particle interior. In further embodiments, the oxide phase is present as intragranular nanoscale dispersoids (e.g., about 5 to about 50 nm) formed during solidification, thereby providing an ODS-type dispersion strengthening effect without mechanical alloying.

In the spray drying process, the rare earth oxide may coat the metal particles, providing an even distribution of the oxide particles on the surfaces of the metal particles. Prior techniques for combining oxides with metal alloys involved high energy mill coating, which is an expensive undertaking and does not provide the type of even distribution obtained using the above-described spray-drying technique. This technique may be particularly applicable to Ni-based and Fe-based alloys, although it may be employed with other types of alloys or individual metals as well.

Thus, while essentially any transition metal or known alloy may be employed for forming a spherical powder according to the methods of the disclosure, the process is most advantageous from a cost perspective for the highest melting point metals such as Ta, Nb, Hf, W, Re and Mo and refractory and high temperature alloys because the cost of direct metal atomization process increases very significantly with the increase of atomization temperature, which has to be above the melting point of the metal being atomized. For example, the melting point for Mo is about 2623° C.

### Metal Oxides

Metal oxides are less expensive than metals and require much lower sintering temperatures than the corresponding metals, which results in lower processing cost. Examples of metal oxides within the scope of this disclosure include oxides of any of the metals listed above, including transition metal oxides and rare earth metal oxides, without limitation, the oxides of scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), terbium (Tb), thulium (Tm), and ytterbium (Yb).

As explained in more detail below, the method described herein which employs metal starting materials may be used for metal oxide starting materials as well. However, the metal oxide route requires a reduction step to convert the oxide to elemental metal. This reduction may be performed in two ways: (A) sequentially, as a separate thermal step following sintering, in the same or a different furnace; or (B) simultaneously with sintering as a single concurrent thermal process, in which the debound spherical oxide agglomerates are heated under a hydrogen, hydrogen-containing, or forming gas atmosphere to a temperature sufficient to achieve both sintering consolidation and oxide-to-metal reduction concurrently. The simultaneous sintering-reduction approach (B) is particularly preferred for readily reducible oxides such as WO₃, MoO₃, and Fe₂O₃, where reduction temperatures overlap with practical sintering temperatures. For more thermodynamically stable oxides (e.g., Ta₂O₅, Nb₂O₅, TiO₂), the sequential approach (A) may be preferred, as higher temperatures or longer hold times required for reduction may compromise agglomerate integrity if sintering and reduction are conducted simultaneously. In both cases, the subsequent DC plasma spheroidization step is required to restore particle sphericity and achieve near-theoretical density following the volume change accompanying reduction.

### Slurry Preparation

As previously explained, an exemplary spray drying process includes two steps: (a) preparation of a slurry or mixture containing primary metal or metal oxide powders, and (b) spray drying of the slurry. The preparation of a slurry for spray-drying typically includes preparing a binder solution and mixing of the primary powders with the binder solution.

In certain embodiments, the slurry includes primary metal or metal oxide powders in a water- or organic solvent-based slurry containing an organic binder. Appropriate organic solvents include, without limitation, acetone, alcohol, etc. Exemplary binders include, without limitation, polyvinyl alcohol (PVA), polyvinylpyrrolidone (PVP), polyvinyl butyral (PVB), and the like. Other binders, such as water-soluble dextrose, glucose, cellulose, starch, and the like, may be used as well.

In certain embodiments, the binder solution contains the binder in an amount of about 1 to about 1.5% wt., based on the total weight of the binder solution.

In certain embodiments, the slurry may further include an additive such as a dispersant to reduce agglomeration of the powders. Suitable dispersant may include, for example, anionic, cationic, or non-ionic surfactants, polymeric (e.g., polyacrylic, polyphosphonate, or the like) dispersants, stearic acid dispersants, and the like, which may be included in an amount of less than about 1 weight %.

In certain embodiments, an activator or sintering aid may be added to the metal or metal oxide powders during the step of mixing them with the binder. Alternatively, an activator may be added to the original metal powder. The inclusion of an activator in an amount of about 0.1 to about 1% by weight to the metal powder to be sintered allows for a reduction in the sintering temperature of the metal; for refractory metal systems (e.g., W, Mo, Ta), the reduction is about 800° C. to about 1200° C., so that sintering of metal powders and refractory alloys can be conducted in relatively inexpensive resistance heater furnaces which can sinter at temperatures up to 1700° C.

For example, tungsten with Ni activator additions can be sintered at approximately 1400-1500° C. instead of the conventional 2400-2700° C. (Samsonov and Yakovlev, Powder Metallurgy and Metal Ceramics, 6, 606-611 (1967)), and molybdenum with Ni activator can be sintered at approximately 1200-1400° C. instead of the conventional 2200° C. Higher temperatures require the use of much more expensive (by a factor of five to ten) sintering furnaces which increases cost of the product significantly. It is within the scope of the disclosure to employ activators such as Ni, Fe, Pt and Ru, which are known to reduce sintering temperatures of refractory metals and high temperature alloys below 1700° C. However, other appropriate activators which are known in the art or to be developed would also be appropriate provided they provide for a similar reduction in sintering temperature.

It should be noted that Ni and Fe activators may segregate to grain boundaries in refractory metals, potentially reducing ductility and high-temperature mechanical properties. For structural aerospace applications requiring maximum mechanical integrity, activator concentrations should be minimized (e.g., ≤0.1 wt. %) or alternative activated sintering approaches may be employed. In applications where embrittlement is a concern, the use of Pt or Ru activators, which have higher solubility in refractory metals, may be preferred despite their higher cost.

The mixing may be performed in a planetary vacuum mixer, as this type of mixer will advantageously produce a slurry which is free of air, although other types of mixers may be used as well.

After mixing the primary metal or metal oxide powders with the binder solution to obtain a slurry or mixture, the slurry may optionally be further homogenized in a ball mill to activate particle surface and achieve highly homogeneous distribution of the solid components in the slurry, including the metal or metal oxide powders, binder components, and additives such as activator and REO oxides, as explained below. In preferred embodiments, the slurry has a solids content of about 25% to about 35% by weight, more preferably about 27% to about 33% solids by weight.

When preparing an ODS powder according to Route (1), nanoscale oxide particles (<less than about 0 nm D50) are first mechanically alloyed into the metal powder via, for example, high-energy planetary ball milling, attritor milling, or acoustic milling (e.g., Resodyn acoustic mixer) to establish intragranular dispersoid distribution before slurry preparation and spray drying. For oxide-modified alloys according to Route (2) (with plasma spheroidization), oxide particles of about 100 nm to about 5 μm (D50) are appropriate, as these particles will redistribute to grain boundaries during plasma treatment to provide Zener pinning and Hall-Petch strengthening. In each case, the oxide is preferably included in the slurry in an amount between about 0.5% to about 3.0% wt., preferably between about 0.75% and about 1.5% wt. based on the total weight of solids. For oxide-dispersed powders according to Route (3), nanoscale or sub-micron oxide particles (about 10 nm to about 500 nm D50) are deagglomerated in a liquid carrier with a dispersant and deposited onto metal powder surfaces by hetero-agglomeration prior to slurry preparation; the oxide is preferably included in an amount between about 0.1% to about 2.0% wt., preferably between about 0.2% and about 1.5% wt. based on the total weight of solids.

### Spray Drying Process

As previously explained, in a spray drying process, a feed slurry transforms into fine droplets by passing through a nozzle where they are atomized, and then pass into a drying chamber where they are dried by a hot atmosphere (e.g., hot air or inert gas, at a temperature of about 50° C. to about 300° C.) to remove any remaining volatile substances, including solvent. It is desirable to use a cyclone to capture dry powder and transfer it into a filter bag. It is further desirable to use a rotary spray dryer as it allows for the production of highly spherical particles which is critical for the manufacturing of spherical powders. The parameters used for the spray drying process may be determined by routine experimentation based on the specific metal or metal oxide starting material.

Optionally following the spray drying step, the spray dried powders may optionally be subjected to a screening step to screen out hard agglomerates and break soft agglomerates. The screening of large agglomerates may be performed using a known apparatus, such as, for example, on a vibratory screener such as Sweco.

### Debinding Process

Following spray drying and optional screening, the spray dried powders are debound to remove any remaining binder. Thermal debinding of the spray dried powders may be conducted in a dedicated debinding furnace, such as an atmosphere furnace or an inert gas shielded furnace, separate from the microwave sintering furnace. In preferred embodiments, debinding is performed in a separate furnace from the microwave sintering furnace, as the organic volatiles and carbonaceous residues released during binder burnout may coat the microwave cavity walls, waveguides, and susceptor elements, degrading microwave coupling efficiency and potentially damaging the furnace. In alternative embodiments, debinding and sintering may be performed sequentially in the same furnace provided that the furnace design accommodates adequate gas flow to remove binder decomposition products before the microwave sintering cycle begins, and that the cavity and susceptor materials are resistant to carbonaceous deposits; this combined debind-and-sinter approach may be advantageous for oxygen-sensitive alloys (e.g., Ti, Ta, Zr, Hf) where minimizing furnace transfers reduces the risk of oxygen pickup. The debinding furnace is operated under a flowing atmosphere of hydrogen, forming gas (N₂/12), or inert gas (Ar, N₂) to carry away binder decomposition products. The temperature range and time for debinding are dependent on the type of binder and starting material, but are typically in the range of about 200° C. to about 600° C. and for a period of about 1 to about 5 hours; these parameters may be determined by routine experimentation and thermogravimetric analysis (TGA) of the binder system. Residual carbon from incomplete debinding is a known contamination pathway; for refractory metals where carbon forms stable carbides that affect mechanical properties, target residual carbon levels should be below about 0.01 wt. % C as measured by LECO combustion analysis. After the binder has been completely removed, the debound agglomerates are transferred to the sintering furnace. For reactive metals (Ti, Ta, Zr, Hf), the transfer should be performed under inert atmosphere to prevent oxygen pickup.

### Sintering

Powder sintering is a thermal treatment process that binds metal powder particles together to create a solid, dense piece. The process involves heating the powder to a temperature below the solidus temperature of the metal or alloy, which allows the particles to fuse together without melting. The sintering may be performed in an inert atmosphere (such as nitrogen, argon, etc.), pure hydrogen or a forming gas (e.g., a mixture of H₂ and an inert gas). Both inductive and resistance heaters or furnaces may be used for powder sintering; these devices are well known in the art and the specific parameters used for the sintering may be determined by routine experimentation. As previously explained, the use of an activator reduces the sintering temperature of the metal powder.

However, to further reduce manufacturing cost and improve densification, it is highly desirable to use a microwave oven for sintering.

In contrast to traditional heating methods, microwave sintering of powders offers certain advantages, such as energy efficiency, environmental friendliness, higher densification, and a fine grain size due to the faster heating rates and the lower sintering temperature. (See, for example, Janney et al., Ceramic Powder Science II, 21(18), 919-924 (1988)); Math et al., Metals, 6(7), 143 (2016)). Additionally, uniform volumetric heating and smaller and equiaxed pores in the sintered green compacts and fine microstructure are added advantages of microwave sintering. According to Rajkumar et al., (J. Mater. Proc. Technol., 209, 5601-5605 (2009)), microwave sintering should result in improved mechanical properties and better product performance.

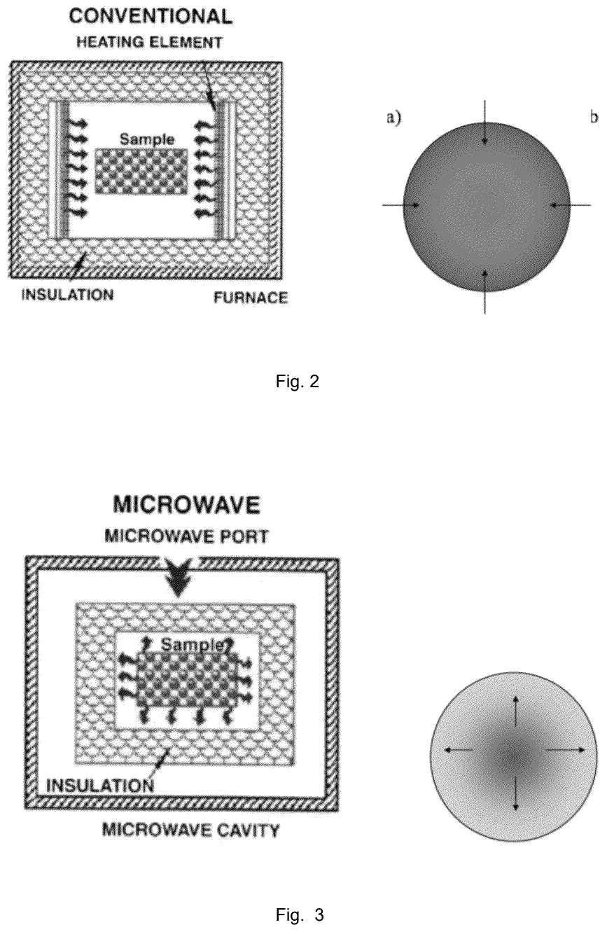

The basic difference between traditional and microwave sintering processes lies in the heating mechanism. (See, e.g., Agarwal, Trans. Ind. Ceram. Soc., 65, 129-144 (2006)). As shown in FIG. 2, in conventional heating, the specimen (i.e., particle) is heated using heating elements like silicon rods. The heat is then transferred to the specimen from the outer to the inner surface of the specimen either by conduction, convection or radiation. This can create thermal gradients, which may result in non-uniform heating and internal stresses in the specimen.

In contrast, as shown in FIG. 3, microwave sintering involves electromagnetic field coupling with the material, resulting in volumetric power deposition within the specimen. Under appropriate coupling conditions, this can produce more uniform heating compared to conventional surface-to-core conduction, although thermal gradients may still develop depending on penetration depth, specimen geometry, and material properties. For conductive metal powders, hybrid heating using susceptor materials (e.g., SiC or graphite) is commonly employed to initiate and sustain coupling at lower temperatures.

The most recent development in microwave applications is in sintering of metal powders, a surprising application, in view of the fact that bulk metals reflect microwaves.

However, reflection by a metal occurs only when it is in a solid, nonporous form and is exposed to microwaves at room temperature. Metals in the form of fine powder can absorb microwave energy under appropriate conditions, depending on particle size, oxide surface films, packing density, and percolation behavior. Hybrid heating using susceptor materials is often employed to initiate heating of metal powders at lower temperatures where direct microwave coupling may be insufficient. Because of this volumetric heating mechanism, microwave sintering can provide an efficient densification approach, with laboratory-scale studies demonstrating energy savings of 60-90% over conventional sintering for certain material systems. (See Roy et al., Nature, 399, 668-670 (1999); see also Aman et al., Advanced Engineering Materials, 26, 2302065 (2024)).

In the microwave sintering process, 2.45 GHz and 915 MHz are the commonly used microwave frequencies, with a suitable frequency range being about 2.45 GHz and 890-950 MHz. The specimen is usually housed in an insulated alumina chamber or tube. The insulation of the chamber ensures that the heat generated within the specimen does not escape and is effectively utilized. The temperature generated in the specimen can be measured using, e.g., an infrared (IR) sensor, optical pyrometer and/or sheathed thermocouple, which is placed close enough to the surface of the specimen. The sintering chamber is appropriately equipped to provide the desired inert atmosphere by passing an inert gas, such as Ar or N₂, and is capable of achieving temperatures up to 1600° C. and is typically operated at a temperature range of about 200° C. to about 1600° C. For refractory metal systems requiring sintering temperatures above 1600° C., even with the use of activators, conventional resistance heater furnaces (capable of temperatures up to 1700° C.) may be employed in lieu of microwave sintering. The microwave sintering apparatus or furnace normally includes four parts, namely: (a) a microwave generator or magnetron; (b) a susceptor; (c) a heating system; and (d) a programmable controller.

Depending on the starting material and the selected process pathway, the spray dried agglomerates may be sintered under different atmospheres. When metal powders are used as the starting material, sintering is performed in an inert gas atmosphere (such as Ar or N₂). When metal oxide powders are used as the starting material, sintering may be performed in either: (A) an inert gas atmosphere (sequential pathway), in which sintering consolidation is completed first, followed by a separate reduction step under hydrogen or forming gas; or (B) a hydrogen or forming gas atmosphere (simultaneous pathway), in which the H₂ partial pressure serves the dual function of (i) providing the reducing atmosphere necessary to convert the oxide to metallic form, and (ii) acting as a furnace atmosphere during sintering consolidation, such that oxide reduction and sintering occur concurrently in the same thermal cycle. In the simultaneous approach (B), the sintering temperature profile and H₂ partial pressure must be selected to ensure that oxide reduction is substantially complete concurrent with or prior to achievement of the target sintered density. Simultaneous sintering-reduction is particularly suitable for readily reducible oxides (WO₃, MoO₃, Fe₂O₃) whose reduction temperatures fall within practical sintering temperature ranges. For more stable oxides (Ta₂O₅, Nb₂O₅, TiO₂), sequential approach (A) is generally preferred.

Optionally, following sintering, the sintered powders may also be passed through a screen to remove agglomerated particles and achieve a size of about 5 to about 100 microns, or other sizes as desirable.

Reduction Process (Sequential or Simultaneous with Sintering)

When metal oxide powders are used as the starting materials, reduction converts the oxide to its metal form and may be performed either: (A) sequentially, as a separate thermal step following sintering, either in a single furnace or in different furnaces; or (B) simultaneously with sintering as a single concurrent thermal process in a single furnace, wherein the debound spherical oxide agglomerates are heated under a hydrogen or forming gas atmosphere at a temperature and for a time sufficient to effect both sintering consolidation and oxide reduction concurrently in the same furnace cycle. In both pathways (A) and (B), it should be noted that reduction of metal oxides (e.g., WO₃, Ta₂O₅, MoO₃) is accompanied by significant volume change (typically 30-55%), which may cause particle cracking and loss of sphericity. Accordingly, for the metal oxide route regardless of whether the sequential or simultaneous approach is employed, the DC plasma spheroidization step described below is required to restore particle sphericity and achieve near-theoretical density after the reduction step. In other words, unlike the metal powder route where DC plasma spheroidization is optional, the oxide route should be understood to include DC plasma spheroidization as a necessary process step.

With respect to reduction, there are two types of metals in the periodic table of elements: metals that can be reduced by a H₂ reduction process and metals that cannot. Both types of metals may be reduced using metallothermic reduction, a method of using a metal (or its alloy) as a reducing agent to reduce a metal-based compound at a high temperature which depends on the specific metal to obtain a pure target metal. This method has been widely adopted in industrial metallurgical processes.

Calcium, magnesium, aluminum, and sodium are typically used for reduction, but a reducer is specifically selected according to its activity, availability and volatility, ability to form compounds and to alloy with the produced metallic powder, and the ease with which it can be removed from the final product.

Metallothermic reduction is a general term for reduction reactions conducted to obtain a target metal or compound from feed material such as oxides or chlorides (halides) by using a metal as a reducing agent. Many reactive metals such as Ti, Ta, V, and REMs are produced by metallothermic reduction. Depicting the reducing agent as R and the feed material as MX, the reaction of a metallothermic reduction for producing metal M is generally expressed by the following equation: MX+R→M+RX.

There are generally two ways the metallothermic reduction process may be implemented: a non-contact method and a mixing method. In an exemplary non-contact method, a powder that needs to be reduced and a reducing agent are placed in separate trays in a furnace and in this case, the powder is reduced by the vapor produced by the reducing agent. In an exemplary mixing method, the powder that is being reduced is mixed with the reducing agent and the mixture is heated to a temperature which is dependent on the material being reduced.

It is beneficial in a metallothermic reduction process to use powders of alloys and reducing agents with different particle size distributions (PSDs) so that the reducing agent may be screened out after the reduction is completed. In addition, it is desirable that the screened powder is washed in a non-oxidizing acid such as hydrochloric acid or phosphoric acid to remove contamination from the particle's surfaces.

Alternatively to the metallothermic reduction process, carbothermal reduction may be utilized. Carbothermic reactions involve the reduction of substances, often metal oxides (O²⁻), using carbon as the reducing agent. These chemical reactions are typically conducted at temperatures ranging from about 600° C. to about 2000° C. depending on the thermodynamic stability of the oxide; for example, iron oxides may be carbothermically reduced at about 600° C. to about 1000° C., while refractory metal oxides such as WO₃ and MoO₃ generally require temperatures of about 1000° C. to about 1500° C., and more stable oxides such as TiO₂ and ZrO₂ may require temperatures exceeding 1500° C.

However, one of the major downsides of carbothermic reduction is the contamination of the metal with carbon impurities. To mitigate carbon contamination when carbothermal reduction is employed, a subsequent vacuum or hydrogen decarburization step may be performed at temperatures of about 800° C. to about 1200° C. to reduce residual carbon content to acceptable levels (e.g., below 0.1 wt. % for most applications, or below 0.01 wt. % for aerospace-grade materials). Alternatively, the carbothermal reduction may be followed by the DC plasma spheroidization step, during which residual carbon may be partially volatilized.

### Optional Plasma Spheroidization/Densification

In certain embodiments, the process of spherical powder manufacturing may further include a spheroidization step using DC plasma processing, which improves the spheroidization and densification of the powders produced by spray drying and sintering. This step is applicable to Route (2) (oxide-modified alloys), Route (3) (oxide-dispersed powders), Route (4) (melt-mediated nano-oxide dispersion without mechanical alloying), to metal or alloy powders processed without oxide additions, and to Route (1) (ODS) powders when combined with rapid quenching as described below. For Route (1) (ODS), DC plasma spheroidization with rapid quenching is required to achieve full density while retaining the nano-scale oxide dispersoids within the metal matrix. For the metal oxide starting material route, this step is required to restore particle sphericity and density lost during the volume change accompanying oxide-to-metal reduction. This step enables the production of spray-dried and sintered particles with density close to theoretical and in the range of 99-100%, with greater reliability than commercially known atomization methods.

When oxide-containing powders are subjected to DC plasma spheroidization according to the oxide-modified alloy pathway (Route (2)), the millisecond melt residence time causes redistribution of oxide particles to grain boundaries and solidification cell boundaries upon resolidification. The resulting oxide-modified alloy particles are fully dense (about 99% to about 100% of theoretical) and highly spherical, with oxide particles providing grain boundary strengthening through three complementary mechanisms: (a) Zener pinning, in which grain boundary-pinned oxide particles resist grain growth during subsequent thermal processing (printing, HIP, heat treatment), resulting in finer grain size; (b) Hall-Petch strengthening from the refined grain structure; and (c) the reactive element effect, in which REO particles at grain boundaries improve oxide scale adherence and oxidation resistance, particularly in Ni-based and Fe-based alloy systems. These oxide-modified alloy powders are suitable for all additive manufacturing processes including L-PBF, directed energy deposition, binder jetting, material extrusion, and conventional powder metallurgy including MIM. The grain boundary strengthening of Route (2) provides moderate improvements in strength and oxidation resistance, whereas Route (1) achieves the superior high-temperature creep resistance characteristic of true intragranular ODS materials. Route (3) (oxide-dispersed powders) achieves an intermediate level of dispersion strengthening, with fine oxide inclusions distributed throughout the particle interior providing both Orowan-type pinning (for the finest inclusions) and load transfer, without requiring the mechanical alloying step of Route (1). Route (4) (melt-mediated nano-oxide dispersion) achieves dispersion strengthening by combining nanoscale oxide particles with primary metal powder during slurry preparation and relying on plasma spheroidization with rapid solidification to dissolve, react, and reprecipitate oxide phases within the particle interior, without requiring either the mechanical alloying step of Route (1) or the colloidal hetero-agglomeration and pre-sintering steps of Route (3).

In certain embodiments of Route (1) (ODS), the sintered ODS powder particles may be subjected to DC plasma spheroidization followed by rapid quenching to achieve near-theoretical density (99-100%) while preserving the intragranular nanoscale dispersoid distribution. The spheroidized molten droplets are rapidly quenched upon exiting the plasma hot zone at an effective cooling rate of at least about 10³ K/s, and in further embodiments at least about 10⁴, 10⁵, or 10⁶ K/s. Rapid quenching may be achieved by, for example, a high-velocity inert gas quench (e.g., He, Ar, N₂), impingement into a water-cooled collection chamber, collection into a liquid quench medium (with appropriate post-collection drying and passivation for reactive alloy systems), or cryogenic gas cooling. The resulting spherical particles exhibit nanoscale oxide dispersoids (e.g., Y-containing oxides, Y—Ti—O complex oxides) distributed substantially intragranularly.

Without being limited by theory, sufficiently high solidification velocities favor engulfment of nanoscale oxide features by the advancing solid-liquid interface over rejection to grain boundaries, consistent with established pushing/engulfment criteria for nano-scale particles (critical velocity decreasing with decreasing particle radius). Additionally, supersaturated oxide constituents and sub-nanometer clusters present in the mechanically alloyed powder may partially dissolve during the brief melt residence time and reprecipitate as intragranular dispersoids during rapid solidification. The functional requirement for preserving ODS character during plasma spheroidization is a melt residence time of less than about 10 milliseconds for particles in the 15-150 μm size range and a quench rate sufficient to limit dispersoid coarsening beyond about 50 nm and to limit preferential migration of dispersoids to grain boundaries, as verified by TEM showing mean dispersoid size of about 50 nm or less and predominantly intragranular placement.

However, when alloys and metal powders are used as starting materials, the high temperature sintering step may be replaced with a spheroidization step rather than spheroidization being performed after sintering as is the case with metal oxide powder starting materials. That is, the spray dried metal or metal alloy powder may be subjected directly to DC plasma processing after it is debound.

Thermal plasma synthesis is a relatively new process that has been successfully applied to generate spheroidized powders of a variety of metal and ceramic powders, as described, for example, in “Spheroidisation of iron powder in a microwave plasma” (van Laar et al. (Journal of the South African Institute of Mining and Metallurgy; 116, 941 (2016))). It has been found that high temperature and highly concentrated enthalpy available in the plasma jet can melt and vaporize virtually any material. The high quench rate favors homogeneous nucleation, resulting in spheroidized particles.

The RF plasma process that currently dominates the atomization market was originally developed for atomization of metals and alloys and has been also used for spheroidization/densification of particles. Commercially available RF atomization and spheroidization tools are very expensive and equally unreliable, which makes the process of manufacturing of spheroidized powders very expensive. Further, the tools are sold as R&D tools, not industrial tools.

On the other hand, DC plasma spraying technique was initially applied for enhancing the corrosion resistance of hard metal surfaces in the early 1900s. Extensive industrial applications have increased steadily in the chemical, automotive, aeronautic and space, electronic, ceramic and nuclear fields. DC plasma systems generally offer higher energy densities and greater scalability than RF systems at equivalent power levels. For powder spheroidization applications, the power of DC plasma spray torches typically ranges from about 20 kW to about 500 kW for laboratory and pilot-scale operations (e.g., Praxair/TAFA SG-100 at 80 kW, PlazJet at 200+kW); in certain industrial-scale embodiments, DC plasma torches such as those manufactured by Mettech, Pyrogenesis, and similar suppliers may operate at powers of about 500 kW to about 5 MW for high-throughput powder production, while the power from existing RF plasmatrons generally does not exceed 1 MW. DC plasma torches for spheroidization applications can operate with durations of up to 103 hours. For the embodiments described herein, DC plasma spheroidization may be performed using a DC non-transferred arc plasma torch operating at a power of about kW to about 500 kW and passing the spherical metal powder particles through a plasma plume to at least partially melt the spherical metal powder particles and spheroidize by surface tension.

These DC systems, therefore, are attractive due to their high energy efficiency and can be used for the realization of high-temperature processes on an industrial scale.

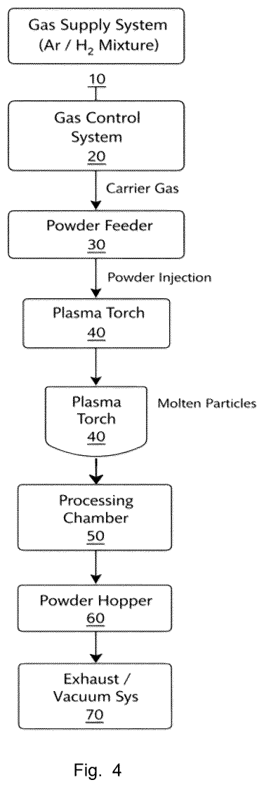

FIG. 4 shows a diagram of a plasma powder spheroidization system. The system contains a gas supply system 10, a gas control system 20, a powder feeder 30, plasma torch 40, processing chamber 50, powder hopper 60, and exhaust/vacuum system 70.

Employing an optional final spheroidization step in the method described herein for spherical powder manufacturing enables the production of spray-dried and sintered particles with density close to theoretical. In the case of metal and metal alloy powders, the DC plasma processing step may eliminate a high temperature sintering step.

During DC plasma spheroidization, satellite formation may occur, in which small particles or solidified splashes weld onto the surfaces of larger spherical particles during flight or collection. Satellite formation is a known phenomenon in plasma processing of metal powders and can degrade powder flowability and packing density. To mitigate satellite formation, one or more of the following measures may be employed: (i) optimization of the powder feed rate to reduce particle-to-particle collisions in the plasma plume; (ii) control of the plasma gas flow and power to ensure complete melting and adequate particle separation; (iii) use of a cyclone or inertial separator to remove fine satellite-generating particles from the collection stream; and (iv) post-processing classification by sieving, air classification, or other size-separation methods to remove satellite-bearing particles from the product fraction. In preferred embodiments, the DC plasma operating parameters (power, gas composition, feed rate, and injection geometry) are optimized to minimize satellite incidence to below about 5% of particles by number.

For refractory metal systems containing elements with volatile oxide or sub-oxide phases, element volatilization during DC plasma spheroidization should be considered. In particular, rhenium heptoxide (Re₂O₇) sublimes at approximately 360° C. and molybdenum trioxide (MoO₃) sublimes at approximately 700° C. For alloys containing rhenium (e.g., W—Re, Mo—Re), any residual oxide present during the plasma step may volatilize, causing compositional deviation from the target alloy stoichiometry. To mitigate element volatilization: (i) oxide reduction should be substantially complete before DC plasma processing, with target oxygen levels below about 0.05 wt. % as measured by inert gas fusion analysis; (ii) the plasma gas composition may include a reducing component (e.g., H₂ at about 1-10 vol. %) to suppress oxide formation during processing; and (iii) acceptable compositional deviation limits should be defined for the specific alloy system (e.g., ±0.5 wt. % Re for W—Re alloys). The DC plasma residence time (typically less than about 10 milliseconds for particles in the 15-150 μm size range) limits the extent of volatilization of metallic species, but this residence time is sufficient to volatilize low-sublimation-point oxide phases if they are present.

In certain embodiments, the sintering step may be omitted entirely, and the debound agglomerates may be fed directly into the DC plasma torch for simultaneous densification and spheroidization. This debind-and-plasma pathway is particularly suitable for metal and alloy systems (non-oxide starting materials) where the spray-dried agglomerates have sufficient green strength after debinding to survive powder feeding and injection into the plasma plume. In this pathway, the process comprises: (a) spray drying a slurry a metal or metal alloy powder having an average particle size D50 of about 0.01 microns to about 10 microns, an organic binder, and a solvent to produce spherical agglomerates; (b) debinding the spherical agglomerates in a dedicated debinding furnace; and (c) feeding the debound agglomerates directly into a DC plasma torch (without a prior sintering step), wherein the debound agglomerates are simultaneously densified and spheroidized to near-theoretical density (99-100% of theoretical) by the DC plasma. This pathway reduces process complexity, eliminates the capital cost and energy consumption of the sintering furnace, and may be advantageous for applications where throughput and cost are primary considerations. The debound agglomerates for the debind-and-plasma pathway preferably have a density of at least about 40% of theoretical to ensure sufficient structural integrity for powder feeding.

In certain embodiments directed to sinter-based additive manufacturing processes, including binder jetting, material extrusion (such as fused filament fabrication (FFF) of metal-filled filaments, metal injection molding (MIM)-type feedstock extrusion, and bound metal deposition), and indirect 3D printing processes that require a subsequent sintering step to achieve final part density, the DC plasma spheroidization step is omitted, and the spray-dried and sintered powder is the final powder product. In these applications, the sintered spherical powder particles have a density of about 70% to about 95% of theoretical density, with residual interconnected or closed porosity that provides sinter activity during the part-level sintering or hot isostatic pressing (HIP) step that follows the additive manufacturing build.

For binder jetting and material extrusion applications where maximum sinter activity and uniform part-level shrinkage are desired, a granule density of about 70% to about 85% of theoretical density is preferred. Lower granule densities within this range provide a greater thermodynamic driving force for sintering, a higher density of diffusion pathways through interconnected porosity, and more uniform dimensional change during the part sintering cycle, resulting in improved final part density and reduced risk of residual porosity or density gradients. Granule densities above about 90% of theoretical density, while still suitable for certain sinter-based AM applications, may result in reduced sinter activity and require higher sintering temperatures, longer hold times, or supplemental hot isostatic pressing to achieve full part density. This residual porosity is beneficial because it enables the powder particles to sinter together during part consolidation, achieving final part densities of about 97% to about 100% of theoretical density. Fully dense (about 99% to about 100% TD) spherical powder particles, such as those produced by gas atomization or plasma spheroidization, may exhibit insufficient sinter activity for binder jetting and material extrusion applications, leading to incomplete part densification or requiring higher sintering temperatures and longer hold times. The intentionally porous powder produced by the spray drying and sintering process described herein thus provides a performance advantage for sinter-based AM processes by combining the favorable flowability and packing characteristics of spherical particle morphology with enhanced sinter activity relative to fully dense powders.

For alloy systems that include a lower-melting constituent capable of forming a liquid phase during part-level sintering, such as tungsten heavy alloys (W—Ni—Fe, W—Ni—Cu), cemented carbides (WC—Co), copper-infiltrated tungsten composites, and other multi-phase alloys containing a binder phase with a solidus temperature below the sintering temperature, the spray-dried and sintered powder particles produced according to the methods described herein are particularly advantageous. During the part-level sintering cycle, the binder phase melts to form a liquid that provides capillary-driven rearrangement, solution-reprecipitation densification, and pore elimination through liquid phase sintering (LPS), enabling rapid achievement of near-theoretical part density. The homogeneous distribution of binder elements within each spray-dried granule, achieved through slurry-level mixing as described herein, ensures uniform liquid phase formation throughout the part cross-section during LPS, reducing the risk of localized density gradients and binder pooling that can occur when blending pre-alloyed powders of dissimilar particle sizes. In these embodiments, the sintering activators described herein may serve the dual function of reducing the granule-level sintering temperature during powder manufacturing and contributing to the liquid phase during part-level LPS. For the avoidance of doubt, the spray-dried and sintered powders produced for sinter-based AM applications described herein may be produced from any of the alloy families described herein, including but not limited to refractory metals and their alloys, nickel-based superalloys, cobalt-based alloys, iron-based alloys, titanium alloys, copper alloys, aluminum alloys, high entropy alloys, and metal matrix composites, and are not limited to tungsten heavy alloy compositions.

In certain embodiments directed to sinter-based AM, the sintering step during powder manufacturing may be conducted at a temperature and time sufficient to produce a liquid phase from a lower-melting constituent within the spray-dried granule, thereby achieving granule-level liquid phase sintering and producing spherical powder particles with a density of about 95% to about 100% of theoretical density at the granule level without requiring a subsequent plasma spheroidization step. Thus, the sintering step forms a liquid phase within each debound agglomerate form a lower-melting constituent in the metal alloy powder or from partial melting between the solidus and liquidus temperatures of the metal allow, whereby the individual granules are densified to a density of about 95% to about 100% of theoretical density by liquid phase sintering at the granule level without a subsequent plasma spheroidization step.

In some embodiments, the method may involve preparing a slurry comprising a pre-alloyed metal powder, organic binder, and solvent. In this case, the heating step may involve heating the debound agglomerates to a temperature between the solidus and liquidus temperatures of the metal alloy to cause partial melting and formation of a liquid phase between each debound agglomerate, whereby the individual agglomerates are densified to a density of about 95% to about 100% of theoretical density by liquid phase sintering at the granule level without a subsequent plasma spheroidization step. The heating may be performed in a fluidized bed furnace, a rotating tube furnace, or on a non-wetting substrate selected from the group consisting of boron nitride-coated alumina and yttria-stabilized zirconia.

This granule-level LPS pathway is applicable to alloy systems in which the liquid phase is a designed constituent of the final alloy composition, such that its presence does not degrade the target mechanical or physical properties. Exemplary alloy systems suitable for granule-level LPS include tungsten heavy alloys (about 85 to about 97 wt. % W with Ni, Fe, Cu, or Co balance), cemented carbides (WC with about 3 to about 25 wt. % Co), and copper-tungsten composites (about 10 to about 40 wt. % Cu). To prevent inter-granule bridging and agglomeration during granule-level LPS, the sintering may be performed in a fluidized bed furnace, a rotating tube furnace, or on a non-wetting substrate (such as boron nitride-coated alumina or yttria-stabilized zirconia). The fully dense spherical powder particles produced by granule-level LPS are suitable for laser powder bed fusion (L-PBF), directed energy deposition (DED), plasma spray, cold spray, and other AM and thermal spray processes that require fully dense feedstock powder.

In certain embodiments, the sintering step during powder manufacturing is conducted as supersolidus liquid phase sintering (SLPS), wherein spray-dried granules composed of pre-alloyed powder are heated to a temperature between the solidus and liquidus temperatures of the alloy, causing partial melting and formation of an intragranular liquid phase along grain boundaries within each individual granule. The intragranular liquid provides capillary-driven densification of the individual granule to a density of about 95% to about 100% of theoretical density without requiring a subsequent plasma spheroidization step. Unlike conventional SLPS, which is applied to densify macroscopic compacts or additively manufactured green parts, the granule-level SLPS described herein is applied to densify individual loose powder particles during the powder manufacturing process itself. This distinction is significant because the engineering challenges differ fundamentally: granule-level SLPS requires prevention of inter-granule bridging and agglomeration while maintaining particle sphericity, whereas part-level SLPS requires management of macroscopic shrinkage and shape fidelity. To prevent inter-granule agglomeration during granule-level SLPS, the sintering is performed under conditions that minimize inter-particle contact, including but not limited to sintering in a fluidized bed furnace with inert gas fluidization, sintering in a rotating or tumbling tube furnace, sintering on a non-wetting substrate or setter (such as boron nitride-coated alumina, yttria-stabilized zirconia, or graphite for non-carbide-forming systems), or sintering in a drop-tube or free-fall configuration. The SLPS temperature window for granule-level densification is alloy-specific and is determined by the solidus-liquidus gap of the alloy; for alloys with narrow solidus-liquidus gaps (less than about 20° C., such as Inconel® 718 or certain tool steels), precise temperature control is required, and microwave sintering as described herein is advantageous because the volumetric heating mechanism provides more uniform temperature distribution across the powder bed than conventional radiative heating, thereby reducing the risk of localized overheating and granule distortion.

Exemplary alloy systems suitable for granule-level SLPS include, without limitation: nickel-based superalloys (such as Inconel® 718, Inconel® 625, Waspaloy, HAYNES® 230, HAYNES® 282, René 41, René 80, René N5, CMSX-4, Mar-M-247, Udimet 720, and Astroloy), for which the SLPS temperature is typically between about 1260° C. and about 1350° C. depending on alloy composition; cobalt-based alloys (such as Stellite 6, Stellite 21, CoCrMo alloys for medical and dental applications, and HAYNES® 188), for which the SLPS temperature is typically between about 1275° C. and about 1375° C.; tool steels and high-speed steels (such as M2, M4, T15, H13, and D2), for which the SLPS temperature is typically between about 1240° C. and about 1300° C.; stainless steels (such as 316L, 17-4PH, and 420), for which the SLPS temperature is typically between about 1350° C. and about 1420° C.; and aluminum alloys (such as 6061, 7075, and 2024), for which the SLPS temperature is typically between about 580° C. and about 640° C. The liquid volume fraction during granule-level SLPS is preferably maintained between about 5% and about 30% by volume to achieve densification without excessive granule distortion or loss of sphericity. The sintering hold time at the SLPS temperature is preferably between about 1 minute and about 60 minutes, with shorter hold times being preferred for alloys with wider solidus-liquidus gaps and higher liquid volume fractions.

In certain embodiments, the sintering step during powder manufacturing is conducted as transient liquid phase sintering (TLPS), wherein a transient liquid-forming additive is incorporated into the spray drying slurry in addition to the primary metal powder. During sintering, the additive melts or forms a eutectic liquid with the primary metal at a temperature below the solidus of the primary alloy, providing capillary-driven densification of the individual granule. The transient liquid subsequently solidifies by isothermal diffusion of the liquid-forming element into the solid matrix, such that the final granule is compositionally homogeneous and contains no residual liquid-forming phase at ambient temperature. The TLPS pathway is particularly advantageous because it enables granule-level densification to about 95% to about 100% of theoretical density at temperatures significantly below the solidus of the primary alloy, thereby reducing energy consumption and avoiding the narrow temperature processing windows associated with SLPS. Furthermore, because the liquid-forming additive is fully absorbed into the solid matrix, the final powder composition and properties are not compromised by the presence of a residual low-melting phase.

Exemplary transient liquid-forming additives and alloy systems suitable for granule-level TLPS include, without limitation: boron additions of about 0.1 to about 1.0 wt. % to nickel-based superalloys, stainless steels, and cobalt-based alloys, wherein the boron depresses the local solidus and forms a transient Ni—B, Fe—B, or Co—B eutectic liquid at temperatures between about 1050° C. and about 1200° C. that subsequently diffuses into the matrix; copper additions of about 1 to about 5 wt. % to iron-based alloys and steels, wherein the copper melts at about 1085° C. and diffuses into the iron matrix providing solid solution strengthening; silicon additions of about 0.5 to about 3 wt. % to nickel-based alloys, forming a transient Ni—Si eutectic; phosphorus additions of about 0.1 to about 0.8 wt. % to iron-based alloys and steels; and tin additions of about 1 to about 5 wt. % to copper-based alloys, forming a transient Cu—Sn liquid. In each case, the transient liquid-forming additive is added to the slurry as a fine powder (preferably having a particle size D50 of less than about 5 μm) or as a soluble precursor compound that decomposes during debinding or sintering to release the liquid-forming element. The slurry mixing and spray drying process described herein ensures homogeneous distribution of the transient liquid-forming additive throughout each granule, which is critical for uniform liquid formation and complete subsequent homogenization. The same agglomeration prevention methods described above are employed during TLPS.

For the avoidance of doubt, the Ni and Fe sintering activators described above may function as transient liquid-forming additives when present at concentrations sufficient to form a eutectic liquid phase with the primary metal during sintering. For example, in tungsten and molybdenum systems, Ni additions in the range of about 0.1 to about 1.0 wt. % may form a transient Ni—W or Ni—Mo liquid at temperatures above the respective eutectic temperatures. At the lower end of this range (about 0.1 to about 0.3 wt. %), the Ni functions primarily as a solid-state activated sintering aid; at the upper end (about 0.5 to about 1.0 wt. %), the Ni may form a transient liquid phase that provides enhanced densification. The distinction between activated sintering and TLPS is one of degree rather than kind, and both mechanisms may operate simultaneously depending on the sintering temperature and activator concentration. The spray-dried and sintered powders produced by granule-level SLPS or TLPS as described herein are suitable for all additive manufacturing and thermal spray processes, including but not limited to laser powder bed fusion (L-PBF), electron beam melting (EBM), directed energy deposition (DED), plasma spray, high-velocity oxy-fuel (HVOF) spray, cold spray, and binder jetting (where fully dense feedstock powder may be preferred for certain applications requiring minimal part-level sintering shrinkage).

By employing the methods described herein, highly spherical powder particles of metals, alloys, metal oxides, and mixtures of elemental metals may be produced, including highly spherical powder particles of transition metals, rare earth metals, binary alloys of refractory metals, multielement alloys including titanium alloys, iron alloys, aluminum alloys, copper alloys, cobalt alloys, nickel alloys, tungsten alloys, niobium alloys, and high entropy alloys, and metal matrix composite materials.

The highly spherical metal powder particles described herein may be used in a method of sinter-based additive manufacturing. Such a method involves providing the spherical metal powder particles having a density of about 70% to about 95% of theoretical density with residual interconnected porosity; forming a green part by binder jetting, fused filament fabrication, MIM-type feedstock extrusion, or bound metal deposition; and sintering the green part to at least about 97% of theoretical density without supplemental hot isostatic pressing.

The materials produced by the methods described herein have high sphericity such as sphericity of at least about 0.85, at least about 0.90, or greater. For the metal and metal alloy routes processed through DC plasma spheroidization (Route (2) and non-oxide-containing powders), density is close to theoretical and in the range of about 99 to about 100%. For the ODS route (Route (1)), density is in the range of about 85 to about 95% of theoretical after solid-state sintering, or about 99 to about 100% of theoretical when DC plasma spheroidization with rapid quenching is employed. For the oxide-dispersed route (Route (3)), density is about 99 to about 100% of theoretical after DC plasma spheroidization. For the melt-mediated route (Route (4)), density is at least about 95% of theoretical (and in some embodiments at least about 99%) after plasma spheroidization with rapid solidification. These densities are much greater than commercially known methods which often only achieve densities of 80 to 85% without the plasma spheroidization step. Further, the materials described herein have favorable and improved tensile strength and temperature properties and favorable powder flowability properties, such as a Hall flow rate of about 30 seconds per 50 grams or less as measured by ASTM B213

As used herein, powder characterization methods include the following unless otherwise specified: sphericity and circularity are measured by automated image analysis (e.g., Malvern Morphologi G3 or equivalent); particle size distribution (PSD) is measured by laser diffraction (e.g., Malvern Mastersizer) or sieve analysis according to ASTM B214; powder density is measured by helium pycnometry (e.g., Micromeritics AccuPyc) in accordance with ASTM B923; powder flowability is measured by Hall flow funnel in accordance with ASTM B213 or Carney funnel in accordance with ASTM B964; and oxygen and carbon content are measured by inert gas fusion analysis (e.g., LECO ONH836 for oxygen, LECO CS844 for carbon) in accordance with ASTM E1019 and ASTM E1941, respectively. Apparent density is measured in accordance with ASTM B212 and tap density in accordance with ASTM B527.

The methods described herein may provide cost and energy advantages over conventional RF plasma atomization and gas atomization processes for producing spherical metal powders, particularly for refractory metals and high-temperature alloys. The combination of spray drying (which operates at ambient to moderate temperatures of about 50° C. to about 300° C.), microwave sintering (which can achieve significant energy savings over conventional sintering for appropriate material systems), and DC plasma spheroidization (which can be scaled to high throughput using industrial-scale torches) may result in lower energy consumption per kilogram of spheroidized powder product compared to RF plasma atomization or gas atomization for certain material systems and production scales. For DC plasma spheroidization, the specific energy consumption may be less than about 50 kWh per kilogram of product, depending on the material system, target particle size distribution, plasma torch configuration, and operating conditions. The process throughput is scalable from laboratory quantities (about 0.1 to about 1 kg/h) to industrial production rates (about 10 to about 100 kg/h or more) by employing larger DC plasma torches and parallel spray drying/sintering operations. These cost and energy advantages may be most pronounced for refractory metals (W, Mo, Re, Ta, Nb, Hf) and their alloys, where RF plasma atomization costs can be high due to the extreme melting points and the need for specialized crucible-free atomization equipment.

### Spherical Metal Powders

Additional aspects of the disclosure relate to spherical metal powders comprising metal powder particles having an average particle size D50 of about 5 to about 100 microns, a density of about 70% to about 100% of theoretical density, a sphericity of at least about 0.85 as measured by automated image analysis, and a sintered polycrystalline microstructure comprising multiple grains derived from individual primary powder particles bonded by solid-state sintering necks, with residual closed porosity distributed within a particle interior.

In preferred embodiments, the metal powder particles comprise a refractory metal or refractory metal alloy selected from the group consisting of W, Mo, Re, Ta, Nb, Hf, W—Re, Mo—Re, Mo—Ta, Mo—Hf, and Ta—Nb. In other preferred embodiments, the spherical metal powder is ODS powder comprising intragranular nanoscale oxide dispersoids having an average particle size D50 of about 5 to about 50 nm providing Orowan dislocation pinning, and has a density of about 85% to about 100% of theoretical density; or an oxide-modified alloy powder comprising oxide particles at grain boundaries providing Zener pinning, and has a density of about 99% to about 100% of theoretical density.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

The invention will now be described with the following, non-limiting examples.

### EXAMPLES

The following examples are provided to illustrate representative embodiments of the methods described herein; they are not intended to limit the scope of the invention. Certain examples are prophetic and may include estimated property values based on known material behavior, published data for analogous systems, and engineering calculations; actual measured values may differ. Where experimental measurements are reported, such measurements were obtained using the stated characterization methods and test conditions. Unless otherwise indicated, all parts and percentages are by weight. Where ethanol or other flammable solvents are specified, the laboratory spray dryer is understood to be operated in closed-loop nitrogen mode with an inert-loop accessory suitable for organic solvents. Where a BUCHI B-290 is used to target spray-dried agglomerate D50 values above the standard fine-powder range, the example assumes the ultrasonic nozzle package rather than the standard two-fluid nozzle.

### Example 1: Production of Spherical W-25Re Alloy Powder from Elemental Metal Powders

This example illustrates the production of spherical W-25Re (75 wt. % tungsten, 25 wt. % rhenium) alloy powder from elemental metal powders via spray drying, microwave sintering, and DC plasma spheroidization.

Slurry Preparation. Primary tungsten powder (D50=1.2 μm, purity≥99.95%, Global Tungsten & Powders) and primary rhenium powder (D50=3.5 μm, purity≥99.99%, Molymet) were weighed in a ratio of 75:25 by weight. An activator consisting of nickel powder (D50=2.0 μm, purity≥99.9%) was added at 0.35 wt. % based on total metal weight to reduce the sintering temperature. A binder solution was prepared by dissolving polyvinylpyrrolidone (PVP, K-30, MW ~40,000) in deionized water at a concentration of 1.2 wt. %. The metal powders and activator were combined with the binder solution in a Thinky ARE-310 planetary vacuum mixer and mixed at 2000 rpm for 8 minutes under vacuum (−95 kPa). The resulting slurry had a solids content of 30 wt. %. The slurry was further homogenized in a planetary ball mill (Retsch PM 100) at 250 rpm for 30 minutes using yttria-stabilized zirconia (YSZ) milling media (3 mm diameter).

Spray Drying. The homogenized slurry was spray dried using a BUCHI Mini Spray Dryer B-290 equipped with the Ultrasonic Package (ultrasonic nozzle). The inlet temperature was set at 220° C., the outlet temperature was maintained at 110° C., the feed rate was 8 mL/min, and the ultrasonic nozzle was operated at settings selected to produce the target agglomerate size distribution. A nitrogen atmosphere was used as the drying gas at a flow rate of 35 m3/h. The spray dried agglomerates were collected in a cyclone separator. The resulting agglomerates had a D50 of 38 μm with a particle size distribution ranging from 15 μm to 75 m.

Screening. The spray dried powder was classified on an ultrasonic laboratory sieve shaker fitted with 20 μm and 63 μm electroformed screens to remove hard agglomerates (>63 m) and fine particles (≤20 μm). The screened powder fraction (20-63 μm) represented approximately 72% of the total spray dried output.

Debinding and Microwave Sintering. The screened powder was loaded into alumina crucibles and debound in a dedicated atmosphere furnace by heating from room temperature to 350° C. at a ramp rate of 2° C./min and holding for 2 hours under flowing argon (2 L/min). The debound powder was transferred to a controlled-atmosphere 2.45 GHz microwave sintering furnace rated for operation to at least 1600° C. and sintered at 1550° C. for 45 minutes under flowing argon at a ramp rate of 15° C./min. The total cycle time including both furnace operations was approximately 5.5 hours. The sintered powder had a density of 92.5% of theoretical as measured by helium pycnometry (Micromeritics AccuPyc II 1340).

DC Plasma Spheroidization. The sintered W-25Re powder was subjected to DC plasma spheroidization using a Praxair SG-100 DC plasma torch system. The plasma operating parameters were: arc current 500 A, voltage 38 V, argon plasma gas flow 50 SLPM, hydrogen secondary gas flow 8 SLPM, and powder feed rate 3.5 kg/h. The carrier gas (argon) flow was 4 SLPM. The powder was injected into the plasma plume via an external injection port oriented perpendicular to the torch axis. The spheroidized powder was collected in a water-cooled collection tank under argon atmosphere.

Results. The properties of the W-25Re spherical powder produced according to this Example are summarized in Table 1.

TABLE 1
Properties of Spherical W-25Re Powder (Example 1)

| Property | After Sintering | After DC Plasma |
|---|---|---|
| D50 (μm) | 36 | 35 |
| Apparent Density (g/cm³) | 17.8 | 19.1 |
| % Theoretical Density | 92.5% | 99.2% |
| Hall Flow (s/50 g) | 38.2 | 22.5 |
| Sphericity (Camsizer X3) | 0.88 | 0.97 |
| Oxygen Content (ppm) | 320 | 85 |
| Carbon Content (ppm) | <30 | <20 |

As shown in Table 1, the DC plasma spheroidization step significantly improved the density from 92.5% to 99.2% of theoretical, and improved flowability as reflected by the Hall Flow measurement decreasing from 38.2 to 22.5 s/50 g. The sphericity increased from 0.88 to 0.97 (where 1.0 is a perfect sphere). The oxygen content was substantially reduced during DC plasma processing, confirming the benefit of the high-temperature plasma treatment.

### Example 2: Production of Spherical Molybdenum Powder from Molybdenum Trioxide

This example illustrates the production of spherical molybdenum powder from molybdenum trioxide (MoO₃) via spray drying, microwave sintering, hydrogen reduction, and DC plasma spheroidization.

Slurry Preparation. Molybdenum trioxide powder (MoO₃, D50=2.8 μm, purity≥99.95%, H. C. Starck) was used as the starting material. A binder solution was prepared by dissolving polyvinyl butyral (PVB, Butvar B-76) in ethanol at a concentration of 1.3 wt. %. A dispersant (BYK-111, anionic) was added at 0.5 wt. % based on solids weight. The MoO₃ powder was combined with the binder solution in a planetary vacuum mixer (Thinky ARE-310) and mixed at 2000 rpm for 10 minutes. The slurry had a solids content of 28 wt. %. The slurry was subsequently homogenized in a ball mill for 20 minutes.

Spray Drying. The slurry was spray dried using a BUCHI B-290 spray dryer equipped with the Ultrasonic Package (ultrasonic nozzle). The inlet temperature was 180° C., the outlet temperature was 95° C., the feed rate was 10 mL/min, and the ultrasonic nozzle was operated at settings selected to produce the target agglomerate size distribution. Nitrogen was used as the drying gas.

Screening. The spray dried powder was classified using an ultrasonic laboratory sieve shaker with 15 μm and 75 μm electroformed screens. Approximately 68% of the product fell within the target 15-75 μm range.

Debinding, Combined Reduction, and Microwave Sintering. Debinding was performed in a dedicated atmosphere furnace by heating to 400° C. at 3° C./min and holding for 1.5 hours under flowing nitrogen (2.5 L/min). The debound powder was transferred to a microwave sintering furnace (2.45 GHz). The furnace atmosphere was set to a 50 vol. % H₂/50 vol. % Ar mixture (total flow 5 L/min) and the powder was heated at 5° C./min to 1100° C. with a 60-minute hold. The flowing H₂/Ar mixture served the dual function of reducing MoO₃ to metallic Mo (MoO₃→MoO₂→Mo, occurring progressively between 500° C. and 900° C. on the heating ramp) and continuously sweeping the H₂O generated during reduction out of the furnace chamber, preventing re-oxidation. Once metallic Mo had formed, continued heating to 1100° C. effected solid-state sintering of the metallic Mo agglomerates sintering of the metal phase requires substantially lower temperatures than sintering of the oxide precursor would require. The reduced and sintered Mo powder was cooled under flowing Ar to room temperature. Oxygen analysis (LECO ONH836) confirmed an oxygen content of approximately 400 ppm after the combined reduction/sintering step.

DC Plasma Spheroidization. The reduced Mo powder was processed through a DC plasma system (Praxair SG-100 torch) at: arc current 450 A, voltage 35 V, argon plasma gas 55 SLPM, hydrogen secondary gas 6 SLPM, and powder feed rate 4.0 kg/h.

Results. The properties of the spherical molybdenum powder are summarized in Table 2.

TABLE 2
Properties of Spherical Mo Powder (Example 2)

| | After Combined | |
|---|---|---|
| Property | Reduction/Sintering | After DC Plasma |
| D50 (μm) | 37 | 36 |
| % Theoretical Density | 89.5% | 99.5% |
| Hall Flow (s/50 g) | 40.1 | 19.8 |
| Sphericity | 0.82 | 0.96 |
| Oxygen (ppm) | 400 | 120 |

As shown in Table 2, the oxide route yielded molybdenum powder with 99.5% of theoretical density after DC plasma treatment. In the combined reduction/sintering step, simultaneous H₂ reduction and microwave sintering under 50/50 H₂/Ar at 1100° C. yielded metallic Mo agglomerates at 89.5% of theoretical density with 400 ppm residual oxygen, eliminating the need for a separate tube furnace reduction step. The sphericity of 0.82 after the combined reduction/sintering step reflecting volume shrinkage associated with oxygen loss—was restored to 0.96 after DC plasma spheroidization, confirming the importance of the spheroidization step when oxide starting materials are employed.

### Example 3: Production of Oxide-Modified Inconel® 718 Powder with Y₂O₃ Reinforcement (Route 2)

This example illustrates the production of an oxide-modified Inconel® 718 powder containing 1.0 wt. % yttria (Y₂O₃) via spray drying with microwave sintering.

Slurry Preparation. Pre-alloyed Inconel® 718 powder (D50=5.2 μm, purity compliant with AMS 5662, Praxair Surface Technologies) and yttria (Y₂O₃, D50=500 nm, purity≥99.99%, American Elements) were used as starting materials. The Y₂O₃ was added at 1.0 wt. % based on total solids weight. A binder solution of PVP (1.2 wt. %) in deionized water was prepared. The Inconel® 718 powder and Y₂O₃ were combined with the binder solution and a non-ionic dispersant (Triton X-100, 0.3 wt. %) in a planetary vacuum mixer at 2000 rpm for 10 minutes. The slurry (solids content 32 wt. %) was homogenized in a planetary ball mill at 200 rpm for 45 minutes using YSZ media.

Spray Drying. The slurry was spray dried in a BUCHI B-290 spray dryer fitted with the Ultrasonic Package, with inlet temperature 200° C., outlet temperature 105° C., feed rate 7 mL/min, the ultrasonic nozzle operated at settings selected to produce the target agglomerate size distribution, and nitrogen drying gas at 32 m3/h. The resulting agglomerates had a D50 of 32 μm.

Debinding and Microwave Sintering. Debinding was performed at 300° C. for 2 hours (ramp 2.5° C./min) under argon in a dedicated atmosphere furnace. The debound powder was transferred to the microwave sintering furnace. Sintering was performed at 1240° C. for 75 minutes under argon at a ramp rate of 12° C./min in a microwave sintering furnace (2.45 GHz).

DC Plasma Spheroidization. The sintered oxide-modified powder was processed through DC plasma at: arc current 420 A, voltage 34 V, argon plasma gas 50 SLPM, hydrogen secondary gas 5 SLPM, powder feed rate 5.0 kg/h.

Results. The properties of the oxide-modified Inconel® 718 powder are summarized in Table 3.

TABLE 3
Properties of Oxide-Modified Inconel ® 718 + 1.0%
Y₂O₃ Powder (Example 3)

| Property | After Sintering | After DC Plasma |
|---|---|---|
| D50 (μm) | 31 | 30 |
| % Theoretical Density | 94.8% | 99.6% |
| Hall Flow (s/50 g) | 31.5 | 18.2 |
| Sphericity | 0.90 | 0.98 |
| Oxygen (ppm) | 580 | 210 |

SEM/EDS analysis of polished cross-sections of the oxide-modified powder particles confirmed Y₂O₃ particles (50-300 nm) redistributed to grain boundaries and solidification cell boundaries within the Inconel® 718 matrix. This distribution was substantially more homogeneous than that obtained by conventional mechanical alloying of 30-40 μm atomized powders with oxide particles, as characterized by comparing the coefficient of variation (CV) of yttrium signal intensity across 50 randomly selected particle cross-sections. The spray-dried oxide-modified powder exhibited a CV of 12%, compared with 38% for a conventionally prepared reference sample.

### Example 4: Production of Spherical Tantalum Powder from Tantalum Pentoxide Via Metallothermic Reduction

This example illustrates the production of spherical tantalum powder from tantalum pentoxide (Ta₂O₅) using calcium metallothermic reduction.

Slurry Preparation and Spray Drying. Ta₂O₅ powder (D50=1.5 μm, purity≥99.99%, H. C. Starck) was prepared as a slurry with PVP binder (1.2 wt. %) in deionized water at 29 wt. % solids. The slurry was mixed in a planetary vacuum mixer and spray dried on a BUCHI B-290 fitted with the Ultrasonic Package, at inlet temperature 210° C., outlet 100° C., feed rate 9 mL/min, with the ultrasonic nozzle operated at settings selected to produce the target agglomerate size distribution, under nitrogen. D50 of the spray dried agglomerates was 45 m.

Debinding. Debinding was performed at 380° C. for 2.5 hours under argon in a dedicated atmosphere furnace.

Combined Metallothermic Reduction and Sintering. Combined calcium metallothermic reduction and sintering was performed using the non-contact method. The debound Ta₂O₅ agglomerates (D50=43 μm) were placed in a molybdenum tray and calcium granules (−10 mesh, 99.5% purity) were placed in a separate molybdenum tray within the same furnace. The stoichiometric excess of calcium was 20% over the theoretical requirement. The furnace was heated to 1100° C. at 5° C./min and held for 6 hours under argon (1.5 L/min). At this temperature, the calcium vapor progressively reduced the Ta₂O₅ to metallic tantalum, and the freshly formed fine Ta metal simultaneously underwent solid-state sintering and densification at the 1100° C. hold temperature. After cooling, the reduced powder was washed sequentially with 5% hydrochloric acid (3 washes×30 min each with agitation) followed by deionized water rinses (5 washes) to remove CaO and residual calcium. The washed powder was vacuum dried at 80° C. for 12 hours. Oxygen analysis confirmed 680 ppm residual oxygen.

DC Plasma Spheroidization. The reduced Ta powder was processed through the DC plasma system (Praxair SG-100) at: arc current 480 A, voltage 36 V, argon plasma gas 52 SLPM, hydrogen secondary gas 7 SLPM, powder feed rate 3.0 kg/h.

Results. The properties are summarized in Table 4.

TABLE 4
Properties of Spherical Tantalum Powder (Example 4)

| | After Combined | | |
|---|---|---|---|
| | Ca Reduction/ | After | After |
| Property | Sintering | Wash | DC Plasma |
| D50 (μm) | 40 | 39 | 38 |
| % Theoretical Density | 85.7% | 86.3% | 99.1% |
| Sphericity | 0.78 | 0.79 | 0.96 |
| Oxygen (ppm) | 680 | 620 | 140 |
| Ca (ppm) | 3,200 | <50 | <20 |

As shown in Table 4, the combined metallothermic reduction and sintering step produced metallic tantalum agglomerates with a sphericity of 0.78, reflecting volume change during the oxide-to-metal transformation, and a density of 85.7% of theoretical, reflecting simultaneous sintering of the freshly reduced Ta metal at the 1100° C. hold temperature. The DC plasma spheroidization step restored sphericity to 0.96 and increased density to 99.1% of theoretical, demonstrating that the spheroidization step is required when metal oxide starting materials are used.

### Example 5: Production of Spherical Iron Powder from Iron Oxide

This example illustrates the production of spherical iron powder from iron oxide (Fe₂O₃) via the oxide reduction route using hydrogen reduction.

Slurry Preparation and Spray Drying. Iron(III) oxide powder (Fe₂O₃, D50=0.8 μm, purity≥99.5%, Alfa Aesar) was dispersed in a PVP/water binder solution (1.0 wt. % PVP) with 0.4 wt. % polyacrylic acid dispersant to a slurry solids content of 33 wt. %. The slurry was mixed, homogenized, and spray dried under conditions substantially similar to Example 2, except the inlet temperature was 190° C. and the ultrasonic nozzle settings were adjusted to target the stated agglomerate size. The spray dried agglomerates had a D50 of 35 m.

Debinding, Combined Reduction, and Microwave Sintering. Debinding was performed at 350° C. for 2 hours under argon in a dedicated atmosphere furnace. The debound powder was transferred to a microwave sintering furnace (2.45 GHz). The furnace atmosphere was set to a 50 vol. % H₂/50 vol. % Ar mixture (total flow 5 L/min) and the powder was heated at 5° C./min to 1050° C. with a 45-minute hold. The flowing H₂/Ar mixture served the dual function of reducing Fe₂O₃ to metallic Fe (Fe₂O₃→Fe₃O₄→FeO→Fe, occurring progressively between 400° C. and 700° C. on the heating ramp) and continuously sweeping the H₂O generated during reduction out of the furnace chamber. Once metallic Fe had formed, continued heating to 1050° C. effected solid-state sintering of the metallic Fe agglomerates. The low sintering temperature (relative to the melting point of iron at 1538° C.) was facilitated by the fine primary particle size. The reduced and sintered Fe powder was cooled under flowing Ar to room temperature. Oxygen analysis (LECO ONH836) confirmed an oxygen content of approximately 280 ppm after the combined reduction/sintering step.

DC Plasma Spheroidization. The reduced iron powder was processed through DC plasma at: arc current 380 A, voltage 32 V, argon plasma gas 60 SLPM, hydrogen secondary gas 4 SLPM, powder feed rate 6.0 kg/h.

Results. The final iron powder achieved 99.3% of theoretical density, sphericity of 0.97, Hall flow of 16.5 s/50 g, and D50 of 33 m. These properties compare favorably with commercially available gas-atomized iron powder (typical density 95-97% theoretical, Hall flow 25-30 s/50 g) at significantly reduced production cost due to the lower raw material cost of Fe₂O₃ compared to iron metal and the elimination of the gas atomization step.

### Example 6: Production of Spherical Mo-47.5Re Alloy Powder Using Activator-Assisted Sintering

This example illustrates the effect of an activator (sintering aid) on the sintering temperature and density of a Mo-47.5Re refractory alloy powder produced without DC plasma spheroidization.

Slurry Preparation. Primary molybdenum powder (D50=2.0 μm) and rhenium powder (D50=3.8 μm) were weighed at a ratio of 52.5:47.5 by weight. The slurry was divided into three batches: Batch A received no activator; Batch B received 0.2 wt. % Ni activator (D50=2.0 μm); and Batch C received 0.5 wt. % Ni activator. All batches used PVP binder (1.2 wt. %) in water at 30% solids. Preparation and spray drying were performed under conditions identical to those described in Example 1.

Debinding and Sintering. All three batches were debinded at 350° C. for 2 hours under argon in a dedicated atmosphere furnace. For each batch, sintering trials were performed at 1500° C., 1600° C., and 1700° C. for 60 minutes under argon. The 1500° C. and 1600° C. trials were performed in a microwave sintering furnace (2.45 GHz). The 1700° C. trials were performed in a conventional resistance-heated furnace, as this temperature exceeds the operating range of the microwave sintering furnace.

Results. The densification results are summarized in Table 5.

TABLE 5
Effect of Activator and Sintering Temperature
on Mo—47.5Re Density (% Theoretical)

| Batch | 1500° C. | 1600° C. | 1700° C. |
|---|---|---|---|
| A (No activator) | 72.3% | 78.5% | 83.1% |
| B (0.2% Ni) | 81.6% | 87.9% | 91.8% |
| C (0.5% Ni) | 88.4% | 93.2% | 95.5% |

As shown in Table 5, the addition of 0.5 wt. % Ni activator increased the achieved density at 1500° C. from 72.3% to 88.4%, and at 1700° C. from 83.1% to 95.5%. This demonstrates that the inclusion of an activator enables sintering of refractory alloys in relatively inexpensive resistance heater furnaces operating at or below 1700° C., eliminating the need for significantly more expensive high-temperature sintering equipment. Batch C sintered at 1700° C. achieved 95.5% of theoretical density, which is suitable for many applications and may be further improved to >99% by the optional DC plasma spheroidization step described in Examples 1-5.

### Example 7: Production of Spherical Ti-6A1-4V Alloy Powder from Elemental Powders

This example illustrates the formation of a multi-element alloy (Ti-6A1-4V) from individual elemental powders during the sintering step, demonstrating the versatility of the process for producing alloys from their constituent elements.

Slurry Preparation. Elemental titanium powder (D50=4.5 μm, purity≥99.5%, −325 mesh HDH grade), aluminum powder (D50=3.0 μm, purity≥99.7%), and vanadium powder (D50=5.0 μm, purity≥99.5%) were weighed at 90:6:4 by weight. The powders were combined with PVP binder (1.3 wt. %) in ethanol at 27% solids content. A stearic acid dispersant (0.3 wt. %) was added. The slurry was mixed in a planetary vacuum mixer and homogenized in a ball mill under argon-blanketed conditions for 40 minutes.

Spray Drying. The slurry was spray dried in a BUCHI B-290 under nitrogen with inlet temperature 170° C., outlet temperature 90° C., feed rate 8 mL/min, and the Ultrasonic Package operated at settings selected to produce the target agglomerate size distribution. The spray dried agglomerates had a D50 of 34 m.

Debinding and Sintering. Debinding was performed at 300° C. for 2.5 hours under high-purity argon in a dedicated atmosphere furnace. The debound powder was transferred to a microwave sintering furnace. Sintering was performed at 1350° C. for 90 minutes under argon, during which the elemental powders reacted to form the Ti-6Al-4V alloy via reactive sintering.

DC Plasma Spheroidization. The sintered Ti-6A1-4V powder was processed through DC plasma at: arc current 400 A, voltage 33 V, argon plasma gas 55 SLPM, helium secondary gas 10 SLPM (helium used instead of hydrogen to avoid hydrogen embrittlement of titanium), powder feed rate 4.5 kg/h.

Results. XRD analysis confirmed the formation of the α+βTi-6A1-4V phase structure after sintering. EDS mapping confirmed aluminum and vanadium were homogeneously distributed throughout the particles. The final powder achieved 99.4% of theoretical density, sphericity of 0.97, and Hall flow of 20.1 s/50 g. The oxygen content was 1,200 ppm and the nitrogen content was 180 ppm, both within the specification limits of ASTM F2924 for additive manufacturing of Ti-6Al-4V.

### Example 8: Comparative Cost Analysis Spray Drying/Sintering vs. RF Plasma Atomization

This example provides a comparative analysis of the production costs for spherical W-25Re powder produced by (i) the spray drying, microwave sintering, and DC plasma spheroidization process of Example 1, and (ii) conventional RF plasma atomization.

Results. The estimated production costs per kilogram of spherical W-25Re powder (20-63 μm, ≥99% theoretical density) are summarized in Table 6, assuming a production volume of 100 kg/month.

TABLE 6
Estimated Production Cost Comparison
for Spherical W-25Re Powder ($/kg)

| Cost Component | This Invention | RF Atomization |
|---|---|---|
| Raw Material | $850 | $1,200* |
| Energy | $120 | $680 |
| Capital Depreciation | $85 | $520 |
| Labor | $95 | $180 |
| Consumables/Gases | $75 | $150 |
| Total | $1,225 | $2,730 |

*RF atomization requires wire or rod feedstock which is more expensive than primary powder feedstock used in the methods described herein.

As shown in Table 6, the method of the present invention achieves an approximately 55% reduction in total production cost compared with conventional RF atomization for W-25Re powder. The cost advantage is attributable to lower energy consumption (microwave sintering plus DC plasma vs. sustained RF plasma), lower capital equipment cost (approximately $1.5M for the spray dryer, microwave furnace, and DC plasma system combined, compared with approximately $5-8M for an RF plasma atomization system), use of less expensive primary powder feedstock vs. wire or rod, and higher process yield (>85% compared with ≤30% for RF atomization).

### Example 9: Comparison of Microwave vs. Conventional Sintering for Spray-Dried Mo Powder

This example compares the sintering performance of spray-dried molybdenum powder processed by microwave sintering versus conventional resistance-heated sintering.

Spray dried Mo powder (D50=40 μm) was prepared from MoO₃ substantially as described in Example 2 through the debinding step. The debound powder was divided into two equal portions. Portion A was sintered in a microwave sintering furnace (2.45 GHz) at 1100° C. for 60 minutes under Ar/H₂. Portion B was sintered in a conventional resistance-heated tube furnace (Carbolite CTF) at 1100° C. for 60 minutes under the same atmosphere.

Results. The results are summarized in Table 7.

TABLE 7
Microwave vs. Conventional Sintering of Spray-Dried Mo Powder

| Property | Microwave (A) | Conventional (B) |
|---|---|---|
| % Theoretical Density | 85.3% | 79.6% |
| Grain Size (nm, SEM) | 420 | 680 |
| Total Cycle Time (h) | 3.2 | 8.5 |
| Energy Consumption (kWh/kg) | 4.8 | 38.5 |
| Sphericity | 0.85 | 0.83 |

As shown in Table 7, microwave sintering achieved higher density (85.3% vs. 79.6%), finer grain size (420 nm vs. 680 nm), shorter cycle time (3.2 vs. 8.5 hours), and approximately 87% reduction in energy consumption compared with conventional sintering at identical temperature and hold time. The finer grain size obtained by microwave sintering is advantageous for subsequent 3D printing applications where finer grain structures improve the mechanical properties of printed parts.

### Example 10: Production of Spherical Refractory High Entropy Alloy (MoNbTaW) Powder

This example illustrates the production of a refractory high entropy alloy (RHEA) powder of equimolar composition MoNbTaW from elemental powders.

Slurry Preparation. Elemental powders of Mo (D50=2.0 μm), Nb (D50=4.0 μm), Ta (D50=3.5 μm), and W (D50=1.2 μm) were weighed to achieve equimolar composition (Mo: 17.0 wt. %, Nb: 16.5 wt. %, Ta: 32.1 wt. %, W: 34.4 wt. %). Ni activator (0.4 wt. %) was added. The powders were combined with PVP binder (1.3 wt. %) in water at 29% solids. The slurry was mixed and homogenized as in Example 1.

Spray Drying, Debinding, and Sintering. Spray drying was performed under conditions similar to Example 1 (inlet 220° C., Ultrasonic Package settings selected to produce the target agglomerate size distribution, N₂ drying gas). The spray dried powder (D50=40 μm) was debound at 350° C. for 2 hours under argon in a dedicated atmosphere furnace, then transferred to a conventional resistance-heated furnace and sintered at 1650° C. for 90 minutes under argon. A conventional furnace was used because the sintering temperature exceeds the 1600° C. operating limit of the microwave sintering furnace. XRD analysis of the sintered powder confirmed formation of a single-phase BCC solid solution, consistent with the expected high entropy alloy structure.

DC Plasma Spheroidization. The sintered RHEA powder was processed through DC plasma at: arc current 520 A, voltage 40 V, argon plasma gas 48 SLPM, hydrogen secondary gas 8 SLPM, powder feed rate 2.5 kg/h. The higher power settings reflect the high melting point of this quaternary refractory alloy system.

Results. The final MoNbTaW powder achieved 98.8% of theoretical density, sphericity of 0.95, and Hall flow of 24.3 s/50 g. EDS mapping confirmed a homogeneous distribution of all four constituent elements within individual particles, with no elemental segregation observed. This demonstrates the capability of the spray drying and reactive sintering route to produce complex multi-element alloys from elemental feedstocks.

### Example 11: Production of Spherical 3d Transition High Entropy Alloy (CoCrFeMnNi) Powder

This example illustrates the production of a 3d transition high entropy alloy (THEA) powder of equimolar composition CoCrFeMnNi (Cantor alloy) from elemental powders. The Cantor alloy forms a single-phase FCC solid solution with exceptional fracture toughness at cryogenic temperatures.

Slurry Preparation. Elemental powders of Co (D50=3.5 μm, purity≥99.8%), Cr (D50=4.0 μm, purity≥99.0%), Fe (D50=3.0 μm, purity≥99.5%), Mn (D50=5.0 μm, purity≥99.5%), and Ni (D50=3.0 μm, purity≥99.9%) were weighed to achieve equimolar composition (Co: 21.0 wt. %, Cr: 18.5 wt. %, Fe: 19.9 wt. %, Mn: 19.6 wt. %, Ni: 20.9 wt. %). No activator was required due to the presence of Ni as a constituent element. The powders were combined with PVP binder (1.2 wt. %) in ethanol at 31% solids content with polyacrylic acid dispersant (0.4 wt. %). The slurry was mixed in a planetary vacuum mixer at 2000 rpm for 10 minutes and homogenized in a ball mill at 250 rpm for 35 minutes under argon-blanketed conditions using YSZ media.

Spray Drying. The slurry was spray dried on a BUCHI B-290 spray dryer fitted with the Ultrasonic Package, with inlet temperature 185° C., outlet temperature 100° C., feed rate 9 mL/min, the ultrasonic nozzle operated at settings selected to produce the target agglomerate size distribution, and nitrogen drying gas at 34 m3/h. The spray dried agglomerates had a D50 of 36 m with a particle size distribution of 18-68 am.

Debinding and Sintering. Debinding was performed at 320° C. for 2 hours (ramp 2.5° C./min) under argon in a dedicated atmosphere furnace. The debound powder was transferred to a microwave sintering furnace (2.45 GHz). Sintering was performed at 1200° C. for 75 minutes under argon (ramp 12° C./min). During sintering, the five elemental powders underwent interdiffusion and reactive alloying to form the HEA.

DC Plasma Spheroidization. The sintered CoCrFeMnNi powder was processed through DC plasma at: arc current 420 A, voltage 34 V, argon plasma gas 55 SLPM, hydrogen secondary gas 5 SLPM, powder feed rate 5.5 kg/h.

Results. The properties of the CoCrFeMnNi HEA powder are summarized in Table 8.

TABLE 8
Properties of Spherical CoCrFeMnNi
(Cantor Alloy) Powder (Example 11)

| Property | After Sintering | After DC Plasma |
|---|---|---|
| D50 (μm) | 34 | 33 |
| % Theoretical Density | 93.6% | 99.5% |
| Hall Flow (s/50 g) | 29.4 | 17.8 |
| Sphericity | 0.89 | 0.97 |
| Oxygen (ppm) | 410 | 130 |
| Crystal Structure (XRD) | Single-phase FCC | Single-phase FCC |

XRD analysis confirmed the formation of a single-phase FCC solid solution after sintering, consistent with the expected Cantor alloy structure. No secondary phases (sigma, BCC, or intermetallics) were detected. EDS point analyses across 30 randomly selected particle cross-sections confirmed compositional homogeneity with a coefficient of variation (CV) of ≤5% for each element. The absence of Mn evaporation loss was confirmed by ICP-OES analysis, which measured 19.4 wt. % Mn in the final powder (theoretical 19.6%), indicating that the rapid sintering cycle in the microwave furnace minimized Mn sublimation, which is a known challenge in processing Mn-containing HEAs.

### Example 12: Production of Spherical Lightweight High Entropy Alloy (AlTiVCrNb) Powder

This example illustrates the production of a lightweight high entropy alloy (LHEA) of equimolar composition AlTiVCrNb from elemental powders. LHEAs are of particular interest for aerospace applications where high specific strength (strength-to-density ratio) is desired.

Slurry Preparation. Elemental powders of Al (D50=4.0 μm, purity≥99.7%), Ti (D50=4.5 μm, −325 mesh HDH), V (D50=5.0 μm, purity≥99.5%), Cr (D50=4.0 μm, purity≥99.0%), and Nb (D50=4.0 μm, purity≥99.8%) were weighed to achieve equimolar composition (Al: 10.0 wt. %, Ti: 17.7 wt. %, V: 18.8 wt. %, Cr: 19.2 wt. %, Nb: 34.3 wt. %). Due to the pyrophoric nature of fine Al powder, slurry preparation was conducted under argon-blanketed conditions. PVB binder (1.3 wt. %) in ethanol was used at 28% solids content with 0.3 wt. % stearic acid dispersant. A Ni activator (0.3 wt. %) was added to facilitate sintering of the refractory constituents (V, Cr, Nb). The slurry was mixed in a planetary vacuum mixer and homogenized in a ball mill under argon for 30 minutes.

Spray Drying. The slurry was spray dried under nitrogen with inlet temperature 165° C., outlet temperature 85° C., feed rate 7 mL/min, and the Ultrasonic Package operated at settings selected to produce the target agglomerate size distribution. The spray dried agglomerates had a D50 of 33 m.

Debinding and Sintering. Debinding was performed at 280° C. for 3 hours under high-purity argon in a dedicated atmosphere furnace. The debound powder was transferred to a microwave sintering furnace (2.45 GHz) and sintered at 1400° C. for 90 minutes under argon.

DC Plasma Spheroidization. The sintered LHEA powder was processed through DC plasma at: arc current 440 A, voltage 35 V, argon plasma gas 52 SLPM, helium secondary gas 10 SLPM (helium used instead of hydrogen due to the presence of titanium and aluminum), powder feed rate 4.0 kg/h.

Results. XRD analysis confirmed the formation of a dual-phase BCC/B2 structure after sintering, consistent with the reported equilibrium phases for this LHEA system. The final powder achieved 98.9% of theoretical density, sphericity of 0.96, D50 of 32 μm, and Hall flow of 21.5 s/50 g. The measured density of the LHEA was 6.15 g/cm³, which is approximately 32% lower than the equimolar CoCrFeMnNi Cantor alloy (8.03 g/cm³) and approximately 24% lower than conventional Inconel® 718 (8.19 g/cm³), confirming the lightweight character of this composition. Al content measured by ICP-OES was 9.8 wt. % (theoretical 10.0%), indicating minimal Al evaporation during processing.

### Example 13: Production of Spherical Eutectic High Entropy Alloy (AlCoCrFeNi_{2.1}) Powder

This example illustrates the production of a eutectic high entropy alloy (EHEA) of composition AlCoCrFeNi_{2.1} from elemental powders. EHEAs exhibit a lamellar microstructure consisting of alternating FCC and BCC/B2 phases that provides an excellent combination of strength and ductility.

Slurry Preparation. Elemental powders of Al (D50=4.0 μm), Co (D50=3.5 μm), Cr (D50=4.0 μm), Fe (D50=3.0 μm), and Ni (D50=3.0 μm) were weighed to achieve the composition AlCoCrFeNi_{2.1} (Al: 7.0 wt. %, Co: 15.3 wt. %, Cr: 13.5 wt. %, Fe: 14.5 wt. %, Ni: 49.7 wt. %, adjusted for the non-equimolar Ni_{2.1} stoichiometry). Slurry preparation was performed under argon-blanketed conditions with PVP binder (1.2 wt. %) in ethanol at 30% solids. Processing was performed substantially as described in Example 11.

Sintering and Spheroidization. Debinding was at 310° C. for 2 hours under argon in a dedicated atmosphere furnace. The debound powder was transferred to a microwave sintering furnace and sintered at 1250° C. for 60 minutes under argon. DC plasma spheroidization at: arc current 410 A, voltage 33 V, argon plasma gas 55 SLPM, hydrogen secondary gas 5 SLPM, feed rate 5.0 kg/h.

Results. The final AlCoCrFeNi_{2.1} powder achieved 99.3% of theoretical density and sphericity of 0.97. SEM backscatter electron imaging of polished cross-sections revealed a fine lamellar eutectic microstructure consisting of alternating FCC (L1₂) and BCC (B2) phases with an average lamellar spacing of approximately 350 nm. XRD analysis confirmed the dual-phase FCC+BCC/B2 structure. The fine lamellar spacing achieved through the rapid solidification during DC plasma processing is finer than that typically obtained in arc-melted or cast EHEA ingots (1-5 μm lamellar spacing), which is expected to yield improved mechanical properties in printed parts.

### Example 14: Production of Oxide-Modified 316L Stainless Steel Powder with La₂O₃ Reinforcement (Route 2)

This example illustrates the production of an oxide-modified 316L stainless steel powder containing 0.75 wt. % lanthanum oxide (La₂O₃) for applications requiring improved creep resistance at elevated temperatures in corrosive environments.

Slurry Preparation. Pre-alloyed 316L stainless steel powder (D50=4.8 μm, composition per ASTM A240, Sandvik Osprey) and La₂O₃ nanoparticles (D50=200 nm, purity≥99.99%, American Elements) were used as starting materials. La₂O₃ was added at 0.75 wt. % based on total solids weight. A binder solution of PVP (1.1 wt. %) in deionized water was prepared. The 316L powder and La₂O₃ nanoparticles were combined with the binder solution and a non-ionic dispersant (Triton X-100, 0.4 wt. %) in a planetary vacuum mixer at 2000 rpm for 12 minutes. The slurry (solids content 33 wt. %) was homogenized in a planetary ball mill at 200 rpm for 50 minutes using YSZ media.

Spray Drying. The slurry was spray dried in a BUCHI B-290 spray dryer fitted with the Ultrasonic Package, with inlet temperature 195° C., outlet temperature 105° C., feed rate 8 mL/min, the ultrasonic nozzle operated at settings selected to produce the target agglomerate size distribution, and nitrogen drying gas at 33 m3/h. The resulting agglomerates had a D50 of 35 μm.

Debinding and Microwave Sintering. Debinding was performed at 340° C. for 2 hours (ramp 2.5° C./min) under argon in a dedicated atmosphere furnace. The debound powder was transferred to a microwave sintering furnace (2.45 GHz) and sintered at 1250° C. for 50 minutes under argon at a ramp rate of 12° C./min.

DC Plasma Spheroidization. The sintered oxide-modified 316L powder was processed through DC plasma at: arc current 400 A, voltage 32 V, argon plasma gas 55 SLPM, hydrogen secondary gas 4 SLPM, powder feed rate 5.5 kg/h.

Results. The properties of the oxide-modified 316L powder are summarized in Table 9.

TABLE 9
Properties of Oxide-Modified 316 L + 0.75%
La₂O₃ Powder (Example 14)

| Property | After Sintering | After DC Plasma |
|---|---|---|
| D50 (μm) | 34 | 33 |
| % Theoretical Density | 95.1% | 99.4% |
| Hall Flow (s/50 g) | 28.6 | 17.1 |
| Sphericity | 0.91 | 0.98 |
| Oxygen (ppm) | 520 | 190 |

SEM/EDS mapping of polished cross-sections confirmed uniform distribution of La₂O₃ particles (40-250 nm) at grain boundaries and solidification cell boundaries within the 316L matrix. The CV of lanthanum signal intensity across 50 particle cross-sections was 14%, compared with 41% for a reference sample prepared by conventional high-energy ball milling of m gas-atomized 316L with La₂O₃. This demonstrates that the spray drying technique provides substantially more uniform oxide distribution in iron-based oxide-modified alloys, consistent with the results obtained for Ni-based oxide-modified alloys in Example 3.

### Example 15: Production of Oxide-Modified Nb-1Zr Alloy Powder with Ce₂O₃ Reinforcement (Route 2)

This example illustrates the production of an oxide-modified Nb-1Zr refractory alloy powder containing 1.5 wt. % cerium oxide (Ce₂O₃) for high-temperature aerospace applications. Nb-1Zr is widely used in rocket nozzles and heat shields but suffers from creep at operating temperatures above 1100° C.; oxide reinforcement is expected to improve creep resistance.

Slurry Preparation. Elemental niobium powder (D50=3.5 μm, purity≥99.8%, H. C. Starck) and zirconium powder (D50=5.0 μm, purity≥99.5%) were weighed at 99:1 by weight. Ce₂O₃ nanoparticles (D50=300 nm, purity≥99.9%, American Elements) were added at 1.5 wt. % based on total solids weight. The powders were combined with PVP binder (1.3 wt. %) in ethanol at 28% solids with 0.3 wt. % stearic acid dispersant. Slurry preparation was performed under argon-blanketed conditions due to the oxygen sensitivity of Nb and Zr powders. The slurry was mixed in a planetary vacuum mixer and homogenized in a ball mill under argon for 40 minutes. A Ni activator (0.25 wt. %) was added to reduce sintering temperature of the refractory Nb matrix.

Spray Drying, Debinding, and Sintering. Spray drying was performed under nitrogen with inlet temperature 175° C., outlet 90° C., feed rate 7 mL/min, and the Ultrasonic Package operated at settings selected to produce the target agglomerate size distribution. The spray dried powder (D50=37 μm) was debound at 300° C. for 2.5 hours under high-purity argon in a dedicated atmosphere furnace. The debound powder was transferred to a microwave sintering furnace and sintered at 1600° C. for 75 minutes under argon. XRD confirmed the formation of the Nb-1Zr solid solution with no detectable NbO or ZrO₂ phases.

DC Plasma Spheroidization. The sintered oxide-modified Nb-1Zr powder was processed through DC plasma at: arc current 490 A, voltage 37 V, argon plasma gas 50 SLPM, helium secondary gas 10 SLPM (helium used to avoid hydrogen embrittlement of Nb), powder feed rate 3.0 kg/h.

Results. The properties are summarized in Table 10.

TABLE 10
Properties of Oxide-Modified Nb—1Zr +
1.5% Ce₂O₃ Powder (Example 15)

| Property | After Sintering | After DC Plasma |
|---|---|---|
| D50 (μm) | 36 | 35 |
| % Theoretical Density | 90.2% | 99.0% |
| Hall Flow (s/50 g) | 34.7 | 20.8 |
| Sphericity | 0.87 | 0.96 |
| Oxygen (ppm) | 780 | 250 |

SEM/EDS analysis confirmed uniform Ce₂O₃ particle distribution (80-400 nm) at grain boundaries and solidification cell boundaries within the Nb-1Zr matrix, with a CV of 16% across 40 particle cross-sections. This example demonstrates the applicability of the spray drying/microwave sintering process to produce oxide-modified variants of refractory alloys, extending the oxide dispersion strengthening approach beyond the conventional Ni-based and Fe-based oxide-modified systems.

### Example 16: Production of Oxide-Modified Ti-6A1-4V Powder with Y₂O₃—TiO₂ Reinforcement (Route 2)

This example illustrates the production of an oxide-modified Ti-6A1-4V powder containing 1.0 wt. % yttria (Y₂O₃) and 0.5 wt. % titania (TiO₂) as co-dispersoids. The Y—Ti—O system is known to form complex Y₂Ti₂O₇ pyrochlore-type nano-dispersoids during high-temperature processing, which are more effective at pinning dislocations and grain boundaries than Y₂O₃ alone, resulting in superior creep resistance.

Slurry Preparation. Pre-alloyed Ti-6A1-4V powder (D50=5.0 μm, Grade 5, −325 mesh, AP&C) was used as the matrix material. Y₂O₃ nanoparticles (D50=100 nm, purity≥99.99%) and TiO₂ nanoparticles (D50=80 nm, anatase phase, purity≥99.9%) were added at 1.0 wt. % and 0.5 wt. %, respectively, based on total solids weight. The powders were combined with PVP binder (1.2 wt. %) in ethanol at 27% solids with a non-ionic dispersant (0.4 wt. %). Slurry preparation was performed under argon-blanketed conditions. The slurry was mixed in a planetary vacuum mixer and homogenized in a ball mill under argon at 200 rpm for 60 minutes to ensure thorough dispersion of the nano-oxide particles.

Spray Drying. The slurry was spray dried under nitrogen with inlet temperature 170° C., outlet temperature 88° C., feed rate 7 mL/min, and the Ultrasonic Package operated at settings selected to produce the target agglomerate size distribution. The spray dried agglomerates had a D50 of 30 m.

Debinding and Microwave Sintering. Debinding was performed at 290° C. for 2.5 hours under high-purity argon in a dedicated atmosphere furnace. The debound powder was transferred to a microwave sintering furnace (2.45 GHz) and sintered at 1300° C. for 75 minutes under argon. The sintering temperature was selected to promote the in-situ formation of Y—Ti—O complex oxides.

DC Plasma Spheroidization. The sintered oxide-modified Ti-6A1-4V powder was processed through DC plasma at: arc current 400 A, voltage 33 V, argon plasma gas 55 SLPM, helium secondary gas 10 SLPM, powder feed rate 4.0 kg/h.

Results. The properties are summarized in Table 11.

TABLE 11
Properties of Oxide-Modified Ti-6Al-4V + 1.0%
Y₂O₃ + 0.5% TiO₂ Powder (Example 16)

| Property | After Sintering | After DC Plasma |
|---|---|---|
| D50 (um) | 29 | 28 |
| % Theoretical Density | 94.2% | 99.3% |
| Hall Flow (s/50 g) | 30.8 | 18.6 |
| Sphericity | 0.90 | 0.97 |
| Oxygen (ppm) | 1,850 | 1,350 |
| Nitrogen (ppm) | 210 | 170 |

TEM analysis of FIB-sectioned DC plasma-spheroidized oxide-modified Ti-6A1-4V particles indicates that Y—Ti—O and/or Y₂O₃-containing oxide features ranging from 5 nm to 50 nm are concentrated predominantly along solidification cell boundaries and grain boundaries, consistent with Route 2 grain-boundary pinning behavior, with a minor population of finer oxide features present within grains. Selected area electron diffraction (SAED) confirmed the presence of Y₂Ti₂O₇ pyrochlore-type phase alongside residual Y₂O₃. The average dispersoid spacing was approximately 80 nm, significantly finer than reported values of 200-500 nm for mechanically alloyed ODS Ti alloys. The higher oxygen content relative to non-oxide-modified Ti-6A1-4V (Example 7) is attributable to the intentionally added oxide dispersoids and is within acceptable limits for oxide-modified compositions. This example demonstrates that the spray drying process enables the formation of advanced Y—Ti—O complex oxide dispersoids with finer size and spacing than achievable by conventional mechanical alloying.

### Example 17: Comparative Analysis of Oxide Distribution Uniformity Spray Drying (Route 2) vs. Conventional Mechanical Alloying

This example provides a direct comparison of oxide dispersoid distribution uniformity between (i) the spray drying method of the present invention and (ii) conventional high-energy mechanical alloying (ball milling) for three oxide-modified alloy systems.

For each alloy system, two batches of powder were prepared: Batch S (spray drying method) was prepared substantially as described in the corresponding preceding Examples (Examples 3, 14, and 15, all processed via Route 2), and Batch M (mechanical alloying) was prepared by high-energy ball milling of pre-alloyed or elemental powders (D50=30-40 μm, gas-atomized) with the corresponding oxide nanoparticles in a Simoloyer CM01 horizontal attritor at 1200 rpm for 20 hours under argon. Both batches were subsequently processed through DC plasma spheroidization under identical conditions.

Results. Dispersoid distribution uniformity was quantified by the coefficient of variation (CV) of the rare earth element signal intensity measured by EDS across 50 randomly selected particle cross-sections for each sample. Lower CV indicates more uniform distribution. Additionally, the dispersoid size distribution was characterized by TEM. Results are summarized in Table 12.

TABLE 12
Oxide Distribution Uniformity - Spray Drying
Route 2 (S) vs. Mechanical Alloying (M)

| | | | Avg. | Avg. | Max | Max |
|---|---|---|---|---|---|---|
| | CV | CV | Size | Size | Size | Size |
| Alloy System | (S) | (M) | (S) | (M) | (S) | (M) |
| IN718 + Y₂O₃ | 12% | 38% | 85 nm | 320 nm | 300 nm | 1.8 μm |
| 316L + La₂O₃ | 14% | 41% | 75 nm | 280 nm | 250 nm | 2.1 μm |
| Nb1Zr + Ce₂O₃ | 16% | 45% | 110 nm | 450 nm | 400 nm | 3.2 μm |

As shown in Table 12, the spray drying method consistently produced more uniform dispersoid distributions (CV 12-16%) than conventional mechanical alloying (CV 38-45%) across all three alloy systems and across different oxide types. The spray drying method also produced significantly finer dispersoids (average 75-110 nm vs. 280-450 nm) with a much narrower size distribution (maximum 250-400 nm vs. 1.8-3.2 μm). The large maximum dispersoid sizes observed in the mechanically alloyed samples reflect incomplete break-up of oxide agglomerates during ball milling, a known limitation of the mechanical alloying approach. The finer and more uniformly distributed dispersoids obtained by the spray drying method are expected to provide superior strengthening efficiency per unit volume fraction of added oxide.

### Example 18: Production of Spherical W-25Re Powder by Direct DC Plasma Densification (Without Sintering Step)

This example illustrates the production of spherical W-25Re alloy powder in which the high temperature sintering step is replaced by DC plasma densification. As described herein, when metal or metal alloy powders (as opposed to metal oxides) are used as starting materials, the spray dried and debound powder may be subjected directly to DC plasma treatment in which the powder particles are simultaneously sintered, densified, and spheroidized in a single step.

Slurry Preparation and Spray Drying. A W-25Re slurry was prepared and spray dried substantially as described in Example 1, using primary tungsten powder (D50=1.2 μm) and rhenium powder (D50=3.5 μm) at 75:25 weight ratio with 0.35 wt. % Ni activator, PVP binder (1.2 wt. %) in water at 30% solids. The spray dried agglomerates had a D50 of 37 m.

Screening. The spray dried powder was screened to the 20-63 μm fraction as in Example 1.

Debinding. Debinding was performed in an atmosphere furnace by heating to 350° C. at 2° C./min and holding for 2 hours under flowing argon (2 L/min). The debinding was performed in a conventional atmosphere furnace rather than a microwave furnace because no subsequent sintering step was to be performed in the furnace.

DC Plasma Densification. The debound spray dried W-25Re powder was fed directly into the DC plasma system (Praxair SG-100 torch) without any intermediate sintering step. The plasma operating parameters were: arc current 550 A, voltage 40 V, argon plasma gas 48 SLPM, hydrogen secondary gas 10 SLPM, and powder feed rate 2.0 kg/h. The higher power settings and lower feed rate compared with Example 1 (where DC plasma was used only for spheroidization of pre-sintered powder) were employed because the spray dried agglomerates entering the plasma were in an unsintered, porous state and required more energy input to achieve full densification. A second pass through the DC plasma was performed at the same settings to ensure complete densification of all particles.

Results. The properties of the W-25Re powder produced by direct DC plasma densification are summarized in Table 13 and compared with the properties achieved by the sintering+DC plasma route of Example 1.

TABLE 13
W-25Re Powder - Direct DC Plasma Densification
(Ex. 18) vs. Sintering + DC Plasma (Ex. 1)

| | Ex. 18 (DC | Ex. 1 (Sinter + |
|---|---|---|
| Property | Plasma Only) | DC Plasma) |
| D50 (μm) | 34 | 35 |
| % Theoretical Density | 99.4% | 99.2% |
| Hall Flow (s/50 g) | 21.8 | 22.5 |
| Sphericity | 0.98 | 0.97 |
| Oxygen (ppm) | 75 | 85 |
| Carbon (ppm) | <20 | <20 |
| Process Steps | 3 (spray dry, debind, | 4 (spray dry, debind, |
| | DC plasma) | sinter, DC plasma) |

As shown in Table 13, the direct DC plasma densification route (Example 18) achieved comparable or slightly superior properties to the sintering+DC plasma route (Example 1), while eliminating the high temperature sintering step entirely. The density (99.4% vs. 99.2%), sphericity (0.98 vs. 0.97), and oxygen content (75 vs. 85 ppm) were all slightly improved in the direct DC plasma route. XRD and EDS analysis confirmed formation of the W-25Re solid solution alloy during the DC plasma treatment, demonstrating that the high temperature and rapid heating/cooling rates of the DC plasma are sufficient to achieve reactive alloying of the elemental powders simultaneously with densification and spheroidization.

The elimination of the sintering step reduces the total process time and eliminates the need for a high-temperature sintering furnace. However, the lower powder feed rate (2.0 kg/h vs. 3.5 kg/h in Example 1) and the requirement for a second pass through the plasma result in lower throughput per unit time compared with the sintering+DC plasma route. The selection between the two routes depends on the balance of capital equipment cost (furnace eliminated) vs. DC plasma operating cost (longer plasma processing time) for a specific production scenario.

### Example 19: Production of Spherical Inconel® 625 Powder by Direct DC Plasma Densification

This example illustrates the direct DC plasma densification route applied to a pre-alloyed nickel superalloy powder (Inconel® 625), demonstrating that the process is applicable to pre-alloyed starting materials in addition to elemental powder mixtures.

Slurry Preparation and Spray Drying. Pre-alloyed Inconel® 625 powder (D50=4.8 μm, composition per AMS 5666, Praxair Surface Technologies) was combined with PVP binder (1.1 wt. %) in deionized water at 32% solids with 0.3 wt. % non-ionic dispersant. The slurry was mixed in a planetary vacuum mixer, homogenized in a ball mill for 30 minutes, and spray dried on a BUCHI B-290 spray dryer fitted with the Ultrasonic Package (inlet 200° C., outlet 105° C., feed rate 8 mL/min, with the ultrasonic nozzle operated at settings selected to produce the target agglomerate size distribution, N₂ drying gas). The spray dried agglomerates had a D50 of 33 m.

Debinding. The spray dried powder was screened (20-53 μm) and debinded at 320° C. for 2 hours under argon in an atmosphere furnace.

DC Plasma Densification. The debound Inconel® 625 powder was fed directly into the DC plasma system without sintering. Plasma parameters: arc current 460 A, voltage 35 V, argon plasma gas 52 SLPM, hydrogen secondary gas 6 SLPM, powder feed rate 3.5 kg/h. A single pass was sufficient to achieve full densification due to the lower melting point of Inconel® 625 (−1350° C.) compared with W-25Re (~3050° C.).

Results. The properties are summarized in Table 14.

TABLE 14
Properties of Inconel ® 625 Powder - Direct
DC Plasma Densification (Example 19)

| Property | After Debinding | After DC Plasma |
|---|---|---|
| D50 (μm) | 33 | 31 |
| Apparent Density (g/cm³) | 3.2 (est.) | 8.38 |
| % Theoretical Density | ~38%* | 99.5% |
| Hall Flow (s/50 g) | No flow | 17.5 |
| Sphericity | 0.91 | 0.98 |
| Oxygen (ppm) | 850 | 95 |

*Density after debinding reflects the porous agglomerate structure prior to any sintering or densification. The debound agglomerates retained their spherical morphology from spray drying but had insufficient strength for reliable Hall flow measurement.

As shown in Table 14, the DC plasma densification step transformed the porous spray dried agglomerates (~38% dense) directly into fully dense (99.5%) spherical particles in a single step, achieving simultaneous sintering, densification, and spheroidization. Chemical analysis by ICP-OES confirmed that the alloy composition was maintained within the AMS 5666 specification after DC plasma processing, with no detectable loss of volatile elements. This demonstrates that pre-alloyed powders do not require any reactive alloying during the DC plasma step and can be processed efficiently in a single pass.

### Example 20: Comparative Analysis Three Process Routes for Mo-47.5Re Alloy Powder

This example provides a direct comparison of three process routes for producing spherical Mo-47.5Re alloy powder from elemental powders: (A) microwave sintering followed by DC plasma spheroidization, (B) direct DC plasma densification without sintering, and (C) microwave sintering only without DC plasma treatment.

Preparation. Three identical batches of Mo-47.5Re spray dried powder were prepared substantially as described in Example 6 (Batch C formulation with 0.5 wt. % Ni activator). Each batch was debinded at 350° C. for 2 hours under argon. The three batches were then processed as follows:

Route A (Sinter+DC Plasma). Microwave sintering at 1650° C. for 60 minutes under argon, followed by DC plasma spheroidization at: arc current 510 A, voltage 39 V, argon 50 SLPM, H₂ 8 SLPM, feed rate 3.0 kg/h.

Route B (DC Plasma Only). Direct DC plasma densification (no sintering) at: arc current 560 A, voltage 42 V, argon 46 SLPM, H₂ 10 SLPM, feed rate 1.8 kg/h. Two passes through the plasma were performed.

Route C (Sinter Only). Microwave sintering at 1700° C. for 90 minutes under argon. No DC plasma treatment.

Results. The properties are summarized in Table 15.

TABLE 15
Comparative Properties - Three Process Routes for Mo—47.5Re Powder

| | A: Sinter + DC | B: DC Plasma | C: Sinter |
|---|---|---|---|
| Property | Plasma | Only | Only |
| D50 (μm) | 37 | 35 | 39 |
| % Theoretical Density | 99.3% | 99.1% | 95.5% |
| Hall Flow (s/50 g) | 21.2 | 20.5 | 32.8 |
| Sphericity | 0.97 | 0.98 | 0.86 |
| Oxygen (ppm) | 90 | 70 | 380 |
| Grain Size (nm, SEM) | 650 | 480 | 850 |
| XRD Phase | Single-phase σ + | Single-phase σ + | Single-phase σ + |
| | solid soln. | solid soln. | solid soln. |
| Total Processing Steps | 4 | 3 | 3 |
| DC Plasma Throughput | 3.0 kg/h (1 pass) | 1.8 kg/h (2 passes) | N/A |

As shown in Table 15, Routes A and B both achieved near-theoretical density (≥99.1%) and high sphericity (≥0.97), while Route C (sintering only) achieved only 95.5% density and 0.86 sphericity. This confirms that the DC plasma step whether used as a post-sintering spheroidization treatment (Route A) or as a direct densification step replacing sintering (Route B) is critical for achieving the highest quality spherical powders.

Route B (DC plasma only) achieved slightly finer grain size (480 nm vs. 650 nm for Route A) due to the extremely rapid heating and cooling rates in the plasma, which inhibit grain growth. Route B also showed lower oxygen content (70 ppm vs. 90 ppm), attributed to the shorter total high-temperature exposure time. However, Route B required higher DC plasma power and two passes at lower feed rate, resulting in a plasma throughput of approximately 0.9 kg/h effective vs. 3.0 kg/h for Route A.

Route C (sintering only) produced powder suitable for applications where 95.5% density is acceptable, and represents the lowest-cost route by eliminating the DC plasma step entirely. However, for additive manufacturing applications requiring ≥99% density and high sphericity, Routes A or B are preferred. The choice between Route A and Route B depends on the specific production economics: Route A offers higher throughput and lower DC plasma operating cost but requires a high-temperature sintering furnace; Route B eliminates the sintering furnace but has higher DC plasma energy consumption per kilogram of product.

### Example 21: DC Plasma Densification of Spray-Dried Ti-6A1-4V Powder with Controlled Atmosphere

This example illustrates the direct DC plasma densification route applied to Ti-6A1-4V, an oxygen-sensitive alloy for which atmosphere control during the plasma treatment is critical. This example demonstrates the adaptations necessary when applying direct DC plasma densification to reactive metals.

Slurry Preparation and Spray Drying. Pre-alloyed Ti-6A1-4V powder (D50=5.0 μm, Grade 5, AP&C) was prepared and spray dried substantially as described in Example 7, yielding agglomerates with D50 of 35 m.

Debinding. Debinding was performed at 300° C. for 2.5 hours under ultra-high-purity argon (99.999%) in a sealed atmosphere furnace. The furnace was purged with three vacuum/argon backfill cycles prior to debinding to minimize residual oxygen.

DC Plasma Densification. The debound powder was processed through the DC plasma system under carefully controlled conditions to prevent oxygen pickup. The reactor chamber was purged with argon and maintained at an oxygen partial pressure below 10 ppm throughout processing. Plasma parameters: arc current 430 A, voltage 34 V, argon plasma gas 58 SLPM, helium secondary gas 12 SLPM (no hydrogen to avoid hydrogen embrittlement), powder feed rate 3.0 kg/h. The collection tank was water-cooled and maintained under argon. The powder was allowed to cool to below 100° C. under argon before exposure to ambient atmosphere.

Results. The properties are summarized in Table 16.

TABLE 16
Ti-6Al-4V - Direct DC Plasma Densification
(Ex. 21) vs. Sinter + DC Plasma (Ex. 7)

| | Ex. 21 (DC | Ex. 7 (Sinter + DC |
|---|---|---|
| Property | Plasma Only) | Plasma) |
| D50 (μm) | 33 | 33 |
| % Theoretical Density | 99.5% | 99.4% |
| Hall Flow (s/50 g) | 19.4 | 20.1 |
| Sphericity | 0.98 | 0.97 |
| Oxygen (ppm) | 980 | 1,200 |
| Nitrogen (ppm) | 140 | 180 |
| Hydrogen (ppm) | 18 | 22 |
| ASTM F2924 Compliant | Yes | Yes |

As shown in Table 16, the direct DC plasma densification route (Example 21) produced Ti-6A1-4V powder with lower oxygen content (980 ppm vs. 1,200 ppm) and lower nitrogen content (140 ppm vs. 180 ppm) compared with the sintering+DC plasma route (Example 7). The reduction in interstitial contamination is attributed to the shorter total high-temperature residence time in the direct DC plasma route, which reduces the opportunity for oxygen and nitrogen pickup. Both routes produced powder compliant with ASTM F2924 for additive manufacturing of Ti-6A1-4V. XRD confirmed the expected a+p phase structure, and EDS confirmed homogeneous distribution of Al and V.

This example demonstrates that the direct DC plasma densification route is particularly advantageous for oxygen-sensitive reactive metals such as titanium alloys, where minimizing high-temperature processing time directly reduces interstitial contamination. The use of helium as the secondary plasma gas (instead of hydrogen) prevented hydrogen embrittlement while maintaining adequate plasma enthalpy for full densification.

### Example 22: Production of True ODS Inconel® 718 Powder Without Plasma Spheroidization (Route 1)

This example illustrates the production of a true oxide dispersion strengthened (ODS) Inconel® 718 powder containing 0.35 wt. % yttria (Y₂O₃) via spray drying and solid-state microwave sintering without any plasma spheroidization step (Route 1). The powder is designed for solid-state additive manufacturing consolidation methods (binder jetting, material extrusion, cold spray, HIP) in which the powder is not melted during part fabrication, thereby preserving the intragranular nanoscale dispersoid architecture from powder through to consolidated part.

Mechanical Alloying (Route 1). Prior to slurry preparation, pre-alloyed Inconel® 718 powder (D50=5.2 μm, purity compliant with AMS 5662, Praxair Surface Technologies) and yttria nanoparticles (Y₂O₃, D50=30 nm, purity≥99.99%, American Elements) were mechanically alloyed in the dry state by high-energy planetary ball milling under argon (YSZ milling media, ball-to-powder ratio 10:1, 350 rpm, 8 hours), producing severe plastic deformation, cold welding and fracture events that embed Y—O species into the metal powder as described herein. The Y₂O₃ was added at 0.35 wt. % based on total solids weight—a loading typical of ODS alloys optimized for Orowan strengthening (compared with 1.0 wt. % in Example 3, which was intended for Route 2 plasma processing). The mechanically alloyed powder was then used as the metal powder input for slurry preparation.

Slurry Preparation. The mechanically alloyed Inconel® 718+0.35 wt. % Y₂O₃ powder was combined with a PVP binder solution (1.2 wt. % PVP in deionized water) and Triton X-100 dispersant (0.3 wt. %) in a planetary vacuum mixer at 2000 rpm for 12 minutes. The slurry (solids content 32 wt. %) was homogenized in a planetary ball mill at 200 rpm for 30 minutes using YSZ media.

Spray Drying. The slurry was spray dried in a BÜCHI B-290 spray dryer fitted with the Ultrasonic Package, with inlet temperature 200° C., outlet temperature 105° C., feed rate 7 mL/min, the ultrasonic nozzle operated at settings selected to produce the target agglomerate size distribution, and nitrogen drying gas at 32 m³/h. The resulting agglomerates had a D50 of 33 m.

Debinding and Microwave Sintering. Debinding was performed at 300° C. for 2 hours (ramp 2.5° C./min) under argon in a dedicated atmosphere furnace. The debound powder was transferred to a microwave sintering furnace (2.45 GHz) and sintered at 1180° C. for 45 minutes under argon at a ramp rate of 12° C./min. The sintering temperature was intentionally lower than in Example 3 (1240° C.) to minimize grain growth and ensure the Y₂O₃ dispersoids remained in their intragranular positions rather than migrating to grain boundaries. No DC plasma spheroidization step was applied.

Results. The properties of the Route 1 ODS Inconel® 718 powder are summarized in Table 17 and compared with the Route 2 oxide-modified powder of Example 3.

TABLE 17
Route 1 (No Plasma) vs. Route 2 (Plasma) Oxide-
Modified Inconel ® 718 Powder

| | Ex. 22 Route 1 (No | Ex. 3 Route |
|---|---|---|
| Property | Plasma) | 2 (Plasma) |
| D50 (μm) | 32 | 30 |
| % Theoretical Density | 93.1% | 99.6% |
| Hall Flow (s/50 g) | 34.8 | 18.2 |
| Sphericity | 0.89 | 0.98 |
| Oxygen (ppm) | 620 | 210 |
| Y₂O₃ Loading (wt. %) | 0.35 | 1.0 |
| Dispersoid Location (TEM) | Intragranular | Grain boundaries |
| Avg. Dispersoid Size (nm) | 15-35 | 50-300 |

TEM analysis of FB-sectioned particles confirmed that the Y₂O₃ dispersoids in the Route 1 powder remained in intragranular positions within the Inconel® 718 grains, with an average dispersoid size of 15-35 nm and average inter-particle spacing of approximately 60 nm. This is consistent with Orowan strengthening architecture. In contrast, the Route 2 powder of Example 3 (which underwent DC plasma spheroidization) showed Y₂O₃ redistributed to grain boundaries and solidification cell walls with coarser sizes of 50-300 nm, consistent with a Zener pinning/Hall-Petch strengthening mechanism.

The Route 1 powder exhibited lower density (93.1% vs. 99.6%), lower sphericity (0.89 vs. 0.98), and poorer Hall flow (34.8 vs. 18.2 s/50 g) compared with the Route 2 powder. These physical properties are acceptable for solid-state consolidation methods such as binder jetting and HIP, which do not require the high flowability and packing density needed for L-PBF. The critical advantage of Route 1 is the preservation of intragranular dispersoid architecture, which provides superior Orowan strengthening and high-temperature creep resistance in the final consolidated part, as demonstrated in Example 23.

### Example 23: Binder Jetting Consolidation of Route 1 ODS Inconel® 718 Powder—Dispersoid Preservation Verification

This example demonstrates that the intragranular dispersoid architecture of Route 1 ODS powder (Example 22) is preserved through binder jetting and HIP consolidation to a fully dense final part, validating the core rationale of the Route 1/Route 2 process-to-application matching strategy.

Binder Jetting. Route 1 ODS Inconel® 718 powder from Example 22 was loaded into an ExOne Innovent+ binder jetting system. The powder was spread in 50 μm layers using a counter-rotating roller. An aqueous polymeric binder (ExOne CleanFuse) was selectively deposited at 60% saturation. A total of 12 tensile bar specimens (ASTM E8 sub-size) and 6 creep specimens (ASTM E139) were printed. The green parts were cured at 180° C. for 6 hours.

Debinding and Sintering. The cured green parts were debinded at 350° C. for 3 hours under argon in a retort furnace. Sintering was performed at 1240° C. for 4 hours under argon in a vacuum furnace (10⁻⁴ torr base pressure, argon partial pressure backfill to 200 torr). The sintered parts achieved 96.2% theoretical density.

Hot Isostatic Pressing (HIP). The sintered parts were HIPed at 1165° C./150 MPa for 3 hours under argon in a Quintus QIH-15L press. Following HIP, parts achieved 99.7% theoretical density with no detectable open porosity.

Results. The microstructural and mechanical properties of the consolidated Route 1 ODS parts are summarized in Table 18 and compared with standard (non-ODS) binder jetted Inconel® 718 from literature values.

TABLE 18
Properties of Route 1 ODS Inconel ® 718 - Binder
Jetted + HIP vs. Standard Inconel ® 718

| | Route 1 ODS | Standard IN718 |
|---|---|---|
| Property | (BJ + HIP) | (BJ + HIP) |
| Final Density (% theo.) | 99.7% | 99.5% |
| UTS (MPa) | 1,085 | 1,020 |
| 0.2% YS (MPa) | 920 | 850 |
| Elongation (%) | 14.5 | 16.2 |
| Creep Life at 650° C./690 MPa | 385 | 142 |
| (h) | | |
| Dispersoid Location (TEM) | Intragranular | N/A |
| Avg. Dispersoid Size (nm) | 18-40 | N/A |

TEM analysis of the HIPed Route 1 ODS specimens confirmed that Y₂O₃ dispersoids remained in intragranular positions with sizes of 18-40 nm-essentially unchanged from the powder state (15-35 nm in Example 22). This confirms that the solid-state consolidation pathway (binder jetting+sintering+HIP) preserves the Orowan-type dispersoid architecture because the powder is never melted during any processing step from spray drying through final consolidation.

The Route 1 ODS parts exhibited a 170% increase in creep life at 650° C./690 MPa compared with non-ODS binder jetted Inconel® 718 (385 vs. 142 hours), attributable to the intragranular dispersoids acting as dislocation pinning sites (Orowan mechanism). The modest reduction in ductility (14.5% vs. 16.2% elongation) is typical for ODS alloys and is within acceptable limits for high-temperature structural applications. This example demonstrates the complete process chain from Route 1 ODS powder production (Example 22) through solid-state AM consolidation (this Example) with confirmed preservation of the dispersoid-strengthened microstructure.

### Example 24: Activator-Free Sintering of W-25Re for Aerospace-Grade Structural Applications

This example illustrates the production of aerospace-grade W-25Re powder without a metallic activator, demonstrating the activator-free route recommended for structural applications where grain-boundary embrittlement is unacceptable regarding activator segregation and grain-boundary effects).

Slurry Preparation. Primary tungsten powder (D50=1.2 μm) and rhenium powder (D50=3.5 μm) were weighed at 75:25 by weight. No activator was added. The slurry was prepared with PVP binder (1.2 wt. %) in deionized water at 30% solids and processed substantially as described in Example 1.

Spray Drying and Debinding. Spray drying and debinding were performed under conditions identical to Example 1. The spray dried agglomerates had a D50 of 37 m.

High-Temperature Sintering. Because no activator was used, the sintering temperature required to achieve meaningful densification was substantially higher than in Example 1. Sintering was performed in a high-temperature tungsten-element resistance furnace at 2200° C. for 2 hours under flowing hydrogen (5 L/min). This temperature exceeds the operating range of the microwave sintering furnace (≤1600° C.) and required conventional heating equipment.

DC Plasma Spheroidization. The sintered W-25Re powder was processed through DC plasma spheroidization under conditions identical to Example 1.

Results. The properties are summarized in Table 19 and compared with the activator-containing powder of Example 1.

TABLE 19
W-25Re Powder - Activator-Free (Ex. 24) vs. Ni-Activated (Ex. 1)

| | Ex. 24 | |
|---|---|---|
| Property | (No Activator) | Ex. 1 (0.35% Ni) |
| Sintering Temperature (° C.) | 2,200 | 1,550 |
| % Density After Sintering | 90.8% | 92.5% |
| % Density After DC Plasma | 99.3% | 99.2% |
| Hall Flow (s/50 g) | 22.0 | 22.5 |
| Sphericity | 0.97 | 0.97 |
| Ni Content (ppm, ICP-OES) | <5 | 3,400 |
| Grain Boundary Ni (STEM- | None detected | Segregation confirmed |
| EDS) | | |

The activator-free powder achieved equivalent final density and physical properties to the Ni-activated powder of Example 1 after DC plasma spheroidization. STEM-EDS analysis of grain boundaries in FIB-sectioned particles confirmed no nickel segregation in the activator-free powder, compared with confirmed Ni enrichment at grain boundaries in Example 1 powder. Mechanical testing of HIPed compacts showed that the activator-free material exhibited 23% higher fracture toughness (K_IC=18.2 vs. 14.8 MPa m\hat{ }(1/2)) and ductile-to-brittle transition temperature (DBTT) approximately 150° C. lower than the Ni-activated material, confirming that the activator-free route is preferred for aerospace structural applications such as rocket nozzle liners and high-temperature radiation shielding where grain-boundary integrity is critical.

The trade-off is that the activator-free route requires sintering equipment capable of sustained operation at ≥2200° C. under hydrogen, which is more costly than the microwave sintering furnace used for activator-assisted sintering. Accordingly, the activated route (Example 1) remains preferred for non-structural applications including binder jetting feedstock, radiation shielding, counterweights, and pre-forms intended for subsequent plasma densification, where grain-boundary embrittlement is tolerable.

### Example 25: Production of Spherical WC-12Co Cemented Carbide Powder (Metal-Matrix Composite)

This example illustrates the production of spherical tungsten carbide-cobalt (WC-12Co) powder, a metal-matrix composite (MMC), demonstrating that the spray drying platform produces both oxide-modified powders (Examples 3, 14, 15, 16) and ODS powders (Example 22) and MMC powders as distinct product classes with different compositions, reinforcement volume fractions, and strengthening mechanisms.

Slurry Preparation. Tungsten carbide powder (WC, D50=0.8 μm, purity≥99.5%, Global Tungsten & Powders) and cobalt powder (Co, D50=1.5 μm, purity≥99.8%) were weighed at 88:12 by weight. The WC constitutes approximately 73 vol. % of the composite—substantially higher than the 0.2-0.5 wt. % oxide dispersoid loadings in ODS alloys (Route 1), characteristic of an MMC load-transfer strengthening mechanism. A binder solution of PVP (1.5 wt. %) in deionized water with 0.5 wt. % polyacrylic acid dispersant was prepared at 35 wt. % solids. The slurry was mixed in a planetary vacuum mixer and homogenized in a ball mill at 250 rpm for 45 minutes using WC—Co milling media to avoid contamination.

Spray Drying. The slurry was spray dried on a BUCHI B-290 fitted with the Ultrasonic Package, at inlet temperature 210° C., outlet 105° C., feed rate 7 mL/min, with the ultrasonic nozzle operated at settings selected to produce the target agglomerate size distribution, under nitrogen. The spray dried agglomerates had a D50 of 28 μm with a narrow distribution (15-45 μm).

Debinding and Sintering. Debinding was performed at 350° C. for 2 hours under argon in a dedicated atmosphere furnace. The debound powder was transferred to a microwave sintering furnace and sintered at 1250° C. for 90 minutes under argon/hydrogen (90:10) atmosphere. The sintering temperature was maintained below the WC—Co eutectic onset (~1,280° C.) to ensure solid-state sintering. The resulting sintered powder had a density of approximately 82% of theoretical, with final densification achieved during the subsequent DC plasma spheroidization step.

DC Plasma Spheroidization. The sintered WC-12Co powder was processed through DC plasma at: arc current 450 A, voltage 36 V, argon plasma gas 52 SLPM, hydrogen secondary gas 6 SLPM, powder feed rate 3.5 kg/h.

Results. The properties are summarized in Table 20.

TABLE 20
Properties of Spherical WC-12Co Cemented
Carbide Powder (Example 25)

| Property | After Sintering | After DC Plasma |
|---|---|---|
| D50 (μm) | 27 | 26 |
| % Theoretical Density | 82% | 99.7% |
| Hall Flow (s/50 g) | 26.5 | 15.3 |
| Sphericity | 0.92 | 0.98 |
| Hardness (HV30, cross-section) | 1,280 | 1,350 |
| Carbon (wt. %, LECO) | 5.48 | 5.42 |
| WC Grain Size (nm, SEM) | 350 | 280 |

This example demonstrates that the spray drying platform produces MMC powders with reinforcement phase volume fractions (73 vol. % WC) that are fundamentally different from ODS powders (typically ≤1 vol. % oxide). The strengthening mechanism in the WC—Co composite is load transfer from the Co binder to the hard WC phase, not Orowan dislocation pinning as in ODS alloys. The fine WC grain size (280 nm after DC plasma) is a direct benefit of the fine starting powder (0.8 μm D50) and rapid cooling during plasma treatment, and is finer than typically achieved in conventional spray-dried and sintered WC—Co powders (500-800 nm).

### Example 26: Carbothermic Reduction of Nb₂O₅ with Subsequent Hydrogen Decarburization

This example illustrates the carbothermic reduction route applied to niobium pentoxide (Nb₂O₅), including the required decarburization step to reduce residual carbon to acceptable levels for aerospace applications.

Slurry Preparation and Spray Drying. Nb₂O₅ powder (D50=2.0 μm, purity≥99.9%, H. C. Starck) was combined with carbon black (D50=40 nm, Cabot Vulcan XC-72) at a C:Nb₂O₅ molar ratio of 5.2:1 (4% stoichiometric excess over theoretical 5:1). The mixture was dispersed in a PVP/water binder solution (1.2 wt. % PVP, 30% solids) and spray dried under nitrogen (inlet 200° C., outlet 100° C., with the Ultrasonic Package operated at settings selected to produce the target agglomerate size distribution). The spray dried agglomerates had a D50 of 40 μm.

Debinding and Sintering. Debinding at 380° C. for 2.5 hours under argon in a dedicated atmosphere furnace. The debound powder was transferred to a microwave sintering furnace and sintered at 1100° C. for 60 minutes under argon.

Carbothermic Reduction. The sintered Nb₂O₅/C agglomerates were heated to 1600° C. for 4 hours under flowing argon (3 L/min) in a graphite-element furnace. The reaction Nb₂O₅+5 C→2Nb+5CO proceeds above ~1400° C. After cooling, oxygen analysis confirmed reduction to 850 ppm oxygen. However, carbon analysis (LECO CS844) measured 2,800 ppm residual carbon, far exceeding the ≤100 ppm requirement for aerospace-grade niobium.

Hydrogen Decarburization. The carbothermically reduced Nb powder was subjected to vacuum annealing under flowing hydrogen (99.999% purity, 5 L/min) at 1200° C. for 6 hours in a molybdenum-element tube furnace. The hydrogen reacts with residual carbon via the reaction C+2H₂→CH₄, which is removed in the gas stream. After decarburization, carbon analysis confirmed 65 ppm residual carbon, within the ≤100 ppm specification. Oxygen increased slightly to 920 ppm due to trace moisture in the hydrogen supply.

DC Plasma Spheroidization. The decarburized Nb powder was processed through DC plasma at: arc current 470 A, voltage 36 V, argon plasma gas 52 SLPM, helium secondary gas 10 SLPM (helium used due to hydrogen embrittlement sensitivity of Nb), powder feed rate 3.0 kg/h.

Results. The properties are summarized in Table 21 and compared with the metallothermically reduced Ta powder of Example 4.

TABLE 21
Carbothermic Nb (Ex. 26) vs. Metallothermic
Ta (Ex. 4) - Oxide Reduction Route Comparison

| | Ex. 26 Nb | Ex. 4 Ta |
|---|---|---|
| Property | (Carbothermic) | (Ca Metallothermic) |
| Starting Oxide | Nb₂O₅ | Ta₂O₅ |
| Reduction/Sintering Temp. | 1,600 | 1,100 |
| (° C.) | | |
| Decarburization Required | Yes (1,200° C./H₂) | No |
| Total Reduction Steps | 2 | 1 + acid wash |
| Oxygen After Reduction | 920 | 620 |
| (ppm) | | |
| Carbon After Processing | 65 | <30 |
| (ppm) | | |
| % Density After DC | 98.9% | 99.1% |
| Plasma | | |
| Sphericity After DC | 0.95 | 0.96 |
| Plasma | | |

As shown in Table 21, the carbothermic reduction route requires higher temperatures and an additional decarburization step compared with metallothermic reduction. The final powder properties (98.9% density, 0.95 sphericity) are slightly lower than the metallothermic route, and the residual carbon (65 ppm) while within specification represents an ongoing quality control concern. Accordingly, metallothermic (Ca or Mg) reduction is preferred for Nb, Ta, Zr, and Hf where available, consistent with the specification guidance. The carbothermic route remains applicable where metallothermic reduction is impractical or where carbon tolerance is higher (e.g., NbC cermet feedstocks).

The following Examples 27-43 supplement Examples 1-26 and illustrate additional embodiments and process variants not addressed by the preceding examples.

### Example 27: Production of Oxide-Dispersed Ni-20Cr Powder Via Colloidal Hetero-Agglomeration (Route 3)

This example illustrates the production of oxide-dispersed Ni-20Cr powder containing fine Y₂O₃ inclusions distributed throughout the particle interior via colloidal hetero-agglomeration without mechanical alloying (Route 3).

Oxide Dispersion Preparation. Nanoscale Y₂O₃ powder (D50=50 nm, purity≥99.99%, specific surface area 30 m²/g, Nanostructured & Amorphous Materials, Inc.) was dispersed in deionized water at 5 wt. % solids with polyacrylic acid (PAA, MW 5,000, Sigma-Aldrich) as dispersant at 0.5 wt. % relative to oxide mass. The dispersion was ultrasonicated using a Hielscher UP200S probe sonicator (200 W, 24 kHz) for 15 minutes in an ice bath to break agglomerates, followed by centrifugation at 1,500 rpm for 5 minutes to sediment any remaining coarse agglomerates. The supernatant was recovered as the working dispersion. Dynamic light scattering (DLS, Malvern Zetasizer Nano ZS) measured a D50 in liquid of 78 nm with a polydispersity index of 0.18, confirming a stable, substantially agglomerate-free colloidal dispersion. The zeta potential of the Y₂O₃ nanoparticles was measured as ±42 mV at pH 4.5 (the isoelectric point of Y₂O₃ is approximately pH 8-9, so the particles are positively charged below this pH).

Hetero-Agglomeration. Gas-atomized Ni-20Cr powder (D50=5.0 μm, purity compliant with AMS 5544, Praxair Surface Technologies) was combined with the stabilized Y₂O₃ dispersion at a ratio providing 0.5 wt. % Y₂O₃ relative to metal weight. The pH of the combined suspension was adjusted to 4.5 using 0.1 M HCl. At this pH, the Ni-20Cr particle surfaces (isoelectric point approximately pH 3-4 for passive NiCr oxide film) carried a negative zeta potential of −24 mV, while the Y₂O₃ nanoparticles carried a positive zeta potential of ±42 mV. This opposite charge configuration promoted electrostatic hetero-coagulation, causing the Y₂O₃ nanoparticles to deposit preferentially onto the Ni-20Cr particle surfaces. PVP (MW 40,000, 0.5 wt. % relative to metal) was added as a polymer bridge binder to stabilize the oxide-metal attachment. The suspension was stirred at 500 rpm for 30 minutes using an overhead impeller.

SEM-EDS mapping (JEOL JSM-7600F) of the dried oxide-decorated powder confirmed a uniform coating of Y₂O₃ nanoparticles on the Ni-20Cr particle surfaces, with yttrium signal intensity detected across >95% of the metal particle surface area. No large Y₂O₃ agglomerates (≥500 nm) were observed, confirming the effectiveness of the deagglomeration and dispersant stabilization steps.

Slurry Preparation and Spray Drying. The oxide-decorated Ni-20Cr powder was used to prepare a spray drying slurry with additional PVP binder (total binder 1.2 wt. % based on binder solution weight) in deionized water at 28 wt. % total solids. The slurry was mixed in a planetary vacuum mixer (Thinky ARE-310) at 2000 rpm for 10 minutes and spray dried in a BUCHI Mini Spray Dryer B-290 equipped with the Ultrasonic Package (ultrasonic nozzle), at inlet temperature 210° C., outlet temperature 100° C., feed rate 7 mL/min, with the ultrasonic nozzle operated at settings selected to produce the target agglomerate size distribution, and nitrogen drying gas at 33 m³/h. The resulting spray-dried agglomerates had a D50 of 36 μm with a particle size distribution of 17-65 μm. During spray drying, the multi-particle granule assembly converted the surface-distributed Y₂O₃ into oxide distributed throughout the granule interior, as individual metal particles with their surface oxide coatings were packed together within each spherical agglomerate.

Debinding and Sintering. Debinding was performed at 300° C. for 2 hours (ramp 2.5° C./min) under flowing argon (2 L/min) in a dedicated atmosphere furnace. The debound powder was transferred to a microwave sintering furnace (2.45 GHz) and sintered at 1150° C. for 90 minutes under flowing argon. The sintering temperature was below the solidus of the Ni-20Cr system (~1395° C.) to maintain the solid-state condition. During sintering, the Y₂O₃ nanoparticles became physically captured as internal inclusions within the densified granule as the metal particles sintered together around the oxide. The sintered powder had a density of 93.8% of theoretical (8.11 g/cm³ vs. 8.65 g/cm³ theoretical for Ni-20Cr) as measured by helium pycnometry (Micromeritics AccuPyc 111340) and sphericity of 0.89 (Camsizer X3).

DC Plasma Spheroidization with Rapid Quenching. The sintered oxide-dispersed powder was subjected to DC plasma spheroidization using a Praxair SG-100 DC plasma torch at: arc current 430 A, voltage 34 V, argon plasma gas 55 SLPM, helium secondary gas 12 SLPM, powder feed rate 3.5 kg/h. The collection zone was equipped with a high-velocity helium gas quench manifold (99.999% He, flow rate 200 SLPM directed at the particle flight path exit) providing an estimated cooling rate of approximately 10⁴ K/s for 36 μm droplets, as estimated from the Ranz-Marshall heat transfer correlation for forced convection cooling of spherical droplets.

During the brief melt residence time (~5 ms at 36 μm particle size), the Y₂O₃ inclusions were retained within the molten Ni-20Cr droplets. Upon rapid solidification, the advancing solid-liquid interface engulfed the nanoparticles rather than pushing them to grain boundaries, consistent with established pushing/engulfment theory which predicts a critical engulfment velocity that decreases with decreasing particle radius. For the 50-200 nm Y₂O₃ inclusions in this example, the solidification front velocity (~10⁻² m/s, estimated from the cooling rate and thermal gradient) exceeded the predicted critical velocity for engulfment.

Results. The properties of the oxide-dispersed Ni-20Cr powder are summarized in Table 22.

TABLE 22
Properties of Oxide-Dispersed Ni-20Cr +
0.5% Y₂O₃ Powder via Route 3 (Example 27)

| | | After DC Plasma + |
|---|---|---|
| Property | After Sintering | Quench |
| D50 (μm) | 35 | 34 |
| % Theoretical Density | 93.8% | 99.5% |
| Hall Flow (s/50 g) | 32.5 | 19.8 |
| Sphericity (Camsizer X3) | 0.89 | 0.97 |
| Oxygen (ppm) | 1,420 | 980 |
| Carbon (ppm) | <30 | <20 |

SEM and TEM analysis of FIB-sectioned (FEI Helios NanoLab 600) DC plasma-spheroidized particles confirmed Y₂O₃ inclusions (mean size ~65 nm, range 20-250 nm) distributed throughout the particle interior, with inclusions present both within grains and at grain boundaries. This distribution was quantified by measuring yttrium signal intensity across five diametral line scans per particle on 30 randomly selected particle cross-sections; the yttrium signal was detected at >80% of measurement points across each particle diameter, confirming interior distribution rather than surface or grain-boundary-only localization. Energy-dispersive X-ray spectroscopy (EDS) at individual inclusion sites confirmed Y and O without detectable Ni or Cr, confirming discrete Y₂O₃ phase retention through the melt-resolidification cycle.

The oxide distribution in Route 3 was distinct from Route 1 (Example 22, intragranular nanoscale dispersoids of 15-35 nm formed by mechanical alloying and precipitation) and from Route 2 (Example 3, oxide particles of 50-300 nm redistributed to grain boundaries during plasma treatment). In Route 3, the oxide existed as discrete fine inclusions (20-250 nm) engulfed throughout the particle interior by the rapid solidification front, providing dispersion strengthening by a combination of Orowan pinning (for inclusions below ~100 nm) and load transfer to the oxide phase (for larger inclusions). The elevated oxygen content (980 ppm) relative to the non-oxide-containing base alloy reflects the intentional 0.5 wt. % Y₂O₃ addition.

### Example 28: Oxide-Dispersed Inconel® 625 Powder Via In-Situ Precursor Method (Route 3 Variant)

This example illustrates the in-situ precursor variant of Route 3 described above, in which a soluble metal-organic precursor is deposited onto metal powder surfaces from solution and converted to the oxide phase during debinding or sintering, rather than by direct addition of pre-formed oxide nanoparticles. This example provides support for the corresponding embodiment (oxide-dispersed powder without mechanical alloying).

Precursor Deposition. Pre-alloyed Inconel® 625 powder (D50=4.8 μm, composition per AMS 5666, Praxair Surface Technologies) was suspended in anhydrous ethanol at 20 wt. % solids with gentle stirring. Yttrium(III) acetate tetrahydrate (Y(CH₃COO)₃ 4H₂O, 99.9%, Alfa Aesar) was dissolved in the ethanol at a concentration calculated to provide 0.35 wt. % Y₂O₃ equivalent upon thermal conversion. The solution was stirred at 300 rpm for 60 minutes to allow adsorption of the yttrium acetate onto the Inconel® 625 particle surfaces. The ethanol was then evaporated under vacuum at 60° C. in a rotary evaporator, depositing a thin film of yttrium acetate onto the metal powder surfaces. FTIR analysis (Thermo Scientific Nicolet iS50) of the precursor-coated powder confirmed the presence of yttrium acetate (characteristic carboxylate stretching bands at 1,540 and 1,460 cm¹) on the powder surfaces.

Slurry Preparation and Spray Drying. The precursor-coated Inconel® 625 powder was used to prepare a slurry with PVP binder (1.2 wt. %) in deionized water at 30 wt. % solids. The slurry was mixed in a planetary vacuum mixer and spray dried in a BUCHI B-290 with the Ultrasonic Package, at inlet 200° C., outlet 105° C., feed rate 8 mL/min, with the ultrasonic nozzle operated at settings selected to produce the target agglomerate size distribution, and N₂ drying gas. The spray dried agglomerates had a D50 of 34 μm.

Debinding, Precursor Conversion, and Sintering. Debinding was performed at 350° C. for 2 hours under flowing argon in a dedicated atmosphere furnace. During the debinding step, the yttrium acetate precursor decomposed and was converted to nanocrystalline Y₂O₃ in situ on the metal particle surfaces. Thermogravimetric analysis with mass spectrometry (TGA-MS, TA Instruments SDT Q600 coupled with Pfeiffer ThermoStar MS) of the precursor-coated powder under argon confirmed that yttrium acetate decomposition was complete by 340° C., with CO₂ and H₂O as the primary gaseous products. XRD of the debound powder confirmed the appearance of nanocrystalline Y₂O₃ peaks (broad, consistent with ~5-10 nm crystallite size by Scherrer analysis). Sintering was performed at 1200° C. for 60 minutes under argon in a microwave sintering furnace (2.45 GHz).

DC Plasma Spheroidization with Rapid Quenching. The sintered powder was processed through DC plasma (Praxair SG-100 torch) at: arc current 440 A, voltage 35 V, argon plasma gas 52 SLPM, helium secondary gas 12 SLPM, powder feed rate 4.0 kg/h, with helium gas quench in the collection zone.

Results. The properties are summarized in Table 23.

TABLE 23
Properties of Oxide-Dispersed Inconel ® 625 Powder
via In-Situ Precursor Route 3 (Example 28)

| | | After DC Plasma + |
|---|---|---|
| Property | After Sintering | Quench |
| D50 (μm) | 33 | 32 |
| % Theoretical Density | 94.5% | 99.6% |
| Hall Flow (s/50 g) | 30.2 | 18.0 |
| Sphericity (Camsizer X3) | 0.90 | 0.98 |
| Oxygen (ppm) | 1,280 | 820 |
| Y content (ppm, ICP-OES) | 2,750 | 2,680 |

TEM analysis of FIB-sectioned plasma-spheroidized particles revealed Y₂O₃ inclusions with a mean size of approximately 25 nm (range 5-120 nm) distributed throughout the particle interior. The mean inclusion size was substantially finer than that obtained by direct nanoparticle addition in Example 27 (65 nm mean), confirming the advantage of the in-situ precursor route described above for producing finer and more uniformly distributed oxide particles. The finer inclusion size was attributed to the molecular-level deposition of the yttrium precursor, which produced a higher density of nucleation sites and smaller initial oxide crystallites upon thermal conversion. The yttrium content measured by ICP-OES (2,680 ppm in final powder) was consistent with the target loading, confirming negligible loss of the oxide phase during processing.

### Example 29: Oxide-Dispersed Hastelloy X Powder with Core-Shell Granule Architecture (Route 3 Variant)

This example illustrates the core-shell granule variant of Route 3 described above, in which spray drying parameters are controlled to produce granules having an outer shell enriched in metal and an inner region enriched in the oxide phase. This example supports the core-shell granule embodiment disclosed in the specification within the scope of the corresponding embodiment.

Hetero-Agglomeration. Gas-atomized Hastelloy X powder (D50=5.5 μm, composition per AMS 5754, Praxair Surface Technologies) was coated with Y₂O₃ nanoparticles (D50=40 nm, 0.75 wt. %) via the hetero-agglomeration procedure described in Example 27, with pH adjusted to 4.5 to promote electrostatic attachment.

Spray Drying with Core-Shell Control. The oxide-decorated powder was prepared as a slurry with PVP binder (1.2 wt. %) in deionized water at 25 wt. % solids-intentionally lower than the 28-32 wt. % used in preceding examples. The reduced solids content, combined with an elevated but equipment-compatible inlet temperature of 220° C. (outlet 110° C.) and ultrasonic nozzle settings chosen to favor rapid solvent removal, promoted preferential migration of the finer Y₂O₃ nanoparticles toward the droplet interior during drying. This phenomenon is a consequence of the capillary-driven Peclet number sorting effect: during evaporative drying of a polydisperse slurry droplet, larger particles (5 μm metal) accumulate at the receding droplet surface faster than smaller particles (50 nm oxide), which are transported inward by capillary flow. The resulting spray dried agglomerates (D50=33 μm) exhibited a core-shell architecture with an oxide-enriched interior and a metal-enriched outer shell, as confirmed by FIB cross-sectioning and EDS line scanning.

EDS line scans across 20 FIB-sectioned agglomerates showed yttrium signal intensity approximately 2.5× higher in the inner 60% of the particle diameter compared with the outer 40%, consistent with the predicted Peclet number sorting. The metal-enriched outer shell is advantageous for two reasons: (i) it provides improved flowability because the metallic surface has a lower friction coefficient than an oxide-rich surface, and (ii) during DC plasma spheroidization, the metal shell melts first and rapidly, encapsulating the oxide-rich core and preventing oxide ejection during the brief melt residence time.

Debinding, Sintering, and DC Plasma Spheroidization. Debinding was performed at 310° C. for 2 hours under argon in a dedicated atmosphere furnace. The debound powder was transferred to a microwave sintering furnace and sintered at 1200° C. for 60 minutes under argon. DC plasma spheroidization was performed at: arc current 430 A, voltage 34 V, argon plasma gas 55 SLPM, helium secondary gas 12 SLPM, powder feed rate 3.5 kg/h, with helium gas quench providing approximately 10⁴ K/s cooling rate.

Results. The properties are summarized in Table 24.

TABLE 24
Properties of Oxide-Dispersed Hastelloy X Powder
with Core-Shell Architecture (Example 29)

| | | After DC Plasma + |
|---|---|---|
| Property | After Sintering | Quench |
| D50 (μm) | 32 | 31 |
| % Theoretical Density | 93.2% | 99.4% |
| Hall Flow (s/50 g) | 28.4 | 17.6 |
| Sphericity (Camsizer X3) | 0.90 | 0.97 |
| Oxygen (ppm) | 1,680 | 1,050 |
| Y/O Core-Shell Ratio (inner/outer) | 2.5× | 1.4× |

After DC plasma spheroidization, FIB cross-sectioning and EDS analysis confirmed that the core-shell Y₂O₃ enrichment gradient was partially preserved (inner/outer yttrium ratio reduced from 2.5× to 1.4×), indicating that the brief melt residence time resulted in partial homogenization of the oxide distribution while retaining a measurable concentration gradient. The overall inclusion size (mean 55 nm, range 15-220 nm) and interior distribution were consistent with the results of Example 27. The metal-enriched shell provided a measurable improvement in powder flowability; the Hall flow rate of the core-shell powder (17.6 s/50 g) was lower than that of the uniformly distributed Route 3 powder of comparable composition in Example 27 (19.8 s/50 g, after accounting for differences in base alloy density and particle size).

### Example 30: Production of Spherical Tungsten Powder from Tungsten Trioxide via Oxide Route

This example illustrates the production of spherical tungsten powder from tungsten trioxide (WO₃) starting material via the oxide reduction route, complementing the molybdenum oxide route of Example 2, the tantalum oxide route of Example 4, the iron oxide route of Example 5, and the niobium oxide route of Example 26, and demonstrating applicability of the process to the highest-melting-point refractory metal system.

Slurry Preparation. Tungsten trioxide powder (WO₃, D50=1.8 μm, purity≥99.95%, Global Tungsten & Powders Corp.) was used as the starting material. A binder solution was prepared by dissolving PVP (K-30, MW ~40,000) in deionized water at 1.2 wt. %. A Ni activator (0.35 wt. % based on total solids) was added to enable activated sintering of the resulting tungsten metal. The WO₃ powder and activator were combined with the binder solution in a planetary vacuum mixer (Thinky ARE-310) at 2000 rpm for 10 minutes. The slurry had a solids content of 30 wt. %. The slurry was homogenized in a planetary ball mill at 250 rpm for 30 minutes using YSZ media.

Spray Drying. The slurry was spray dried in a BUCHI B-290 fitted with the Ultrasonic Package, at inlet temperature 220° C., outlet temperature 110° C., feed rate 8 mL/min, with the ultrasonic nozzle operated at settings selected to produce the target agglomerate size distribution, and nitrogen drying gas at 35 m³/h. The spray dried agglomerates had a D50 of 45 μm with a particle size distribution of 20-80 μm.

Screening. The spray dried powder was classified on an ultrasonic laboratory sieve shaker with 20 μm and 75 μm electroformed screens. The screened fraction (20-75 μm) represented approximately 70% of the total spray dried output.

Debinding and Microwave Sintering. Debinding was performed at 380° C. for 2 hours (ramp 2° C./min) under flowing forming gas (5% H₂/95% N₂, 2.5 L/min) in a dedicated atmosphere furnace. The debound powder was transferred to a microwave sintering furnace (2.45 GHz) and sintered at 1200° C. for 90 minutes under flowing argon at a ramp rate of 12° C./min. Sintering was performed under inert atmosphere (sequential pathway A) so that the WO₃ agglomerates were consolidated as the oxide phase prior to reduction. The sintering temperature of 1200° C. was much lower than the approximately 2400-2700° C. that would be required for sintering metallic tungsten without an activator, demonstrating the advantage of sintering in the oxide form.

Hydrogen Reduction. The sintered WO₃ agglomerates were reduced in a tube furnace under flowing pure hydrogen (99.999%, 5 L/min). The reduction was performed in two stages: first at 600° C. for 2 hours (to reduce WO₃ to WO₂), followed by 950° C. for 4 hours (to reduce WO₂ through W₂₅O₄₉ intermediates to metallic W). The reduced powder was cooled to room temperature under hydrogen. Oxygen analysis (LECO ONH836) confirmed 520 ppm residual oxygen after reduction. The volume contraction accompanying WO₃→W reduction is approximately 70% (molar volume: WO₃=32.3 cm³/mol; W=9.55 cm³/mol), which caused substantial cracking and loss of sphericity.

DC Plasma Spheroidization. The reduced tungsten powder was processed through DC plasma (Praxair SG-100 torch) at: arc current 530 A, voltage 40 V, argon plasma gas 48 SLPM, hydrogen secondary gas 10 SLPM, powder feed rate 2.5 kg/h. The higher power settings compared with Examples 1-5 reflect the very high melting point of tungsten (3,422° C.).

Results. The properties of the spherical tungsten powder are summarized in Table 25.

TABLE 25
Properties of Spherical Tungsten Powder from WO₃ (Example 30)

| | After | After | After |
|---|---|---|---|
| Property | Sintering | Reduction/Sintering | DC Plasma |
| D50 (μm) | 43 | 35 | 34 |
| % Theoretical Density | 82.6% | 84.8% | 99.3% |
| Hall Flow (s/50 g) | No flow | No flow | 23.2 |
| Sphericity | 0.87 | 0.75 | 0.96 |
| Oxygen (ppm) | 21,500 (as | 520 | 95 |
| | WO₃) | | |
| Carbon (ppm) | <30 | <30 | <20 |

As shown in Table 25, the hydrogen reduction step caused a dramatic decrease in sphericity from 0.87 to 0.75 due to the 70% volume contraction accompanying the WO₃→W transformation. This volume contraction is substantially larger than that observed in the MoO₃→Mo reduction (Example 2, ~55%), the Ta₂O₅→Ta reduction (Example 4, ~68%), and the Fe₂O₃→Fe reduction (Example 5, ~45%), reflecting the particularly large oxygen-to-metal molar volume ratio in the tungsten oxide system. The DC plasma spheroidization step restored sphericity to 0.96 and increased density to 99.3% of theoretical, confirming the importance of the DC plasma step as a required process step for the oxide route as described above. The D50 decreased from 45 μm (spray dried) to 34 μm (final) due to the large volume contraction during reduction and densification during plasma processing.

### Example 31: Production of True ODS NiCoCr+Y₂O₃ Powder Via Acoustic Milling (Route 1)

This example illustrates the production of a true oxide dispersion strengthened (ODS) NiCoCr powder containing 0.35 wt. % Y₂O₃ via acoustic milling mechanical alloying, spray drying, and solid-state sintering (Route 1). The alloy composition (Ni-30Co-3OCr by weight, approximately equimolar NiCoCr) is analogous to NASA's GRX-810 alloy, in which nano-Y₂O₃ was distributed onto NiCoCr powder surfaces via high-intensity acoustic mixing (coating/attachment) prior to L-PBF consolidation.

Mechanical Alloying by Acoustic Milling. Pre-alloyed NiCoCr powder (Ni-30Co-30Cr by weight, gas-atomized, D50=5.8 μm, Praxair Surface Technologies, composition verified by ICP-OES) was mechanically alloyed with nanoscale Y₂O₃ powder (D50=30 nm, purity≥99.99%, specific surface area 35 m²/g, Nanostructured & Amorphous Materials, Inc.) at a loading of 0.35 wt. % Y₂O₃. Mechanical alloying was performed in a Resodyn LabRAM II acoustic mixer at 60 g acceleration for 4 hours under an argon atmosphere maintained by continuous argon purge of the mixing vessel. No milling media were required as the acoustic mixer utilizes the macro-kinetic energy of the powder charge itself for mechanical alloying. The Resodyn acoustic mixer provides intense mechanical energy transfer via resonant acoustic mixing at frequencies of 50-70 Hz, generating repeated impact, shearing, and cold-welding events between powder particles.

After acoustic milling, XRD analysis (Bruker D8 Advance, Cu Kα radiation) showed significant broadening of the Ni-alloy FCC diffraction peaks, with the (111) peak full-width at half-maximum (FWHM) increasing from 0.180 to 0.52°, corresponding to a crystallite size of approximately 18 nm by Scherrer analysis. No discrete Y₂O₃ peaks were detectable above the XRD detection limit (approximately 1-2 vol. % for nanocrystalline phases), indicating successful dissolution and/or comminution of the oxide below XRD detection limits, consistent with the formation of supersaturated Y—O solute species and sub-nanometer clusters within the metal lattice as described above. SEM-EDS mapping confirmed that yttrium was uniformly distributed throughout the mechanically alloyed powder particles with no detectable Y-rich agglomerates at the SEM resolution (~100 nm).

Slurry Preparation and Spray Drying. The mechanically alloyed powder was used to prepare a slurry with PVP binder (1.2 wt. %) in deionized water at 28 wt. % solids. The slurry was mixed in a planetary vacuum mixer (Thinky ARE-310) at 2000 rpm for 10 minutes and spray dried in a BUCHI B-290 with the Ultrasonic Package (inlet 200° C., outlet 105° C., feed rate 7 mL/min, with the ultrasonic nozzle operated at settings selected to produce the target agglomerate size distribution, N₂ drying gas at 32 m³/h). The spray dried agglomerates had a D50 of 34 μm with a particle size distribution of 16-60 μm.

Debinding and Solid-State Sintering. Debinding was performed at 300° C. for 2 hours (ramp 2.5° C./min) under argon in a dedicated atmosphere furnace. The debound powder was transferred to a microwave sintering furnace (2.45 GHz) and sintered at 1100° C. for 120 minutes under flowing argon at a ramp rate of 12° C./min. The sintering temperature was intentionally selected to be well below the solidus of the NiCoCr system (−1350° C.) to prevent melting that would disrupt the intragranular dispersoid distribution established by acoustic milling. During sintering, the non-equilibrium Y—O species (supersaturated solute, sub-nanometer amorphous clusters) nucleated and coalesced into nanoscale dispersoids at intragranular sites—dislocations, stacking faults, and nanocrystalline grain boundaries created during milling—producing an ODS microstructure with intragranular dispersoids providing Orowan dislocation pinning. No DC plasma spheroidization step was applied.

Results. The properties of the Route 1 ODS NiCoCr powder are summarized in Table 26 and compared with the Route 1 ODS Inconel® 718 powder of Example 22 (which used ball mill homogenization rather than acoustic milling for the mechanical alloying step).

TABLE 26
Route 1 ODS NiCoCr via Acoustic Milling (Ex. 31)
vs. Route 1 ODS IN718 via Ball Mill (Ex. 22)

| | Ex. 31 NiCoCr | Ex. 22 IN718 |
|---|---|---|
| Property | (Acoustic) | (Ball Mill) |
| Mechanical Alloying Method | Resodyn LabRAM II, 4 h | Planetary ball |
| | | mill, 8 h |
| Y₂O₃ Loading (wt. %) | 0.35 | 0.35 |
| D50 (μm) | 33 | 32 |
| % Theoretical Density | 92.4% | 93.1% |
| Hall Flow (s/50 g) | 36.2 | 34.8 |
| Sphericity | 0.88 | 0.89 |
| Carney Flow (s/50 g) | 44.5 | 42.8 |
| Oxygen (ppm) | 680 | 620 |
| Dispersoid Location (TEM) | Intragranular | Intragranular |
| Avg. Dispersoid Size (nm, | 12-30 | 15-35 |
| TEM) | | |
| Avg. Dispersoid Spacing (nm) | 55 | 60 |

TEM analysis (JEOL JEM-2100F) of FIB-sectioned sintered powder particles confirmed nanoscale Y—O-rich dispersoids with a mean diameter of 18 nm (range 12-30 nm) distributed predominantly at intragranular sites, including dislocations and nanocrystalline grain boundaries within individual powder particles. Selected area electron diffraction (SAED) of individual dispersoids was consistent with a Y—O-rich phase but the small size precluded definitive phase identification; some dispersoids showed diffuse diffraction consistent with an amorphous or nanocrystalline Y-O structure. The dispersoid size and spacing were slightly finer than those obtained by ball mill mechanical alloying in Example 22 (12-30 nm vs. 15-35 nm mean diameter; 55 nm vs. 60 nm spacing), which may be attributed to the more intensive and uniform energy input of acoustic mixing compared with ball milling for the specific processing parameters used.

The Route 1 ODS NiCoCr powder was suitable for consolidation by binder jetting, material extrusion, cold spray, and HIP without a DC plasma spheroidization step, preserving the intragranular nanoscale dispersoid architecture from powder through to consolidated part as demonstrated for the analogous Inconel® 718 system in Example 23. The use of acoustic milling rather than high-energy ball milling is advantageous for scale-up because acoustic mixers are commercially available at industrial scales (e.g., Resodyn OmniMix 100 and 1000 series), process times are shorter than for ball milling (hours vs. tens of hours for equivalent energy input), and no milling media are required, eliminating a source of contamination.

### Example 32: Route 1 ODS Inconel® 718 Powder with DC Plasma Spheroidization and Rapid Quenching

This example illustrates the production of Route 1 ODS Inconel® 718 powder subjected to DC plasma spheroidization followed by rapid quenching to achieve near-theoretical density (99-100%) while preserving the intragranular nanoscale dispersoid distribution. This example may be compared with Example 22 (Route 1 ODS Inconel® 718 without plasma) to demonstrate that the Route 1 ODS microstructure can be preserved through a melt-resolidification cycle when sufficiently rapid quenching is employed.

Mechanical Alloying and Spray Drying. A second batch of mechanically alloyed Inconel® 718+0.35 wt. % Y₂O₃ powder was prepared prior to slurry preparation under conditions identical to the mechanical alloying step described in Example 22, followed by slurry preparation and spray drying as described therein. The spray dried agglomerates had a D50 of 33 μm.

Debinding and Solid-State Sintering. Debinding was performed at 300° C. for 2 hours under argon in a dedicated atmosphere furnace. The debound powder was transferred to a microwave sintering furnace (2.45 GHz) and sintered at 1180° C. for 45 minutes under argon, identical to Example 22. The sintered powder had a density of 93.5% of theoretical and sphericity of 0.89. TEM analysis of FIB-sectioned particles confirmed intragranular Y—O dispersoids with a mean diameter of 16 nm and an average inter-particle spacing of approximately 58 nm, consistent with the results of Example 22.

DC Plasma Spheroidization with Rapid Quenching. Unlike Example 22 (which excluded DC plasma spheroidization), the sintered ODS powder of this Example was subjected to DC plasma spheroidization with rapid quenching. The Praxair SG-100 DC plasma torch was operated at: arc current 420 A, voltage 34 V, argon plasma gas 50 SLPM, helium secondary gas 15 SLPM, powder feed rate 2.5 kg/h. The lower feed rate compared with non-ODS applications (e.g., 5.0 kg/h in Example 3) was employed to ensure complete melting and spheroidization of each particle.

The collection zone was configured for rapid quenching using a high-velocity helium gas quench manifold, consisting of six symmetrically arranged nozzles directing helium gas (99.999% purity, total flow 250 SLPM) at the particle flight path exit, positioned 30 cm below the torch nozzle. Based on the Ranz-Marshall forced convection heat transfer correlation for 33 μm Inconel® 718 droplets (thermal conductivity ~26 W/m K, density 8.19 g/cm³, heat capacity ~620 J/kg·K) in a helium stream at the measured velocity, the estimated effective cooling rate was approximately 2×10⁴ K/s. This cooling rate exceeds the minimum cooling rate described for the rapid-quench embodiment by more than one order of magnitude.

Results. The properties of the Route 1 ODS Inconel® 718 powder processed with DC plasma+rapid quench are summarized in Table 27 and compared with the Route 1 powder without plasma (Example 22) and the Route 2 powder with plasma (Example 3).

TABLE 27
Route 1 ODS IN718 with Rapid Quench (Ex. 32) vs. Route
1 without Plasma (Ex. 22) vs. Route 2 (Ex. 3)

| | Ex. 32 Route | Ex. 22 Route | Ex. 3 |
|---|---|---|---|
| | 1 + | 1 No | Route 2 |
| Property | Quench | Plasma | Plasma |
| Y₂O₃ Loading (wt. %) | 0.35 | 0.35 | 1.0 |
| D50 (μm) | 31 | 32 | 30 |
| % Theoretical Density | 99.5% | 93.1% | 99.6% |
| Hall Flow (s/50 g) | 18.5 | 34.8 | 18.2 |
| Sphericity | 0.98 | 0.89 | 0.98 |
| Dispersoid Location | Intragranular | Intragranular | Grain boundaries |
| (TEM) | | | |
| Avg. Dispersoid Size | 20-45 | 15-35 | 50-300 |
| (nm) | | | |
| Dispersoid Spacing | 65 | 60 | N/A (GB only) |
| (nm) | | | |
| Oxygen (ppm) | 260 | 620 | 210 |

TEM analysis of FB-sectioned plasma-spheroidized and rapidly quenched particles confirmed that Y—O-rich dispersoids remained in predominantly intragranular positions, with a mean dispersoid diameter of 28 nm (range 20-45 nm) and average inter-particle spacing of approximately 65 nm. The modest increase in mean dispersoid diameter from 16 nm (pre-plasma, this Example) to 28 nm (post-plasma) is attributed to limited coarsening during the brief melt residence time (~5 ms for 33 μm particles) and partial dissolution/reprecipitation during rapid solidification, consistent with the mechanism described above. No preferential migration of dispersoids to grain boundaries was observed, in contrast to the grain-boundary-only distribution in the Route 2 powder of Example 3.

High-angle annular dark-field scanning TEM (HAADF-STEM) imaging with EDS mapping at dispersoid sites confirmed yttrium and oxygen enrichment without detectable nickel, chromium, or iron, demonstrating retention of the discrete Y—O phase through the melt-resolidification-quench cycle. Selected area electron diffraction (SAED) of dispersoids larger than 25 nm was consistent with the cubic Y₂O₃ phase.

This example demonstrates that Route 1 ODS powders can achieve near-theoretical density (99.5%) and high sphericity (0.98) while preserving the intragranular Orowan-type dispersoid architecture, provided that sufficiently rapid quenching (~2×10⁴ K/s) is applied. The resulting powder combines the physical properties needed for L-PBF processing (high density, sphericity, and flowability comparable to Route 2 powder) with the intragranular dispersoid microstructure that provides superior high-temperature creep resistance (as demonstrated for the non-plasma Route 1 powder in Example 23). The trade-off is a lower DC plasma feed rate (2.5 kg/h vs. 5.0 kg/h for Route 2) due to the need for the rapid quench configuration, resulting in higher processing cost per kilogram.

### Example 33: Combined Sintering and Hydrogen Reduction of WO₃ in a Single Furnace

This example illustrates the combined sintering and reduction of spray-dried WO₃ agglomerates in a single furnace operation, in which the sintering and reduction process are combined and performed in the same furnace. This example may be compared with Example 30 (separate sintering and reduction) and Example 2 (separate sintering and reduction for MoO₃).

Slurry Preparation, Spray Drying, and Debinding. Spray-dried WO₃ agglomerates (D50=44 μm) were prepared and debinded substantially as described in Example 30.

Combined Sintering and Reduction. The debound WO₃ agglomerates were loaded into a molybdenum-element tube furnace (Thermal Technology LLC) under flowing pure hydrogen (99.999%, 5 L/min). The combined sintering/reduction was performed in a single programmed thermal cycle: (i) ramp at 3° C./min to 600° C. and hold for 2 hours (first-stage reduction: WO₃→WO₂); (ii) ramp at 3° C./min to 950° C. and hold for 4 hours (second-stage reduction: WO₂→W, through W₂₅O₄₉ intermediates); (iii) ramp at 5° C./min to 1450° C. and hold for 60 minutes (sintering of the now-metallic tungsten powder under hydrogen); (iv) cool at 5° C./min to room temperature under flowing hydrogen. The total furnace cycle time from loading to unloading was approximately 16 hours. A Ni activator (0.35 wt. %) had been incorporated during slurry preparation (as in Example 30) to enable sintering at 1450° C. rather than the 2400-2700° C. required without activator.

Oxygen analysis (LECO ONH836) of the powder after the combined cycle confirmed 480 ppm residual oxygen, comparable to the 520 ppm achieved by separate reduction in Example 30. XRD analysis confirmed complete reduction to metallic tungsten with no detectable WO₂ or other oxide phases. The combined-cycle powder had a density of 86.2% of theoretical as measured by helium pycnometry, sphericity of 0.76, and D50 of 35 μm.

DC Plasma Spheroidization. The combined-cycle powder was processed through DC plasma spheroidization under conditions identical to Example 30. The final spheroidized tungsten powder had a density of 99.1% of theoretical, sphericity of 0.96, Hall flow of 23.8 s/50 g, and oxygen content of 105 ppm.

Results. The properties are summarized in Table 28 and compared with the separate sintering/reduction route of Example 30.

TABLE 28
W from WO₃ - Combined (Ex. 33) vs. Separate
(Ex. 30) Sintering/Reduction

| | Ex. 33 | Ex. 30 |
|---|---|---|
| Property | (Combined) | (Separate) |
| Furnace Operations | 1 (combined) | 2 (sinter + reduce) |
| Total Furnace Time (h) | ~16 | ~12 + ~8 = ~20 |
| O After Reduction (ppm) | 480 | 520 |
| % Density After Sinter/Reduce | 86.2% | 84.8% |
| Sphericity After Sinter/Reduce | 0.76 | 0.75 |
| % Density After DC Plasma | 99.1% | 99.3% |
| Sphericity After DC Plasma | 0.96 | 0.96 |
| Hall Flow After DC Plasma | 23.8 | 23.2 |
| (s/50 g) | | |

As shown in Table 28, the combined sintering/reduction route achieved equivalent final powder properties to the separate two-furnace route of Example 30 while eliminating one furnace loading/unloading cycle and reducing the total furnace time from approximately 20 hours (combined time for two separate furnace operations) to approximately 16 hours (single programmed cycle). The slightly higher post-sintering density (86.2% vs. 84.8%) is attributed to the progressive reduction-then-sintering sequence, which allows the tungsten particles to begin necking and densifying immediately after reduction to metal while still at elevated temperature, rather than cooling to ambient and reloading into a separate furnace. The combined route is advantageous for production efficiency and is particularly applicable when both sintering and reduction can be performed under the same atmosphere (hydrogen), as is the case for tungsten, molybdenum, and iron oxide systems.

### Example 34: W-25Re Powder with Low-Dose Platinum Activator for Aerospace Applications

This example illustrates the use of a platinum (Pt) activator at a concentration of 0.1 wt. % or less for structural aerospace applications where grain boundary embrittlement must be minimized. This example may be compared with Example 1 (0.35 wt. % Ni activator) and Example 24 (no activator, requiring 2200° C. sintering).

Slurry Preparation. Primary tungsten powder (D50=1.2 μm) and rhenium powder (D50=3.5 μm) were weighed at 75:25 by weight. Platinum activator was added as a chloroplatinic acid (H₂PtCl₆·6H₂O, 99.9%, Alfa Aesar) solution in deionized water, at a Pt loading of 0.08 wt. % based on total metal weight. Solution-phase addition was employed rather than metallic Pt powder to ensure molecular-level dispersion of the activator on the W and Re particle surfaces, which is critical at low activator loadings where uniform distribution is difficult to achieve with powder blending. The Pt-coated powders were combined with PVP binder (1.2 wt. %) in deionized water at 30% solids and processed substantially as described in Example 1.

Spray Drying, Debinding, and Sintering. Spray drying was performed under conditions identical to Example 1 (inlet 220° C., with the Ultrasonic Package operated at settings selected to produce the target agglomerate size distribution, N₂ drying gas). The spray dried agglomerates had a D50 of 37 μm. Debinding was performed at 350° C. for 2 hours under argon in a dedicated atmosphere furnace. The debound powder was transferred to a conventional resistance-heated furnace and sintered at 1650° C. for 90 minutes under flowing argon. A conventional furnace was used because the sintering temperature exceeds the 1600° C. operating limit of the microwave sintering furnace. The sintering temperature was intermediate between the activator-free route (2200° C., Example 24) and the 0.35% Ni-activated route (1550° C., Example 1), reflecting the lower activator loading. The sintered powder had a density of 89.5% of theoretical.

DCPlasma Spheroidization. The sintered W-25Re powder was processed through DC plasma spheroidization under conditions identical to Example 1.

Results. The properties are summarized in Table 29 and compared with Example 1 (0.35% Ni) and Example 24 (no activator).

TABLE 29
W-25Re - 0.08% Pt (Ex. 34) vs. 0.35%
Ni (Ex. 1) vs. No Activator (Ex. 24)

| | Ex. 34 | Ex. 1 | Ex. 24 |
|---|---|---|---|
| Property | (0.08% Pt) | (0.35% Ni) | (None) |
| Activator | Pt, 0.08 wt. % | Ni, 0.35 wt. % | None |
| Sintering Temp. (° C.) | 1,650 | 1,550 | 2,200 |
| Sintering Furnace | Conventional | Microwave | W-element |
| | resistance | | resistance |
| % Density After | 89.5% | 92.5% | 90.8% |
| Sintering | | | |
| % Density After DC | 99.1% | 99.2% | 99.3% |
| Plasma | | | |
| Hall Flow (s/50 g) | 22.2 | 22.5 | 22.0 |
| Sphericity | 0.97 | 0.97 | 0.97 |
| Pt Content (ppm, ICP- | 780 | <5 | <5 |
| OES) | | | |
| Ni Content (ppm, ICP- | <5 | 3,400 | <5 |
| OES) | | | |
| GB Segregation | Not detected | Ni confirmed | Not detected |
| (STEM-EDS) | | | |

STEM-EDS analysis of grain boundaries in FIB-sectioned particles did not detect Pt enrichment at grain boundaries, consistent with the known higher solubility of Pt in W compared with Ni in W. The absence of grain-boundary segregation at 0.08 wt. % Pt suggests that this activator species and concentration will not degrade grain-boundary cohesion or fracture toughness, unlike the Ni-activated powder of Example 1 where grain-boundary Ni segregation was confirmed. At the same time, the Pt activator enabled sintering at 1650° C., which is within the operating range of the microwave sintering furnace, whereas the activator-free route of Example 24 required 2200° C. in a specialized W-element resistance furnace costing approximately 5-10× more than the microwave furnace.

This example demonstrates that Pt activator at ≤0.1 wt. % provides a practical compromise between the cost benefit of activated sintering (microwave-compatible temperatures) and the metallurgical integrity required for structural aerospace applications. The higher cost of Pt relative to Ni is offset by the low loading (0.08 wt. %) and the elimination of the expensive high-temperature sintering furnace required for the activator-free route.

### Example 35: Spray Drying of Mo-47.5Re Powder with Dextrose Binder

This example illustrates the use of dextrose as the organic binder in the spray drying step, as an alternative to the PVP and PVB binders used in the preceding Examples.

Slurry Preparation. A slurry was prepared substantially as described in Example 6 (Batch C formulation): elemental Mo (D50=2.0 μm) and Re (D50=3.8 μm) powders at 52.5:47.5 weight ratio with 0.5 wt. % Ni activator, except that dextrose monohydrate (D(+)-glucose monohydrate, ≥99.5%, Sigma-Aldrich) was substituted for PVP as the binder. Dextrose was dissolved in deionized water at 1.3 wt. % based on total binder solution weight. The slurry had a solids content of 30 wt. %. Dextrose is a water-soluble monosaccharide that functions as a temporary organic binder by forming a glassy film upon drying that holds the primary particles in the spray-dried agglomerate until thermal debinding. The slurry was mixed in a planetary vacuum mixer at 2000 rpm for 10 minutes and homogenized in a ball mill at 250 rpm for 30 minutes.

Spray Drying. The slurry was spray dried in a BUCHI B-290 fitted with the Ultrasonic Package, at inlet temperature 210° C., outlet temperature 105° C., feed rate 8 mL/min, with the ultrasonic nozzle operated at settings selected to produce the target agglomerate size distribution, and N₂ drying gas. The spray dried agglomerates had a D50 of 39 μm with a particle size distribution of 18-72 μm. The agglomerate morphology was comparable to PVP-bound agglomerates, with sphericity of 0.87 as measured by Camsizer X3.

Debinding and Sintering. Debinding was performed at 300° C. for 2 hours under flowing argon (2 L/min) in a dedicated atmosphere furnace. TGA of the dextrose binder system (TA Instruments SDT Q600) under argon confirmed that dextrose decomposition commenced at approximately 160° C. and was substantially complete by 280° C., which is a lower decomposition temperature than PVP (~350° C.) and PVB (~300° C. under comparable conditions). Residual carbon after debinding was measured at 0.009 wt. % by LECO CS844, comparable to PVP-bound powders. Sintering was performed at 1700° C. for 60 minutes under argon in a microwave sintering furnace.

DC Plasma Spheroidization. The sintered Mo-47.5Re powder was processed through DC plasma at conditions identical to those described in Example 6 for the Batch C material.

Results. The properties are summarized in Table 30 and compared with the PVP-bound Mo-47.5Re powder of Example 6, Batch C (identical composition, 0.5% Ni activator, sintered at 1700° C.).

TABLE 30
Mo-47.5Re with Dextrose Binder (Ex.
35) vs. PVP Binder (Ex. 6 Batch C)

| | Ex. 35 | Ex. 6C |
|---|---|---|
| Property | (Dextrose) | (PVP) |
| Binder | Dextrose, 1.3 wt. % | PVP, 1.2 wt. % |
| D50 After Spray Drying (μm) | 39 | 38 |
| Spray-Dried Sphericity | 0.87 | 0.88 |
| Debinding Temperature (° C.) | 300 (complete | 350 (complete |
| | by 280) | by 340) |
| Residual C After Debinding | 0.009 | 0.008 |
| (wt. %) | | |
| % Density After Sintering | 95.2% | 95.5% |
| (1700° C.) | | |
| % Density After DC Plasma | 99.3% | 99.4%* |
| Hall Flow After DC Plasma | 21.0 | 20.8* |
| (s/50 g) | | |
| Sphericity After DC Plasma | 0.97 | 0.97* |

*Estimated from Example 6 Batch C sintered density with subsequent DC plasma processing comparable to Example 20 Route A.

As shown in Table 30, the dextrose binder produced spray-dried agglomerates and final sintered/plasma-spheroidized powder with properties substantially equivalent to those obtained with PVP binder. The lower decomposition temperature of dextrose (complete by ~280° C. vs.~340° C. for PVP) may be advantageous for oxygen-sensitive reactive metal systems (Ti, Ta, Zr, Hf) where lower debinding temperatures reduce the risk of oxygen pickup during the debinding step. Dextrose is also lower in cost than PVP or PVB and is available in food-grade purity, which may be advantageous for large-scale production. This example confirms that these binder species are interchangeable without significant impact on the final powder properties, as the binder serves only as a temporary agent that is completely removed during the debinding step.

### Example 36 (Prophetic): L-PBF Consolidation of Route 1 ODS Inconel® 718 Powder

This prophetic example illustrates the consolidation of Route 1 ODS Inconel® 718+0.35 wt. % Y₂O₃ powder into a fully dense article by laser powder bed fusion (L-PBF). The feedstock powder is produced according to Example 32 (Route 1 ODS Inconel® 718 with DC plasma spheroidization and rapid quenching, density 99.5% of theoretical, D50 31 μm, Hall flow 18.5 s/50 g).

Feedstock. The Route 1 ODS IN718+0.35 wt. % Y₂O₃ powder of Example 32, having intragranular Y—O dispersoids with a mean diameter of 28 nm and average inter-particle spacing of approximately 65 nm, is used as the L-PBF feedstock without additional processing.

L-PBFProcessing. L-PBF consolidation is performed on a commercial L-PBF machine (EOS M290 class or equivalent) equipped with a 400 W Yb-fiber laser. The build chamber is purged with argon to an oxygen level below 100 ppm and maintained below 500 ppm during the build. The build plate is preheated to 200° C. to reduce residual stress and cracking susceptibility. Processing parameters are: laser power 250-300 W, scan speed 800-1200 mm/s, layer thickness 40 μm, hatch spacing 80-110 μm, corresponding to a volumetric energy density of approximately 50-95 J/mm³. A 670 rotation scan strategy is employed between successive layers to minimize preferential texture and residual stress accumulation. During L-PBF, each powder layer is selectively melted by the laser, forming a melt pool with an estimated solidification rate of about 105 to about 10⁶ K/s based on published thermal modeling for IN718 L-PBF under comparable parameters.

Oxide Behavior During L-PBF. During the brief melt pool residence time, some fraction of the Y—O dispersoids may partially dissolve and reprecipitate as nanoscale Y—Ti—O or Y—Al—O complex oxides upon rapid solidification, consistent with the oxide evolution pathways described above. At the oxide loading employed (0.35 wt. % Y₂O₃), slagging and cavity formation are not expected based on published L-PBF ODS studies at comparable or higher oxide loadings in nickel-base systems.

Post-Processing. The as-built article is stress-relieved at 1065° C. for 1 hour under argon, followed by aging at 720° C. for 8 hours and 620° C. for 8 hours (standard AMS 5663 double-age). Optional hot isostatic pressing (HIP) at 1165° C./100 MPa/4 hours under argon may be performed prior to aging to close residual porosity.

Expected Verification Results. Density is measured by the Archimedes method and confirmed by micro-computed tomography (micro-CT); the target density is greater than 99.5% of theoretical. SEM imaging of etched cross-sections reveals the characteristic cellular solidification structure of L-PBF IN718, with cell spacing of approximately 0.5-1.5 μm. FIB lift-out TEM specimens are prepared from as-built (pre-HIP) material. HAADF-STEM imaging is expected to reveal nanoscale oxide dispersoids with a mean diameter of about 5 to about 40 nm distributed at intragranular positions, at cellular solidification boundaries, and within the interdendritic regions. STEM-EDS mapping is expected to confirm Y and O enrichment at dispersoid sites, with possible Ti and/or Al enrichment consistent with the formation of Y—Ti—O or Y—Al—O complex oxide phases. SAED of dispersoids larger than approximately 20 nm is expected to be consistent with a cubic or monoclinic Y-bearing oxide phase. The dispersoid size and intragranular placement are expected to provide Orowan dislocation pinning comparable to that observed in the powder state (Example 32), confirming that the L-PBF solidification rate is sufficient to preserve or regenerate the ODS microstructure.

### Example 37 (Prophetic): L-PBF Consolidation of Route 1 ODS 316L Stainless Steel Powder

This prophetic example illustrates the consolidation of Route 1 ODS 316L stainless steel+0.5 wt. % Y₂O₃ powder into a fully dense article by L-PBF.

Feedstock Preparation. Pre-alloyed 316L stainless steel powder (D50=5.0 μm, gas-atomized, composition per ASTM A240) is mechanically alloyed with nanoscale Y₂O₃ powder (D50=25 nm, ≥99.99% purity) at 0.5 wt. % loading via high-energy planetary ball milling at 250 rpm for 48 hours under argon using YSZ milling media at a ball-to-powder ratio of 10:1. The mechanically alloyed powder is spray dried (BUCHI B-290 fitted with the Ultrasonic Package, inlet 200° C., outlet 105° C., with the ultrasonic nozzle operated at settings selected to produce the target agglomerate size distribution, N₂ drying gas) to produce spherical agglomerates with D50 of approximately 35 μm. After debinding at 300° C. for 2 hours under argon and microwave sintering at 1100° C. for 45 minutes under argon (below the 316L solidus of approximately 1390° C.), the sintered ODS powder has an estimated density of about 90% of theoretical. DC plasma spheroidization with rapid quenching (Praxair SG-100, arc current 400 A, voltage 32 V, Ar 55 SLPM, He 12 SLPM, 3.5 kg/h, He gas quench at approximately 10⁴ K/s) produces ODS 316L powder with a density of approximately 99.5% of theoretical, D50 of approximately 32 μm, and sphericity of approximately 0.95.

L-PBFProcessing. L-PBF is performed on a commercial machine (SLM 280 class or equivalent) with a 400 W Yb-fiber laser. Build chamber atmosphere is argon with 02 below 100 ppm. No build plate preheat is required for 316L. Processing parameters are: laser power 180-250 W, scan speed 700-1100 mm/s, layer thickness 30 μm, hatch spacing 80-100 μm, volumetric energy density approximately 55-100 J/mm³. A 670 rotation scan strategy is used between layers.

Expected Verification Results. Density is expected to exceed 99.5% of theoretical by Archimedes measurement. SEM of etched cross-sections is expected to reveal the fine cellular solidification structure characteristic of L-PBF 316L, with cell spacing of approximately 0.3-1.0 μm. FIB lift-out TEM from as-built material is expected to reveal Y—O-rich dispersoids with a mean diameter of about 5 to about 35 nm at intragranular and cell-boundary positions. In 316L, which contains no aluminum or titanium in significant quantities, the oxide dispersoids are expected to remain as Y₂O₃ or Y—Si—O phases rather than forming the complex Y—Al—O or Y—Ti—O phases observed in nickel-base superalloys. STEM-EDS mapping is expected to confirm Y and O co-localization at dispersoid sites.

### Example 38 (Prophetic): L-PBF Consolidation of Route 1 ODS Tungsten Powder

This prophetic example illustrates the consolidation of Route 1 ODS tungsten+1.0 wt. % La₂O₃ powder into an article by L-PBF. La₂O₃ is selected over Y₂O₃ for this system because lanthanum oxide may exhibit a lower propensity to form volatile sub-oxide species under certain tungsten melting conditions and has been reported as an effective grain-refining dispersoid in ODS tungsten.

Feedstock Preparation. Pure tungsten powder (D50=3.0 μm, FSSS, ≥99.95% purity) is mechanically alloyed with nanoscale La₂O₃ powder (D50=40 nm, ≥99.9% purity) at 1.0 wt. % loading via high-energy planetary ball milling at 200 rpm for 72 hours under argon. The mechanically alloyed powder is spray dried, debinded, sintered by microwave sintering at 1500° C. for 60 minutes under hydrogen with 0.35 wt. % Ni activator (as described in Example 30), and processed through DC plasma spheroidization with rapid quenching (arc current 530 A, voltage 40 V, Ar 48 SLPM, H₂ 10 SLPM, 2.5 kg/h, He gas quench) to produce ODS W powder with a density of approximately 99.3% of theoretical, D50 of approximately 30 μm, and sphericity of approximately 0.96.

L-PBF Processing. L-PBF of tungsten requires elevated preheat to mitigate cracking from the high ductile-to-brittle transition temperature (DBTT) of tungsten. L-PBF is performed on a machine equipped with a 1 kW fiber laser and a build plate preheat system capable of at least 400° C. (e.g., modified SLM 280 HL or equivalent platform with induction or resistive substrate heating). Build chamber atmosphere is argon with 02 below 50 ppm. Build plate preheat temperature is 400-600° C. Processing parameters are: laser power 400-800 W, scan speed 200-500 mm/s, layer thickness 20-30 μm, hatch spacing 60-90 μm, corresponding to volumetric energy density of approximately 150-650 J/mm³. An island or checkerboard scan strategy with 5 mm island size and 450 rotation is employed to manage thermal stress. Post-build stress relief is performed at 1000-1200° C. for 2 hours under hydrogen or vacuum.

Expected Verification Results. L-PBF of tungsten typically achieves densities of 96-99% of theoretical; with ODS powder feedstock of 99.3% TD and optimized parameters, a density of approximately 97-99.5% of theoretical is expected. Micro-cracking along grain boundaries may be present in the as-built condition, which is characteristic of L-PBF tungsten and can be mitigated by HIP at 1500° C./200 MPa/2 hours under argon. FIB lift-out TEM from as-built or HIPed material is expected to reveal La—O-rich dispersoids with a mean diameter of about 10 to about 50 nm at intragranular positions and along solidification cell walls. The high melting point of La₂O₃ (2,315° C.) relative to tungsten (3,422° C.), together with the brief melt pool residence time in L-PBF, is expected to limit dissolution of La-0 species; accordingly, La—O-rich dispersoids are expected to persist as discrete nanoscale features that are engulfed by the advancing tungsten solidification front, consistent with the engulfment criteria described above. STEM-EDS mapping is expected to confirm La and O enrichment at dispersoid sites without significant W incorporation into the oxide phase.

### Example 39 (Prophetic): Production of Fully Dense Inconel® 718 Powder by Granule-Level Supersolidus Liquid Phase Sintering

This prophetic example illustrates the production of fully dense spherical Inconel® 718 powder by granule-level supersolidus liquid phase sintering (SLPS). No DC plasma spheroidization step is performed.

Slurry Preparation and Spray Drying. Pre-alloyed Inconel® 718 powder (D50=5.0 μm, composition per AMS 5662, gas-atomized, Praxair Surface Technologies) is combined with PVP binder (1.2 wt. %) in deionized water at 31 wt. % solids with 0.3 wt. % non-ionic dispersant (Triton X-100). The slurry is mixed in a planetary vacuum mixer (Thinky ARE-310) at 2000 rpm for 10 minutes and homogenized in a planetary ball mill at 200 rpm for 30 minutes using YSZ media. The slurry is spray dried in a BUCHI B-290 with the Ultrasonic Package (inlet 200° C., outlet 105° C., feed rate 8 mL/min, with the ultrasonic nozzle operated at settings selected to produce the target agglomerate size distribution, N₂ drying gas. The spray dried agglomerates have an expected D50 of approximately 34 μm.

Debinding. The spray dried powder is classified on an ultrasonic laboratory sieve shaker with 20 μm and 63 μm electroformed screens to the 20-63 μm fraction and debinded at 300° C. for 2 hours under flowing argon in a dedicated atmosphere furnace.

Granule-Level SLPS. The debound agglomerates are sintered in a microwave sintering furnace (2.45 GHz) at a temperature of approximately 1290° C. for 15 minutes under flowing argon. This temperature is between the solidus (~1260° C.) and liquidus (~1336° C.) of Inconel® 718. At approximately 1290° C., a liquid volume fraction of about 10-15% by volume is expected to form along grain boundaries within each individual granule, providing capillary-driven densification. The microwave sintering furnace is selected for this application because the volumetric heating mechanism provides more uniform temperature distribution across the powder bed than conventional radiative heating, reducing the risk of localized overheating and granule distortion within the narrow (~76° C.) solidus-liquidus gap of Inconel® 718, as described above. To prevent inter-granule agglomeration during granule-level SLPS, the sintering is performed on a non-wetting yttria-stabilized zirconia (YSZ) setter plate with the powder spread in a single layer of approximately 2 mm thickness. No subsequent plasma spheroidization step is performed.

Expected Results. The SLPS powder is expected to achieve a density of about 97-99% of theoretical density, sphericity of at least about 0.90 as measured by automated image analysis, and a Hall flow rate of about 25-30 s/50 g as measured according to ASTM B213. Chemical analysis by ICP-OES is expected to confirm that the alloy composition remains within the AMS 5662 specification after SLPS. XRD analysis is expected to confirm the expected γ/γ′ phase structure of Inconel® 718. Some inter-granule bridging may occur at the contact points between adjacent granules; post-SLPS sieving through a 75 μm screen is expected to break any weak sinter bridges and recover individual spherical particles. The resulting fully dense spherical powder is suitable for L-PBF, directed energy deposition, plasma spray, and other processes requiring fully dense feedstock, without the capital cost and energy consumption of a DC plasma spheroidization step.

### Example 40 (Prophetic): Production of Fully Dense 316L Stainless Steel Powder by Granule-Level Transient Liquid Phase Sintering with Boron Additive

This prophetic example illustrates the production of fully dense spherical 316L stainless steel powder by granule-level transient liquid phase sintering (TLPS) using a boron additive. This example provides direct support for the corresponding embodiment (granule-level TLPS: transient liquid additive, isothermal diffusion solidification). No DC plasma spheroidization step is performed.

Slurry Preparation and Spray Drying. Pre-alloyed 316L stainless steel powder (D50=4.8 μm, composition per ASTM A240, gas-atomized, Sandvik Osprey) is combined with amorphous boron powder (D50=1.5 μm, purity≥95%, Alfa Aesar) at 0.5 wt. % based on total solids weight. The boron serves as a transient liquid-forming additive that forms a Fe—B eutectic liquid at approximately 1174° C. The powders are combined with PVP binder (1.2 wt. %) in deionized water at 30 wt. % solids with 0.3 wt. % polyacrylic acid dispersant. The slurry is mixed in a planetary vacuum mixer at 2000 rpm for 10 minutes and homogenized in a ball mill at 250 rpm for 30 minutes. The slurry is spray dried in a BUCHI B-290 with the Ultrasonic Package (inlet 195° C., outlet 105° C., feed rate 8 mL/min, with the ultrasonic nozzle operated at settings selected to produce the target agglomerate size distribution, N₂ drying gas). The spray dried agglomerates have an expected D50 of approximately 35 μm. The spray drying process ensures homogeneous distribution of the fine boron powder throughout each granule, which is critical for uniform transient liquid formation.

Debinding. The spray dried powder is classified on an ultrasonic laboratory sieve shaker with 20 μm and 63 μm electroformed screens to the 20-63 μm fraction and debinded at 320° C. for 2 hours under flowing argon in a dedicated atmosphere furnace.

Granule-Level TLPS. The debound agglomerates are sintered in a microwave sintering furnace (2.45 GHz) at 1200° C. for 30 minutes under flowing argon. At this temperature, the boron forms a transient Fe—B eutectic liquid within each granule. The liquid provides capillary-driven rearrangement and densification of the individual granule. During the isothermal hold at 1200° C., the boron diffuses from the liquid phase into the solid 316L matrix, causing the liquid to solidify isothermally. After 30 minutes, the transient liquid is fully absorbed into the matrix, and the final granule is compositionally homogeneous with no residual boron-rich phase at ambient temperature. Sintering is performed on a boron nitride-coated alumina setter plate with the powder spread in a thin layer to prevent inter-granule agglomeration. No subsequent plasma spheroidization step is performed.

Expected Results. The TLPS powder is expected to achieve a density of about 96-99% of theoretical density, sphericity of at least about 0.90, and a Hall flow rate of about 25-28 s/50 g. Chemical analysis is expected to confirm that the boron content in the final powder is approximately 0.5 wt. % (as designed), homogeneously distributed throughout each particle with no detectable boron-rich phase by XRD. The TLPS approach achieves full densification at 1200° C., which is approximately 190° C. below the solidus of 316L (~1390° C.), avoiding the narrow processing window associated with SLPS and providing a robust manufacturing process with lower sensitivity to temperature uniformity. The resulting powder is suitable for L-PBF, directed energy deposition, plasma spray, and other processes requiring fully dense feedstock

### Example 41 (Prophetic): Production of Spherical Tungsten Heavy Alloy (W-93Ni₄Fe₃) Powder Via Granule-Level Liquid Phase Sintering

This prophetic example illustrates the production of fully dense spherical tungsten heavy alloy (WHA) powder of composition W-93Ni₄Fe₃ (93 wt. % W, 4 wt. % Ni, 3 wt. % Fe) by granule-level liquid phase sintering.

Slurry Preparation and Spray Drying. Elemental tungsten powder (D50=1.2 μm, purity≥99.95%, Global Tungsten & Powders), nickel powder (D50=2.0 μm, purity≥99.9%), and iron powder (D50=3.0 μm, purity≥99.5%) are weighed at 93:4:3 by weight. The powders are combined with PVP binder (1.2 wt. %) in deionized water at 32 wt. % solids with 0.4 wt. % polyacrylic acid dispersant. The slurry is mixed in a planetary vacuum mixer at 2000 rpm for 10 minutes and homogenized in a planetary ball mill at 250 rpm for 30 minutes. The slurry is spray dried in a BUCHI B-290 with the Ultrasonic Package (inlet 220° C., outlet 110° C., feed rate 7 mL/min, with the ultrasonic nozzle operated at settings selected to produce the target agglomerate size distribution, N₂ drying gas). The spray dried agglomerates have an expected D50 of approximately 38 μm.

Debinding. The spray dried powder is classified on an ultrasonic laboratory sieve shaker with 20 μm and 63 μm electroformed screens to the 20-63 μm fraction and debinded at 350° C. for 2 hours under flowing argon in a dedicated atmosphere furnace.

Granule-Level LPS. The debound agglomerates are sintered at 1480° C. for 30 minutes under flowing hydrogen in a rotating tube furnace (rotation speed 2 rpm) to prevent inter-granule agglomeration during liquid phase sintering, as described above. At approximately 1455° C., the Ni—Fe binder phase melts to form a liquid that provides capillary-driven rearrangement, solution-reprecipitation densification, and pore elimination through liquid phase sintering within each individual granule. The homogeneous distribution of Ni and Fe within each spray-dried granule, achieved by slurry-level mixing, ensures uniform liquid phase formation. The rotation of the tube furnace continuously tumbles the granules, preventing contact-mediated bridging. No subsequent plasma spheroidization step is performed.

Expected Results The granule-level LPS powder is expected to achieve a density of about 97-99% of theoretical density (theoretical density of W-93Ni4Fe3≈17.7 g/cm³), sphericity of at least about 0.92, and a Hall flow rate of about 22-28 s/50 g. The Ni—Fe binder phase is expected to be uniformly distributed as a thin intergranular network between tungsten grains within each particle, consistent with the characteristic microstructure of liquid-phase-sintered tungsten heavy alloys. The D50 of the final powder is expected to be approximately 36 μm. The resulting fully dense spherical WHA powder is suitable for L-PBF, directed energy deposition, plasma spray, cold spray, and binder jetting applications without requiring a DC plasma spheroidization step. This example demonstrates that the spray drying platform combined with granule-level LPS produces tungsten heavy alloy powders with significantly higher density than the ≤65% of theoretical achieved in the prior art (Stawovy et al., U.S. Pat. No. 12,359,290, described above).

### Example 42 (Prophetic): Production of Intentionally Porous Mo-47.5Re Powder for Binder Jetting

This prophetic example illustrates the production of intentionally porous spherical Mo-47.5Re alloy powder optimized for binder jetting, in which the residual porosity provides sinter activity for part-level densification. No DC plasma spheroidization step is performed; the sintered powder is the final powder product.

Slurry Preparation and Spray Drying. Elemental molybdenum powder (D50=2.0 μm) and rhenium powder (D50=3.8 μm) are weighed at 52.5:47.5 by weight with 0.3 wt. % Ni activator, PVP binder (1.2 wt. %) in water at 30% solids. The slurry is mixed and spray dried substantially as described in Example 6.

Debinding and Controlled Sintering. Debinding is performed at 350° C. for 2 hours under argon in a dedicated atmosphere furnace. The debound powder is transferred to a microwave sintering furnace (2.45 GHz) and sintered at 1500° C. for 45 minutes under argon. The sintering temperature and time are intentionally selected to achieve a target density in the range of about 78-82% of theoretical density, which is within the preferred 70-85% range for maximum sinter activity during subsequent part-level sintering. Comparison with Example 6 (Batch B: 0.2% Ni, 1500° C., 81.6% TD; Batch C: 0.5% Ni, 1500° C., 88.4% TD) confirms that the 0.3 wt. % Ni loading at 1500° C. targets the desired density range.

Expected Results: The sintered powder is expected to achieve a density of about 78-82% of theoretical density, sphericity of at least about 0.85 as measured by automated image analysis, and a Hall flow rate of about 32-35 s/50 g as measured according to ASTM B213. D50 is expected to be approximately 37 μm. The residual interconnected porosity (approximately 18-22 vol. %) provides sinter activity for part-level densification during the subsequent binder jetting sintering cycle. No DC plasma spheroidization step is performed; the sintered powder is the final powder product for binder jetting use.

Part-Level Densification Validation. To validate the sinter activity of the intentionally porous powder, binder jetting test bars (ASTM E8 sub-size) are printed on an ExOne Innovent+ system with 50 μm layer thickness and 60% binder saturation. After curing at 180° C. for 6 hours and debinding at 350° C. for 3 hours under argon, the green parts are sintered at 1800° C. for 4 hours under hydrogen in a vacuum furnace. The expected final part density is at least about 97% of theoretical density without supplemental hot isostatic pressing, confirming that the residual porosity in the powder particles provides a sufficient thermodynamic driving force for part-level sintering. The expected dimensional shrinkage during sintering is approximately 1₈-2₀% linear (isotropic), consistent with the ~80% starting powder density and ~97% final part density. This example confirms the advantage of intentionally porous powder over fully dense atomized or plasma-spheroidized powder for sinter-based additive manufacturing, as described herein.

### Example 43 (Prophetic): Dispersion-Strengthened Spherical Ni-Base Alloy Powder Via Route 4—Melt-Mediated Nano-Oxide Dispersion Without Mechanical Alloying

This prophetic example illustrates the production of dispersion-strengthened spherical Ni-base alloy powder containing an oxide phase distributed within the particle interior via Route 4, in which nanoscale oxide particles are combined with the primary metal powder in the spray drying slurry without mechanical alloying and the oxide is incorporated by melt-mediated dissolution/reprecipitation during plasma spheroidization and rapid solidification, as described above.

Slurry Preparation. Pre-alloyed Inconel® 718 powder (D50=3.5 μm, purity compliant with AMS 5662, jet-milled from gas-atomized feedstock) and nanoscale Y₂O₃ powder (D50=30 nm, purity≥99.99%, Nanostructured & Amorphous Materials, Inc.) at 0.5 wt. % relative to total metal weight are dispersed in deionized water with PVP binder (1.2 wt. % based on binder solution weight), polyacrylic acid dispersant (0.3 wt. % relative to solids), and a non-ionic surfactant (Triton X-100, 0.2 wt. %). The slurry is prepared at 45 wt. % total solids and mixed in a planetary vacuum mixer (Thinky ARE-310) at 2000 rpm for 12 minutes. No mechanical alloying step is performed; the Y₂O₃ nanoparticles remain as discrete oxide particles distributed throughout the slurry by dispersion and mixing. The slurry is homogenized in a planetary ball mill at 200 rpm for 30 minutes using YSZ media to ensure thorough distribution of the nano-oxide particles.

Spray Drying. The slurry is spray dried in a BUCHI B-290 fitted with the Ultrasonic Package (inlet 200° C., outlet 105° C., feed rate 7 mL/min, with the ultrasonic nozzle operated at settings selected to produce the target agglomerate size distribution, N₂ drying gas at 33 m³/h). The spray dried agglomerates have an expected D50 of approximately 40 μm with a particle size distribution of 18-75 μm. The agglomerates are classified on an ultrasonic laboratory sieve shaker with 20 μm and 63 μm electroformed screens to the 20-63 μm fraction. During spray drying, the multi-particle granule assembly distributes the Y₂O₃ nanoparticles throughout the volume of each agglomerate.

Debinding. Debinding is performed at 300° C. for 2 hours under flowing argon (2 L/min) in a dedicated atmosphere furnace.

Optional Pre-Sintering. In one embodiment, the debound agglomerates are pre-sintered in a microwave sintering furnace (2.45 GHz) at 900° C. for 30 minutes under argon (approximately 0.70 T_solidus for Inconel® 718) to form necks between primary particles and impart handling strength while maintaining open porosity. In an alternative embodiment, the pre-sintering step is omitted and the debound agglomerates are fed directly to the plasma spheroidization step.

Plasma Spheroidization with Rapid Solidification. The debound (or optionally pre-sintered) agglomerates are processed through a DC plasma torch (Praxair SG-100) at: arc current 430 A, voltage 34 V, argon plasma gas 50 SLPM, helium secondary gas 15 SLPM, powder feed rate 3.0 kg/h. The plasma conditions are selected to fully melt each agglomerate and form spherical droplets by surface tension. The molten residence time is minimized by operating at a feed rate and plasma enthalpy that achieve full melting without excessive dwell. The collection zone is equipped with a high-velocity helium gas quench manifold (99.999% He, total flow 250 SLPM) to rapidly solidify the droplets at an estimated cooling rate of approximately 2×10⁴ K/s. During the brief molten interval, Y₂O₃ feedstock is expected to undergo partial dissolution into the Ni-base melt and reprecipitation as nanoscale Y—O and/or Y—Al—O complex oxide dispersoids during rapid solidification, consistent with the mechanism described above and with published observations of oxide evolution in melt-pool studies of dispersion-strengthened alloys.

Expected Results: The Route 4 powder is expected to exhibit high sphericity (≥0.95), D50 of approximately 35 μm, density of at least about 99% of theoretical, and Hall flow rate of approximately 18-22 s/50 g. FIB cross-sectioning with SEM-EDS is expected to show yttrium and oxygen signal distributed within the particle interior rather than concentrated exclusively at the particle surface or grain boundaries. In certain embodiments, TEM analysis of FIB lift-out specimens is expected to reveal nanoscale oxide dispersoids (mean diameter approximately 5-50 nm) at intragranular positions within the rapid solidification cellular structure, consistent with dissolution/reprecipitation of Y—O species during the melt-resolidification cycle. The dispersoid size, morphology, and intragranular vs. boundary distribution may depend on the specific alloy chemistry, oxide loading, melt residence time, and quench rate; optimization of these parameters for a given alloy system may be determined by routine experimentation. This example demonstrates that Route 4 achieves an oxide-dispersed or ODS-type spherical powder without the mechanical alloying step required by Route 1 and without the colloidal hetero-agglomeration and solid-state sintering pre-treatment required by Route 3.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

We claim:

1. A method for producing spherical metal powder particles from a metal or metal alloy starting material, the method comprising:
(a) preparing a slurry comprising a metal or metal alloy powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) sintering the debound agglomerates at a temperature below a solidus temperature of the metal or metal alloy to produce spherical metal powder particles having a density of about 70% to about 95% of theoretical density.

2. The method of claim 1, wherein step (d) is performed in a microwave sintering furnace operating at a frequency of about 2.45 GHz or about 890-950 MHz.

3. The method of claim 1, further comprising:
(e) subjecting the spherical metal powder particles to DC plasma spheroidization using a DC non-transferred arc plasma torch operating at a power of about 20 kW to about 500 kW by passing the spherical metal powder particles through a plasma plume to at least partially melt the spherical metal powder particles and spheroidize by surface tension, wherein the spherical metal powder particles subjected to DC plasma spheroidization have a density of about 99% to about 100% of theoretical density.

4. The method of claim 1, wherein the metal or metal alloy powder is selected from the group consisting of transition metals of Groups 4-12, rare earth metals and alloys thereof, and refractory metals and alloys thereof selected from W, Mo, Re, Ta, Nb, Hf, Mo—Re alloys, W—Re alloys, Mo—W alloys, Mo—Ta alloys, Mo—Hf alloys, Ta—W alloys, and Ta—Nb alloys.

5. The method of claim 1, wherein the slurry further comprises a sintering activator selected from the group consisting of Ni, Fe, Pt, and Ru in an amount of about 0.1 to about 1% by weight based on a total weight of solids.

6. The method of claim 1, further comprising, prior to step (a), mechanically alloying nanoscale oxide particles having a particle size D50 of less than about 50 nm into the metal or metal alloy powder via high-energy planetary ball milling, attritor milling, or acoustic milling to establish an intragranular nanoscale dispersoid distribution,
wherein step (d) is performed in a solid state at a temperature below a solidus temperature of the metal alloy powder to produce oxide dispersion strengthened (ODS) metal powder particles having a density of about 85% to about 95% of theoretical density with an ODS microstructure comprising intragranular nanoscale dispersoids providing Orowan dislocation pinning; and
wherein the method optionally further comprises (e) subjecting the ODS metal powder particles to DC plasma spheroidization followed by rapid quenching at a cooling rate of at least about 103 K/s to produce an ODS metal powder having a density of about 99% to about 100% of theoretical density while preserving the intragranular nanoscale dispersoid distribution.

7. The method of claim 1, wherein the slurry further comprises oxide particles having an average particle size D50 of about 100 nm to about 5 μm selected from the group consisting of Y₂O₃, La₂O₃, CeO₂, Ce₂O₃, and Y—Ti—O complex oxides, in an amount of about 0.5% to about 3.0% by weight based on a total weight of solids, and wherein the method further comprises (e) subjecting the spherical metal powder particles to DC plasma spheroidization, whereby the oxide particles redistribute to grain boundaries upon resolidification to provide grain boundary strengthening via Zener pinning, Hall-Petch grain refinement, and improved oxidation resistance through a reactive element effect.

8. The method of claim 1, wherein an oxide phase comprising oxide particles is introduced within each spray-dried agglomerate without mechanical alloying by either:
(i) deagglomerating nanoscale or sub-micron oxide particles having a particle size D50 of about 10 nm to about 500 nm in a liquid carrier with a dispersant and depositing the oxide particles onto metal powder surfaces by hetero-agglomeration prior to slurry preparation, or
(ii) distributing nanoscale oxide particles or an oxide-forming precursor throughout the slurry prior to spray drying; and
wherein the method further comprises (e) subjecting the debound agglomerates to DC plasma spheroidization with rapid solidification to produce spherical metal powder particles having a density of about 99% to about 100% of theoretical density and containing an oxide phase distributed within a particle interior.

9. A method for producing spherical metal powder particles from a metal or metal alloy starting material, the method comprising:
(a) preparing a slurry comprising a pre-alloyed metal powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) heating the debound agglomerates to a temperature between a solidus temperature and a liquidus temperature of the metal or metal alloy starting material to cause partial melting and formation of a liquid phase within each debound agglomerate, whereby the debound agglomerates are densified to a density of about 95% to about 100% of theoretical density by liquid phase sintering at a granule level without a subsequent plasma spheroidization step,
and wherein the heating is performed in a fluidized bed furnace, a rotating tube furnace, or on a non-wetting substrate selected from the group consisting of boron nitride-coated alumina and yttria-stabilized zirconia.

10. The method of claim 1, wherein the slurry further comprises a transient liquid-forming additive selected from the group consisting of boron in an amount of about 0.1 to about 1.0 wt. %, copper in an amount of about 1 to about 5 wt. %, silicon in an amount of about 0.5 to about 3 wt. %, phosphorus in an amount of about 0.1 to about 0.8 wt. %, and tin in an amount of about 1 to about 5 wt. %, each based on a total weight of solids, wherein during step (d) the transient liquid-forming additive forms a transient liquid phase that densifies the debound agglomerates to a density of about 95% to about 100% of theoretical density and subsequently solidifies by isothermal diffusion into a solid matrix.

11. The method of claim 1, wherein the metal alloy powder is a high entropy alloy selected from the group consisting of refractory high-entropy alloys (RHEAs), 3d transition high-entropy alloys (THEAs), and high-entropy superalloys (HESAs).

12. A method for producing spherical metal powder particles from a metal or metal alloy starting material, the method comprising:
(a) preparing a slurry comprising a metal or metal alloy powder having an average particle size D50 of about 0.01 microns to about 10 microns, an organic binder, and a solvent;
(b) spray drying the slurry to produce spherical agglomerates having an average particle size D50 of about 5 to about 150 microns;
(c) debinding the spherical agglomerates; and
(d) feeding the debound agglomerates directly into a DC plasma torch without a prior sintering step, wherein the DC plasma simultaneously densifies and spheroidizes the debound agglomerates to a density of about 99% to about 100% of theoretical density.

13. A method for producing spherical metal powder particles from metal oxide starting materials, the method comprising:
(a) preparing a slurry comprising a metal oxide powder having an average particle size D50 of about 0.01 microns to about 10 microns, an organic binder, and a solvent;
(b) spray drying the slurry to produce spherical oxide agglomerates;
(c) debinding the spherical oxide agglomerates;
(d) sintering the debound spherical oxide agglomerates under an inert or hydrogen-containing atmosphere,
(e) reducing the debound oxide agglomerates to metallic form via hydrogen reduction or metallothermic reduction, wherein
step (e) is performed simultaneously with step (d) under a hydrogen, hydrogen-containing, or a forming gas atmosphere such that sintering consolidation and oxide reduction occur concurrently in a single combined thermal step to form a reduced metal powder; or
step (e) is performed as a separate step after step (d) to form the reduced metal powder; and
(f) subjecting the reduced metal powder to DC plasma spheroidization to restore sphericity and produce spherical metal powder particles having a density of about 99% to about 100% of theoretical density.

14. The method of claim 13, wherein the metal oxide powder is selected from the group consisting of oxides of W, Mo, Re, Ta, Nb, Hf, Fe, Ti, Ni, and Co.

15. The method of claim 13, wherein step (e) is a metallothermic reduction using a reducing agent selected from the group consisting of calcium, magnesium, aluminum, and sodium; and wherein steps (d) and (e) are performed simultaneously in a single furnace or are performed sequentially in a single furnace or in different furnaces.

16. A spherical metal powder comprising metal powder particles having an average particle size D50 of about 5 to about 100 microns, a density of about 70% to about 100% of theoretical density, a sphericity of at least about 0.85 as measured by automated image analysis, and a sintered polycrystalline microstructure comprising multiple grains derived from individual primary powder particles bonded by solid-state sintering necks, with residual closed porosity distributed within a particle interior.

17. The spherical metal powder of claim 16, wherein the metal powder particles comprise a refractory metal or refractory metal alloy selected from the group consisting of W, Mo, Re, Ta, Nb, Hf, W—Re, Mo—Re, Mo—Ta, Mo—Hf, and Ta—Nb.

18. The spherical metal powder of claim 16, wherein the spherical metal powder is an oxide dispersion strengthened (ODS) powder comprising intragranular nanoscale oxide dispersoids having an average particle size D50 of about 5 to about 50 nm providing Orowan dislocation pinning, and has a density of about 85% to about 100% of theoretical density; or wherein the spherical metal powder is an oxide-modified alloy powder comprising oxide particles at grain boundaries providing Zener pinning, and has a density of about 99% to about 100% of theoretical density.

19. The spherical metal powder of claim 16, wherein the spherical metal powder has a sphericity of at least 0.90 as measured by automated image analysis and a Hall flow rate of about 30 seconds per 50 grams or less as measured according to ASTM B213.

20. A method of sinter-based additive manufacturing comprising:
providing the spherical metal powder of claim 16 having a density of about 70% to about 95% of theoretical density with residual interconnected porosity;
forming a green part by binder jetting, fused filament fabrication, MIM-type feedstock extrusion, or bound metal deposition; and
sintering the green part to at least about 97% of theoretical density without supplemental hot isostatic pressing.
